(19) United States
(12) Patent Application Publication
(10) Pub. No.: US 2026/0103277 A1
(43) Pub. Date: Apr. 16, 2026

(54) AIRCRAFT WITH AN UNDUCTED FAN PROPULSOR

(71) Applicant: General Electric Company, Evendale, OH (US)

(72) Inventors: Sara Elizabeth Carle, Columbus, OH (US); Daniel L. Tweedt, West Chester, OH (US); Syed Arif Khalid, West Chester, OH (US); Andrew Breeze-Stringfellow, Montgomery, OH (US); William Bowden, Cleves, OH (US); Kishore Ramakrishnan, Rexford, NY (US); Trevor Howard Wood, Clifton Park, NY (US)

(21) Appl. No.: 19/419,717

(22) Filed: Dec. 15, 2025

Related U.S. Application Data
(63) Continuation-in-part of application No. PCT/US2024/040754, filed on Aug. 2, 2024.
Application No. PCT/US2024/040754 is a continuation-in-part of application No. 18/652,052, filed on May 1, 2024, now Pat. No. 12,384,522.
Application No. 18/652,052 is a continuation-in-part of application No. 18/230,609, filed on Aug. 4, 2023, now Pat. No. 12,365,471.

(51) Int. Cl. B64C 11/48; B64C 11/18; B64D 27/12; B64D 27/40

(52) U.S. Cl. CPC B64C 11/48; B64C 11/18; B64D 27/12; B64D 27/402

(57) ABSTRACT

The present disclosure is generally related to aircraft having one or more unducted fan propulsors at locations within specific regions relative to an airfoil, such as a wing or horizontal stabilizer. More specifically, the specific regions are located where there is a relatively higher pressure air flow beneath the wings or above a horizontal stabilizer. That higher pressure air flow can be utilized to provide increased thrust from the unducted fan propulsor.

### CROSS-REFERENCE TO RELATED APPLICATIONS

This application is a continuation-in-part of International Appl. No. PCT/US2024/040754, filed Aug. 2, 2024, which claims priority to U.S. patent application Ser. No. 18/230,609, filed on Aug. 4, 2023, and Ser. No. 18/652,052, filed May 1, 2024, the latter of which is a continuation-in-part of the former, the disclosures of which are hereby incorporated by reference in their entireties.

### FIELD

The present disclosure relates generally to an aircraft with a fan propulsor.

### BACKGROUND

Winged aircraft have undermounted propulsors in the form of a turboprop engine. The addition of a propulsor to a wing can lead to installation penalties, including increased drag. As the size of the undermounted propulsor increases, installation penalties can also increase, such as increased weight.

### BRIEF DESCRIPTION OF THE DRAWINGS

A full and enabling disclosure of the aspects of the present description, including the best mode thereof, directed to one of ordinary skill in the art, is set forth in the specification, which refers to the appended figures, in which:

FIG. 1 comprises a top plan view of an aircraft as configured in accordance with various embodiments of these teachings, with undermounted, unducted fan propulsors mounted on forward wings of the aircraft;

FIG. 2 comprises a top plan view of an aircraft as configured in accordance with various embodiments of these teachings, with unducted fan propulsors mounted on top of horizontal stabilizers of the aircraft;

FIG. 3 comprises an elevational cross-sectional view of an exemplary unducted fan propulsor having a plurality of blades arranged in a forward array and a rearward array;

FIG. 4 comprises a schematic side elevation view showing the location of the unducted fan propulsor of FIG. 3 relative to an airfoil section;

FIG. 5A is a schematic side elevation view similar to FIG. 4 and showing the unducted fan propulsor pitched downward relative to the airfoil section;

FIG. 5B defines a pitch angle φ for the unducted fan propulsor relative to a chord line of the airfoil section in FIG. 4;

FIG. 6A comprises a top plan view of the propulsor of FIG. 4 and inboard and outboard locations of the wing relative to an unducted fan propulsor centerline, with the inboard and outboard locations in FIG. 6A used to determine a chord length (C) of the airfoil section in FIG. 4;

FIG. 6B comprises a schematic side elevation view of a first section and a second section of the aircraft wing, which sections are used to determine an effective quarter chord point (QC) of the airfoil section in FIG. 4;

FIG. 6C comprises a schematic top plan view of a portion of an aircraft having a pair of wings extending from the fuselage with the propulsor of FIG. 3 mounted relative to each of the wings;

FIG. 6D comprises a schematic front elevation view of the aircraft portion of FIG. 6C;

FIG. 6E comprises a schematic top plan view of a portion of an aircraft having a pair of wings extending from the fuselage with the propulsor of FIG. 3 mounted relative to each of the wings, similar to FIG. 6C but showing the propulsors toed inwardly toward the fuselage;

FIG. 7 comprises a schematic side elevation view similar to that of FIG. 4, but showing a first ellipse, a second ellipse, a third ellipse, and a fourth ellipse to illustrate various embodiments of mounting locations of one of the unducted fan propulsors relative to one of the wings;

FIG. 8 comprises a schematic side elevation view similar to that of FIG. 7, but showing a first ellipse, a second ellipse, a third ellipse, and a fourth ellipse to illustrate various embodiments of mounting locations of one of the unducted fan propulsors relative to one of the horizontal stabilizers;

FIG. 9 comprises a schematic side elevation view similar to that of FIG. 7, showing the first ellipse, the second ellipse, the third ellipse, and the fourth ellipse to illustrate various embodiments of mounting locations of one of the unducted fan propulsors relative to one of the wings;

FIG. 10 comprises a schematic side elevation view similar to that of FIG. 8, showing the first ellipse, the second ellipse, the third ellipse, and the fourth ellipse to illustrate various embodiments of mounting locations of one of the unducted fan propulsors relative to one of the horizontal stabilizers; and

FIG. 11 comprises a schematic representation showing exemplary locations of a point P of one of the unducted fan propulsors, as defined herein, within the first ellipse, the second ellipse, the third ellipse, and the fourth ellipse.

FIG. 12 is a cross-sectional view of a gas turbine engine in accordance with an exemplary aspect of the present disclosure.

FIG. 13 is a schematic, forward-looking-aft view of a turbofan engine in accordance with an exemplary aspect of the present disclosure.

FIG. 14 is a schematic, forward-looking-aft view of a turbofan engine in accordance with another exemplary aspect of the present disclosure.

FIG. 15 is a schematic, forward-looking-aft view of a turbofan engine in accordance with yet another exemplary aspect of the present disclosure.

FIG. 16 is a schematic, forward-looking-aft view of a turbofan engine in accordance with still another exemplary aspect of the present disclosure.

FIG. 17 is a schematic, forward-looking-aft view of an aircraft having a plurality of turbofan engines in accordance with an exemplary aspect of the present disclosure.

FIG. 18 is a schematic, forward-looking-aft view of a turbofan engine in accordance with yet another exemplary aspect of the present disclosure.

FIG. 19 is a schematic, side view of a portion of the exemplary turbofan engine of FIG. 18.

FIG. 20 is a schematic, forward-looking-aft view of a turbofan engine in accordance with still another exemplary aspect of the present disclosure.

FIG. 21 is a schematic, forward-looking-aft view of a rotor assembly of a turbofan engine in accordance with another exemplary aspect of the present disclosure.

FIG. 22 is a schematic, forward-looking-aft view of a plurality of outlet guide vanes coupled to a cowl of a turbomachine of the exemplary turbofan engine of FIG. 21.

FIG. 23 is a schematic, forward-looking-aft view of a rotor assembly of a turbofan engine in accordance with yet another exemplary aspect of the present disclosure.

FIG. 24 is a schematic, forward-looking-aft view of a plurality of outlet guide vanes coupled to a cowl of a turbomachine of the exemplary turbofan engine of FIG. 23.

FIG. 25 is a schematic, forward-looking-aft view of a rotor assembly of a turbofan engine in accordance with still another exemplary aspect of the present disclosure.

FIG. 26 is a schematic, forward-looking-aft view of a plurality of outlet guide vanes coupled to a cowl of a turbomachine of the exemplary turbofan engine of FIG. 25.

FIG. 27 is a schematic, forward-looking-aft view of a rotor assembly of a turbofan engine in accordance with yet another exemplary aspect of the present disclosure.

FIG. 28 is a schematic, forward-looking-aft view of a plurality of outlet guide vanes coupled to a cowl of a turbomachine of the exemplary turbofan engine of FIG. 27.

FIG. 29 is a schematic, forward-looking-aft view of a plurality of outlet guide vanes coupled to a cowl of a turbomachine of in accordance with another exemplary aspect of the present disclosure.

FIG. 30 is a graph depicting spans of a plurality of outlet guide vanes in accordance with an exemplary aspect of the present disclosure.

FIG. 31 is a graph depicting spans of a plurality of outlet guide vanes in accordance with another exemplary aspect of the present disclosure.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required.

### DETAILED DESCRIPTION

Aspects and advantages of the present disclosure will be set forth in part in the following description or may be learned through practice of the present disclosure.

The word “or” when used herein shall be interpreted as having a disjunctive construction rather than a conjunctive construction unless otherwise specifically indicated.

The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise.

The term “at least one of” in the context of, e.g., “at least one of A, B, and C” refers to only A, only B, only C, or any combination of A, B, and C.

The terms “forward” and “aft” refer to relative positions within a gas turbine engine or vehicle, and refer to the normal operational attitude of the gas turbine engine or vehicle. For example, with regard to a gas turbine engine, forward refers to a position closer to an engine inlet and aft refers to a position closer to an engine nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows.

The term “leading edge” refers to components and/or surfaces which are oriented predominately upstream relative to the fluid flow of the system, and the term “trailing edge” refers to components and/or surfaces which are oriented predominately downstream relative to the fluid flow of the system.

“Airfoil section” and “effective quarter chord point (QC)” are defined as follows.

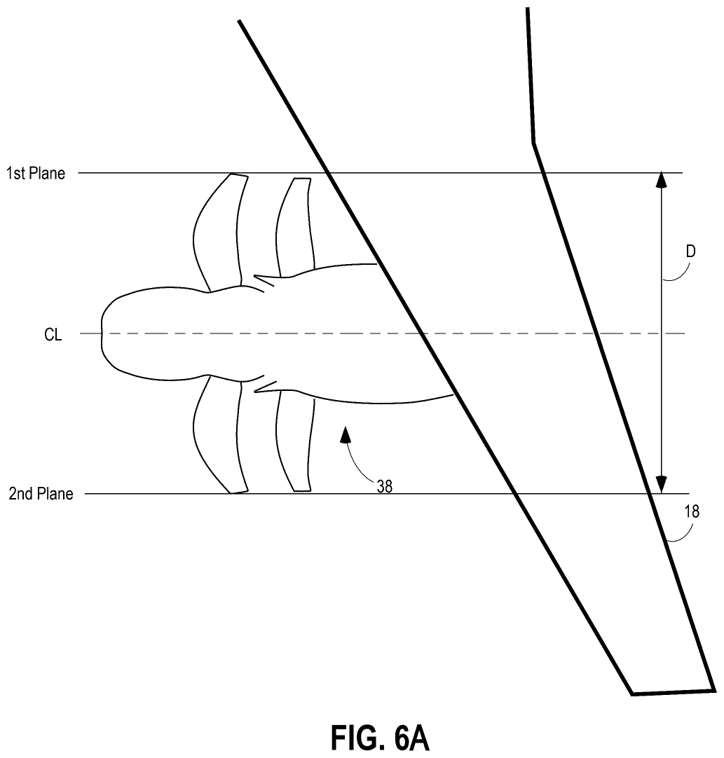

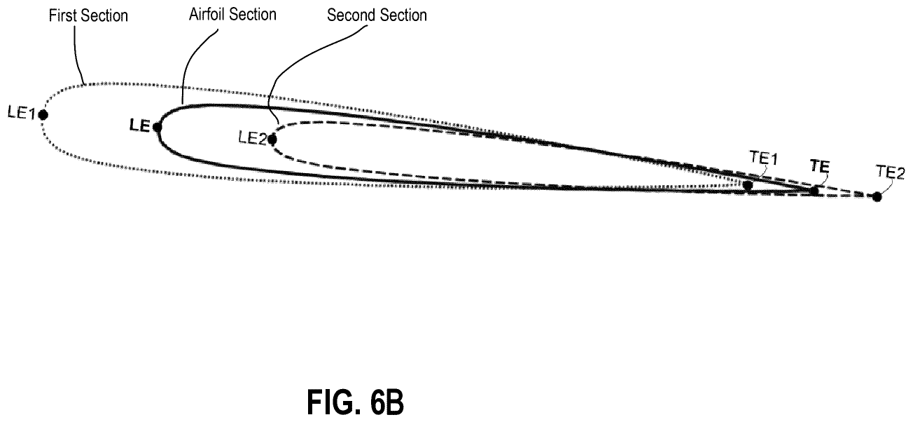

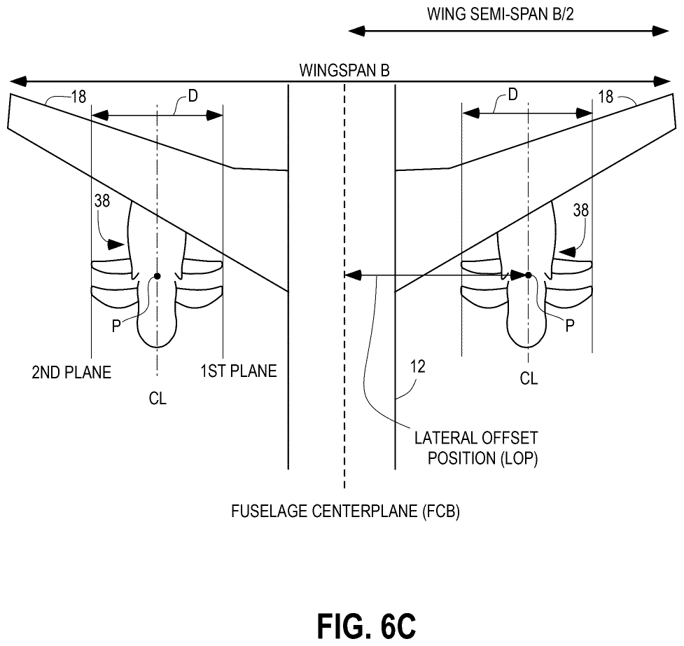

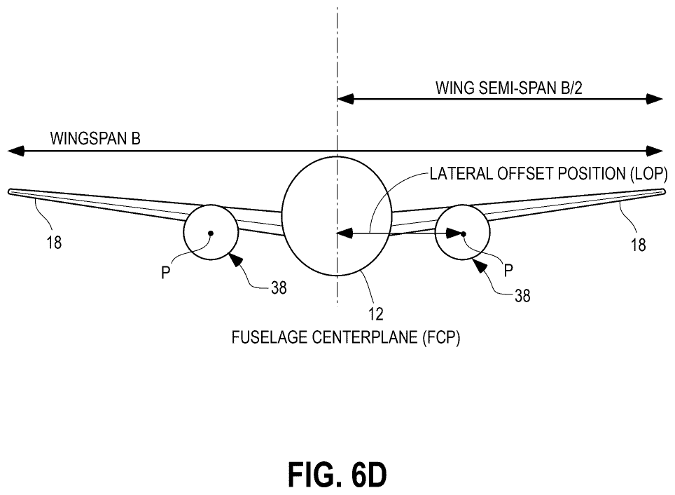

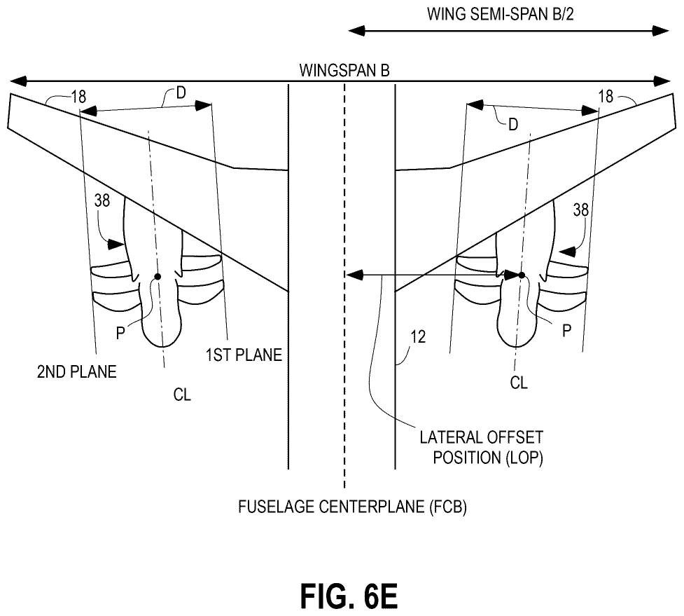

“Airfoil section” is defined as the average of a first offset plane section and a second offset plane section of an airfoil (e.g., an airfoil associated with a horizontal stabilizer or wing of an aircraft), where the first offset plane section is the section of the airfoil taken at a first plane and the second offset plane section is the section of the airfoil taken at a second plane, the first and second planes each being offset in a direction perpendicular to, and equidistant from a central plane by a distance of ½ of a fan diameter (D) of rotating blades of a propulsor mounted to the portion of the aircraft body associated with the airfoil section (wing or horizontal stabilizer). The first plane is inboard of the central plane (towards the fuselage) and the second plane is outboard of the central plane. When the aircraft is on the ground, both the gravity vector and axis of rotation of the rotating blades lie in the central plane. The intersection of the first offset plane with the airfoil defines a first section having a first section leading edge (LE1) and a first section trailing edge (TE1), with the LE1 at the forward-most point of the first section and the TE1 at the aft-most point of the first section. The intersection of the second offset plane with the airfoil defines a second section having a second section leading edge (LE2) and a second section trailing edge (TE2), with the LE2 at the forward-most point of the section and the TE2 at the aft-most point of the second section. Averaging the coordinates of LE1 and LE2 yields a representative LE location for the airfoil section. Averaging the coordinates of TE1 and TE2 yields a representative TE location for the airfoil section. The LE and TE points obtained this way are indicated in FIGS. 6 and 6B. An “Airfoil Section” defined herein has its leading and trailing edges TE, LE determined in this manner. “Effective Quarter-chord point” (“QC”) is defined as ¼ of the distance from the leading edge LE of the airfoil section determined in the foregoing manner, measured along the chord of this airfoil section. QC is dependent on the fan diameter (D) because the airfoil section LE and TE values change if D for the unducted fan propulsor changes.

“Cruise Speed” refers to aircraft speed and applies to a vehicle with a cruising altitude up to approximately 65,000 ft. In certain embodiments, cruise altitude is between approximately 28,000 ft. and approximately 45,000 ft. In still certain embodiments, cruise altitude is expressed in flight levels based on a standard air pressure at sea level, in which a cruise flight condition is between FL280 and FL650. In another embodiment, cruise flight condition is between FL280 and FL450. In still certain embodiments, cruise altitude is defined based at least on a barometric pressure, in which cruise altitude is between approximately 4.85 psia and approximately 0.82 psia based on a sea level pressure of approximately 14.70 psia and sea level temperature at approximately 59 degrees Fahrenheit. In another embodiment, cruise altitude is between approximately 4.85 psia and approximately 2.14 psia. It should be appreciated that in certain embodiments, the ranges of cruise altitude defined by pressure may be adjusted based on a different reference sea level pressure and/or sea level temperature.

It is understood that the plurality blades, whether forward or rearward, may have a variation of root forward-most points and root rearward-most points. This can be due to both installed position as well as orientation in the case of variable pitch blades. For purposes of defining the distances TRL, RTL, and VTL it is understood that a rotating blade or rotating array of blades are orientated such that the respective leading edges of the blades are in their most forward position, e.g., a feathered position. The respective trailing edge position is also obtained when the leading edge is in the most forward position. For purposes of defining the distances TRL, RTL, and VTL it is understood that the forward or leading edge or rearward or trailing edge of a stationary blade (or vane) or array of stationary blades (or vanes) is the most forward or leading edge position across the array of vanes or the most rearward or trailing edge position across the array of vanes.

“Blade” can refer to a stationary or rotating blade. “Stationary blade(s)” has the same meaning as “vane(s)”.

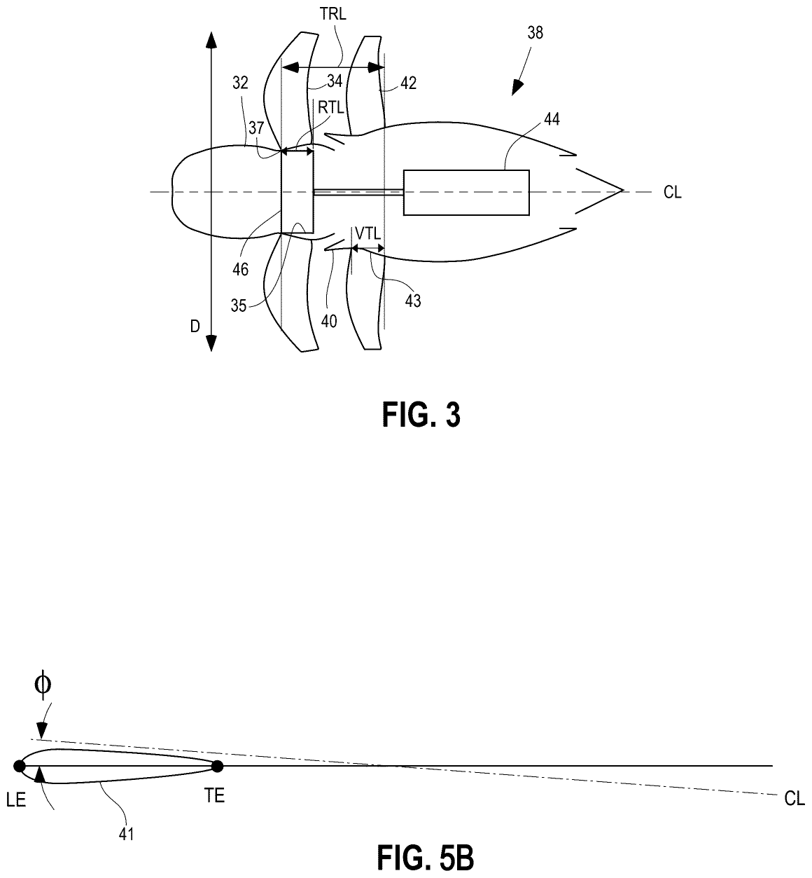

“Unducted fan propulsor” as used herein means an aircraft engine characterized by an array of rotating fan blades and static (or non-rotating), outlet guide vanes (OGV) aft of the array of rotating fan blades, or an array of rotating fan blades and static, unducted inlet guide vanes (IGV) forward of the rotating fan blades. In either case, neither the fan blades nor the IGV or OGV is surrounded by a duct or fan nacelle. FIG. 3 depicts an unducted fan propulsor. Additionally, the term unducted fan propulsor means an unducted, fan driven aircraft engine capable of providing thrust to an aircraft to enable cruise flight speeds between 0.7 Mach and 0.90 Mach, or 0.75 to 0.85 Mach.

“Aircraft” means a vehicle having a wing (and/or horizontal stabilizer), an airfoil defined by the wing (and/or horizontal stabilizer), and one or two unducted fan propulsors mounted to the wing, and the aircraft is operable at cruise flight speeds between 0.7 Mach and 0.90 Mach, or 0.75 to 0.85 Mach.

“Fuselage centerplane” (“FCP”) is defined as a plane that is located equidistant from the wingtips, intersecting the fuselage, and containing the gravity vector when the aircraft is on the ground.

Approximating language, as used herein throughout the specification and claims, is applied to modify any quantitative representation that could permissibly vary without resulting in a change in the basic function to which it is related. Accordingly, a value modified by a term or terms such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

As used herein, the term “proximate” refers to being closer to one side or end than an opposite side or end.

The term “propulsive efficiency” refers to an efficiency with which the energy contained in an engine's fuel is converted into kinetic energy for the vehicle incorporating the engine, to accelerate it, or to replace losses due to aerodynamic drag or gravity.

The terms “coupled,” “fixed,” “attached to,” and the like refer to both direct coupling, fixing, or attaching, as well as indirect coupling, fixing, or attaching through one or more intermediate components or features, unless otherwise specified herein.

As used herein, the terms “first”, “second”, and “third” may be used interchangeably to distinguish one component from another and are not intended to signify location or importance of the individual components.

As used herein, the term “adjacent” when used to identify a component of a plurality of the same or similar components relative to a base component, refers to a component of the plurality of components positioned next to the base component with no intervening components of the plurality of components positioned therebetween. For example, when used to identify an outlet guide vane of a plurality of outlet guide vanes relative to a first outlet guide vane (e.g., “an outlet guide vane adjacent the first outlet guide vane”), adjacent refers to one of the outlet guide vanes positioned next to the first outlet guide vane with no intervening outlet guide vanes positioned therebetween.

The term “highest loaded rotor blade” with reference to a rotor assembly of a gas turbine engine, refers to the rotor blade that is subjected to the highest aerodynamic load of all the individual rotor blades during an operating condition of the gas turbine engine at a single instance. The “aerodynamic load” on the rotor blades refers to the total force on an individual rotor blade, e.g., as a result of a pressure change across the rotor blade. As will be appreciated from the description hereinbelow, during a climb operating mode (e.g., a high angle of attack mode), the highest loaded rotor blade may be located 90 degrees from top-dead-center in a direction of rotation of the rotor assembly. During other operating modes (e.g., cruise), the highest loaded rotor blade may be determined based on a position of a pylon fairing, a wing, etc.

A “third stream” as used herein means a non-primary air stream capable of increasing fluid energy to produce a minority of total propulsion system thrust. The third stream may generally receive inlet air (air from a ducted passage downstream of a primary fan) instead of freestream air (as the primary fan would). A pressure ratio of the third stream may be higher than that of the primary propulsion stream (e.g., a bypass or propeller driven propulsion stream). The thrust may be produced through a dedicated nozzle or through mixing of an airflow through the third stream with a primary propulsion stream or a core air stream, e.g., into a common nozzle.

In certain exemplary embodiments an operating temperature of the airflow through the third stream may be less than a maximum compressor discharge temperature for the engine, and more specifically may be less than 350 degrees Fahrenheit (such as less than 300 degrees Fahrenheit, such as less than 250 degrees Fahrenheit, such as less than 200 degrees Fahrenheit, and at least as great as an ambient temperature). In certain exemplary embodiments these operating temperatures may facilitate heat transfer to or from the airflow through the third stream and a separate fluid stream. Further, in certain exemplary embodiments, the airflow through the third stream may contribute less than 50% of the total engine thrust (and at least, e.g., 2% of the total engine thrust) at a takeoff condition, or more particularly while operating at a rated takeoff power at sea level, static flight speed, 86 degree Fahrenheit ambient temperature operating conditions.

Furthermore in certain exemplary embodiments, aspects of the airflow through the third stream (e.g., airstream, mixing, or exhaust properties), and thereby the aforementioned exemplary percent contribution to total thrust, may passively adjust during engine operation or be modified purposefully through use of engine control features (such as fuel flow, electric machine power, variable stators, variable inlet guide vanes, valves, variable exhaust geometry, or fluidic features) to adjust or optimize overall system performance across a broad range of potential operating conditions.

The inventors were faced with a problem of how to improve thrust delivered to an aircraft by an unducted fan propulsor without increasing the required engine power delivered to the unducted fan of the unducted fan propulsor.

It was surprisingly found that the solution to this problem is heavily dependent on the location of the unducted fan propulsor relative to the aircraft wing.

The inventors found that installing an unducted fan propulsor presents the challenge of addressing penalties that can result due to the interaction with the rest of the aircraft. The manner in which these penalties are addressed according to the claimed subject matter is unique for this type of engine.

An unducted fan propulsor is particularly challenged due to the scrubbing and interference drags relative to a ducted turbofan. That additional drag then results in a higher thrust needed from the propulsor. Generally, higher thrust for a ducted turbofan comes with a larger power requirement and thus more fuel flow. For the unducted fan propulsor it was surprisingly found by placing the engine so that it can take advantage of the high pressure flow induced by the wing (and/or a horizontal stabilizer), engine thrust may increase without increasing the power requirement on the engine. This placement of the engine relative to the wing then acts to offset the scrubbing and interference drag, thus not increasing the required fuel (or reducing the increased fuel flow required for a non-optimum engine placement). The inventors found that increased drag effects associated with an unducted fan propulsor, rather than addressed directly, may instead be offset by placing the engine at a more optimal location relative to the wing.

Additionally, the inventors found that the installed engine's improved position also positively influences the noise produced by the wing-engine interaction during flight at cruise conditions.

It was surprisingly found that by adapting a particular location on an unducted fan propulsor relative to an aircraft wing's effective quarter chord point (QC), the desired result of offsetting interference and scrubbing drag without increasing the power delivered to the fan could be achieved for an unducted fan propulsor.

It was also found that the improved position is dependent on the fan blade size of the unducted fan propulsor.

As explained below, after recognizing the novel flow characteristics associated with an unducted fan propulsor installed on an aircraft, taking into account the limitations on where to place this propulsor, the inventors were surprisingly able to establish criteria for positioning the propulsor relative to an aircraft wing to offset interference and scrubbing effects by defining a midpoint (P) location between external output guide vanes (OGV) or input guide vanes (IGV) and a forward or aft rotating array of fan blades, respectively, and additionally defining the distance from the effective quarter chord point (QC) to P. The position of P relative to QC and QC itself were found dependent on the rotating fan diameter. The correlation of these parameters to offset interference and scrubbing effects was not used before and was the surprising finding of the inventors for an unducted fan propulsor. Thus, mounting unducted fan propulsors relative to the effective quarter-chord point (QC) and fan blade size as described in embodiments provided herein offsets interference and scrubbing effects associated with an unducted fan propulsor and is an improvement over other mounting locations, including conventional mounting locations that are more forward of, and more in line with, a wing chord line.

Various aspects of the present disclosure describe aspects of an aircraft characterized in part by a specific relation between an effective quarter chord point (QC) of an airfoil section associated with a wing (or horizontal stabilizer) and the unducted fan propulsor, which is believed to result in improved aircraft performance and/or fuel efficiency. According to the disclosure, an aircraft includes a fuselage and an unducted fan propulsor installed relative to a section of the wing or the horizontal stabilizer.

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

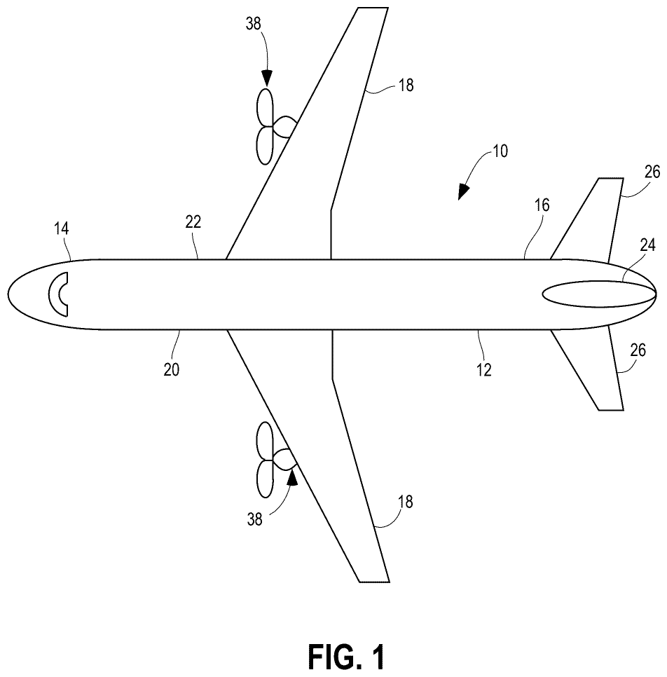

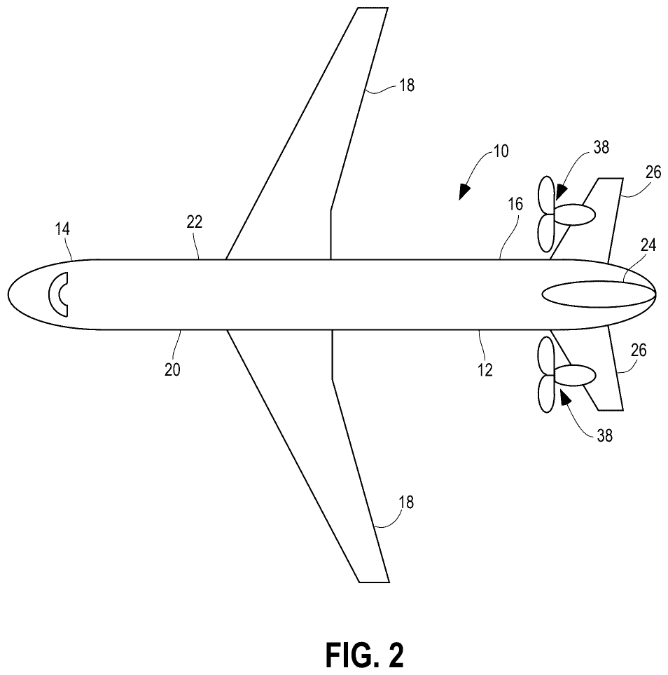

As shown in FIGS. 1 and 2, the aircraft 10 includes a fuselage 12 that extends longitudinally from a forward or nose section 14 and an aft or tail section 16 of the aircraft 10. The aircraft 10 further includes airfoils including a first wing 18 that extends laterally outwardly from a port side 20 and a second wing 18 that extends laterally outwardly from a starboard side 22 of the fuselage 12. The tail section 16 of the aircraft 10 includes a vertical stabilizer 24, a first airfoil of the horizontal stabilizer 26 that extends laterally outwardly from the port side 20, and a second airfoil of the horizontal stabilizer 26 that extends laterally outward from the starboard side 22 of the fuselage 12. An unducted fan propulsor 38 is undermounted relative to each of the wings 18, as shown in the embodiment of FIG. 1. Alternatively, the unducted fan propulsor 38 is mounted relative to the top of each of the horizontal stabilizers 26, as shown in FIG. 2. In some embodiments, more than one of the unducted fan propulsors 30 or 38 may be mounted to each of the wings 18 or each of the horizontal stabilizers 26.

FIG. 3 shows an elevational cross-sectional view of an embodiment of one of the unducted fan propulsors 38. As is seen from FIG. 3, the unducted fan propulsor 38 takes the form of an open fan propulsion system and has a rotating element in the form of rotatable propeller assembly 32 on which is mounted a first array of blades 34 around a centerline (CL) of the unducted fan propulsor 38. The first array of blades 34 defines a diameter D representing the tip-to-tip diameter of the blades and a maximum radial extent from CL. This diameter D is measured along a radial direction perpendicular to CL. The unducted fan propulsor 38 of FIG. 3 includes a second array of blades or vanes, which are non-rotating or static. In some embodiments, a non-rotating stationary element in the form of vane assembly 40 includes an array of vanes 42 disposed around CL.

Each of the blades 34 has a root 35 where the blade 34 is attached to the rotatable propeller assembly 32, and each blade 34 defines a root length (RTL). The root length (RTL) is defined as the axial extent (in a direction parallel to CL) from the radially innermost leading edge (LE) of the blade 34 airfoil, e.g., closest to CL, to the axial location of the radially innermost trailing edge (TE) of the blade 34 airfoil.

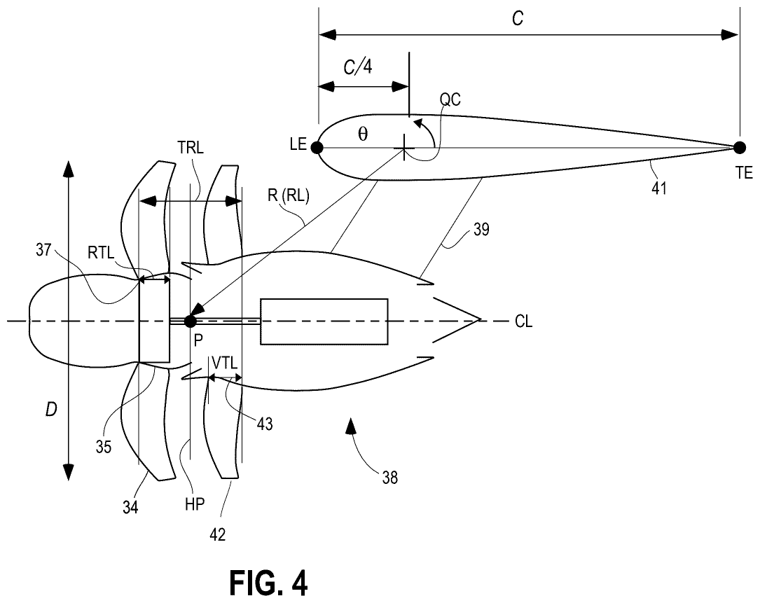

Each of the vanes 42 also has a root 43 with a vane root distance VTL where the vane 42 is attached to the non-rotating vane assembly 40. The total root length (TRL) is the distance between the leading edge (LE) of the blade 34 airfoil (radially nearest to CL) of the blades 34 and the trailing edge (LE) of the root 43 of the vanes 42, as shown in FIGS. 3 and 4. TRL is a measured axial distance from the radial innermost LE of the foremost row of blades/vanes and the trailing edge (TE) of the vanes 42. In some embodiments, the second array may instead be a second rotating elements and the TRL is the measured axial distance from the radially innermost LE of the blades 34 of the first rotating element and the TE of the root of the blades of the second rotating elements. In some embodiments, the vanes 42 may be forward of the rotating blades, and the TRL is the distance between the LE edge of the root of the vanes and the TE of the root of the rotating blades. In some embodiments, an unducted fan propulsor having rotating elements (e.g., rotating blades) and stationary elements (e.g. vanes) may be mounted according to the relationship described in the present disclosure. In unducted fan propulsors having multiple rows of blade and/or vanes, the TRL of an unducted fan propulsor is defined as the distance between the LE of the root of the foremost row of blades/vanes and the rearward edge of the root of the aftmost row of blades/vanes of the unducted fan propulsor.

Referring to FIG. 4, for purposes explained more later, the unducted fan propulsor 38 has a point P. For the unducted fan propulsor 38 with a first array of blades or vanes 34 and a second array of blades or vanes 42, as shown in FIGS. 3 and 4, the point P is located at the intersection of CL and a line HP perpendicular to CL and that passes through an axial midpoint of the total root length TRL between a forward end at the root of one of the blades 34 of the forward array and a rearward end at the root of one of the blades 42 of the rearward array when aligned with the one of the blades 34 of the forward array, as shown in FIG. 6. Either the forward or rearward array can be vanes or blades. In other words, the line HP is located equidistant from a forward end of the root of one of the forward vanes or blades 34 and a rearward end of the root of one of the rearward blades or vanes 42. The TRL of an unducted fan propulsor is defined as the distance between the LE of the root of the forward row of blades/vanes and the rearward edge of the root of the aftmost blade/vane.

Referring again to FIG. 3, the exemplary unducted fan propulsor 38 includes a drive mechanism 44 that provides torque and power to the propeller assembly 32 through a transmission 46. The drive mechanism 44 may be a gas turbine engine and associated transmission 46. Transmission 46 delivers torque from the drive mechanism 44 to the propeller assembly 32. The transmission system can be configured as a direct drive engine, transferring power from a power turbine or low pressure turbine (LPT) to the propeller assembly, or an indirect drive system where torque from the LPT is transferred to the propeller assembly 32 through a gearbox. The gearbox reduces a rotation speed of the drive shaft to match a desired rotational speed for the propeller assembly 32. The gas turbine engine includes in serial order a compressor, combustor, high pressure turbine and the LPT. In other embodiments the drive mechanism may generate power partially or fully by an electric motor. In the former case the drive mechanism is a hybrid electric drive mechanism including a gas turbine engine where a drive shaft includes an electric motor-generator for generating torque. In the latter case the drive mechanism is an electric motor.

The unducted fan propulsor 38 is attached relative to the wings 18 or horizontal stabilizer 26 through one or more intermediate components or features, e.g., a pylon 39, as shown in FIG. 4.

Each of the wings 18 shown in FIG. 1, and horizontal stabilizers 26 shown in FIG. 2, has an airfoil section 41 associated with it, where the airfoil section 41 is defined above.

As depicted in FIG. 4, a chord line C of the airfoil section, length C as shown, is a straight line extending from LE to TE of the airfoil section (it will be understood that the airfoil section as shown and defined herein is not meant to indicate any particular camber associated with an aircraft wing). The effective quarter-chord point (QC) of the airfoil section is located on the chord line. QC is located at a distance of C/4 from the LE of the airfoil section 41.

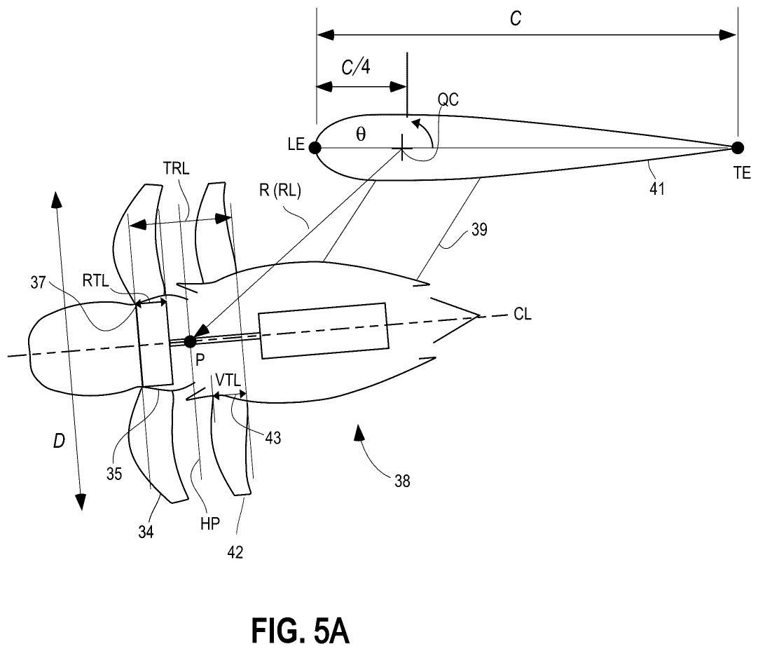

As shown in FIG. 4, the CL of the propulsor 38 and the chord line C are parallel to each other, corresponding to a zero pitch of the propulsor relative to the chord line C. The propulsor 38 can be pitched at different angles relative to the chord line, such as pitched downward as shown in FIG. 5A. FIG. 5B defines a pitch angle φ for the propulsor 38, which is the angle spanned between the propulsor centerline CL and chord line C. Positive pitch corresponds to a clockwise rotation of CL relative to C. The pitch angle φ can be fixed or variable during flight. For underwing installations, the pitch angle φ can vary between −5 and +2 degrees, or it can vary between −3 and 0 degrees. During cruise conditions, propulsor pitch and toe angle (FIG. 6E, defined below) provide for an improved installed aerodynamic performance for the unducted fan propulsor in terms of reduced cabin noise and reduced off-axis loading of the unducted fan propulsor's drive shaft. For aft horizontal stabilizer or aft fuselage installations, the angle φ can vary between −2 and +5 degrees to more align with downwash created by the wing.

The position of the open fan propulsor 38 is defined relative to QC. The airfoil section, as defined above, is the average of a first offset plane section and a second offset plane section of the airfoil (of the wing), where the first offset plane section is the section of the airfoil taken at a first plane and the second offset plane section is the section of the airfoil taken at a second plane, the first and second planes being offset in a direction perpendicular to, and equidistant from a central plane by a distance of ½ the maximum fan diameter (D) for the rotating blades, as shown in FIG. 6A. Both the gravity vector and axis of rotation of the rotating blades of the propulsor lie in this central plane when the aircraft is on the ground.

Referring to FIG. 6C, the propulsor 38—specifically, point P of the propulsor 38—has a spanwise location laterally offset from the fuselage centerplane (FCP) relative to the aircraft's wingspan B. P has a laterally offset position (LOP) between 10% and 80%, 20% and 40%, or between 25% and 35% of B/2 measured from the fuselage centerplane (FCP), as defined above. The location of P is also chosen to avoid interference with the fuselage or an adjacent propulsor if more than one propulsor is mounted relative to the wing. For an aft fuselage installation, the LOP of the propulsor will be closer to the fuselage, but far enough away from the fuselage's boundary layer to reduce or avoid undue interaction with the fuselage boundary layer.

As shown in FIG. 6C, the propulsor centerline CL and the fuselage centerplane (FCP) can be orientated parallel to each other. Referring to FIG. 6D, other angles between propulsor centerline CL and the fuselage centerplane (FCP) are contemplated. For an underwing mounted propulsor, the toe angle can provide added benefit when positive (i.e., the rotor toed-in towards the fuselage with the forward end of the propulsor 38 being more inboard than the aft end). The propulsor can have an inward toe angle of between 0 and 5 degrees, or between 1 and 3 degrees.

There are specific locations that the inventors have found to be advantageous to position the unducted fan propulsor 38 to generate increased thrust using higher pressure air flow, in order to offset the scrubbing and interference drag. The higher pressure air flow can be beneath the wings 18. In the case of a horizontal stabilizer 26, the higher pressure air flow is above the horizontal stabilizer 26. Accordingly, the high-pressure side of an airfoil may refer to the underside of a wing 18 or the top side of a horizontal stabilizer 26.

The aircraft described herein has a fuselage, wings and/or stabilizers, and two or more unducted fan propulsor systems (or propulsors). The unducted fan propulsor system, which is mounted on the pressure side of a wing or horizontal stabilizer, provides thrust to the aircraft. To improve upon what the propulsor system can deliver, there often is a need to make compromises to other parts of aircraft design (trade-offs). Stated another way, the benefits of an unducted fan propulsor cannot be viewed without consideration of the effect of placement of the propulsor on the aircraft. For example, placement can affect loads on and size of the pylon, wing loads, landing gear length and associated forces, weight, and cost.

The teachings described below enable improved balancing of the tradeoffs required in the aircraft design while positioning the unducted fan propulsor relative to the airfoil section's effective quarter chord point QC to offset scrubbing and interference drag loses.

Referring to FIG. 4, the location of an unducted fan propulsor relative to an airfoil section 41 is defined herein using a polar coordinate system having an angular (θ) coordinate and a radial (R) component, with origin located at the effective quarter chord point (QC) of the airfoil section having a chord length (C) as shown. The radial component is referred to herein as a “positioning line (R)”. The location of the point P of the unducted fan propulsor 38 relative to the origin (QC) of the polar coordinate system (the origin of the coordinate system is the same as the effective quarter chord point for airfoil section 41) is expressed in terms of a vector having radial component R with magnitude RL and angular component θ. The vector magnitude RL is called a “positioning line length (RL)”.

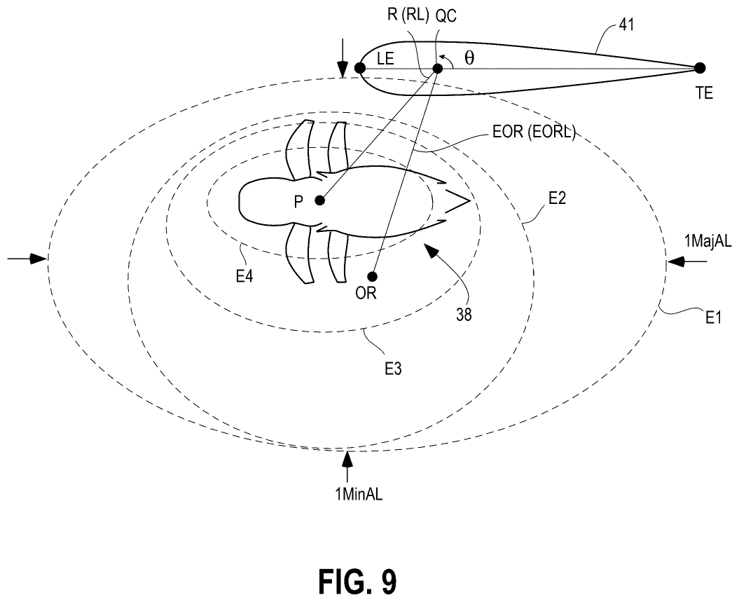

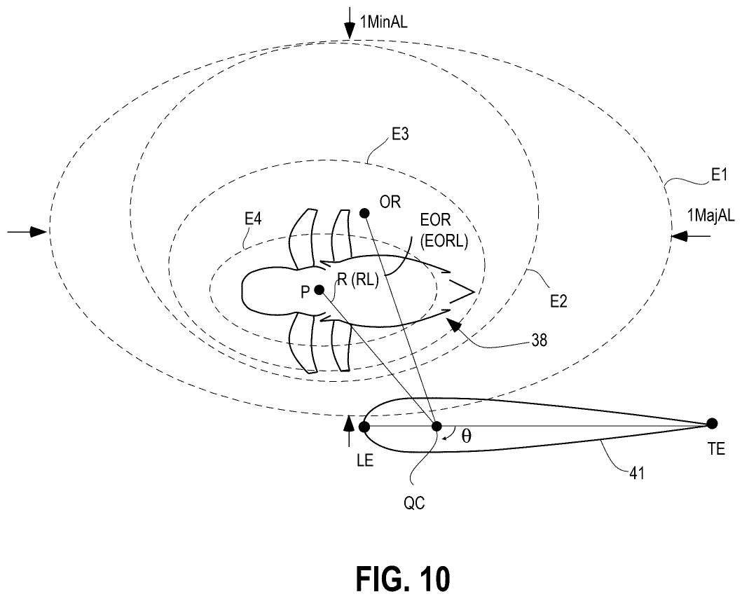

The angle θ is measured relative to a datum that is the airfoil section chord line (e.g., in FIG. 6 the vector R is located by an angle that is between 180 and 270 degrees measured counterclockwise about origin QC relative to the chord line). When viewed looking from an outboard position towards an inboard position (e.g., the fuselage), θ is positive in a counter-clockwise direction when the propulsor is below the airfoil section 41 (wing, FIG. 9), and θ is positive in a clockwise direction when the propulsor is above the airfoil section (horizontal stabilizer, FIG. 10) as indicated in the drawings, respectively, by the direction of the arrow from the origin.

The inventors found that for an unducted fan propulsor system the ratio of RL over D (i.e., RL/D) is desirably less than or equal to 2, less than or equal to 2 and greater than or equal to 0.15, or less than or equal to 2 and greater than or equal to 0.35. Additionally, for the undermounted unducted fan propulsor systems (pressure side of the airfoil section) of FIGS. 5 and 6 the angular component θ associated with these ranges for RL/D and locating the unducted fan propulsor system (i.e., the location of P relative to the airfoil section) are desirably between 187° and 342°, between 198° and 310°, or between 205° and 285°. These regions of RL and θ locating the unducted fan propulsor system relative to the airfoil section tend to offset scrubbing and interference drag for an unducted fan propulsor.

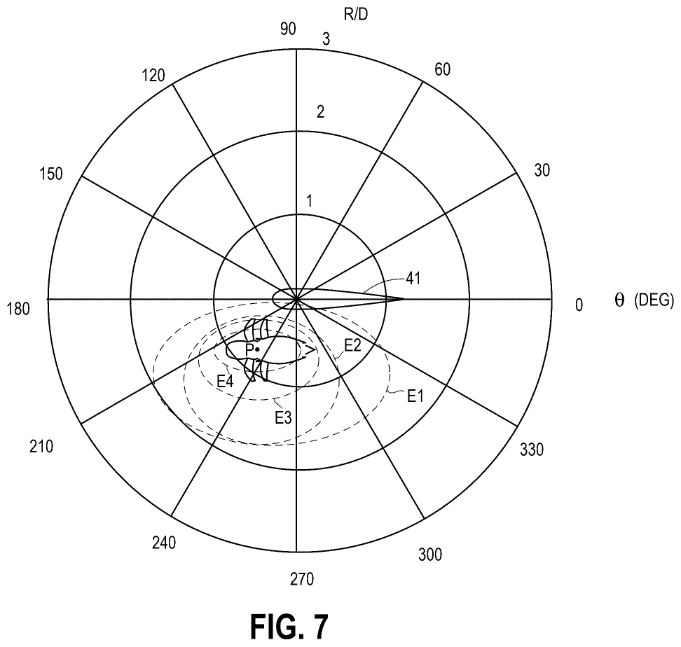

Alternatively, the point P for the unducted fan propulsor can be located within a defined ellipse defining a region relative to QC where scrubbing and interference drag tends to offset. FIGS. 7-10 each illustrate such ellipses according to several embodiments. Each of the ellipses has an origin OR, a major axis length (MajAL), and a minor axis length (MinAL), as shown in FIGS. 9 and 10 with respect to one of several ellipses and as will be explained further below. The location of OR is expressed relative to QC using the polar coordinate system frame of reference defined earlier. The propulsor system is mounted such that the point P of the unducted fan propulsors 38 is located within an ellipse as defined herein.

Referring to FIG. 9, the radial ellipse origin positioning line (EOR) extends from the ellipse origin OR, e.g., ellipse E1, to QC. The ellipse origin position line EOR has a length EORL. The origin of each of the ellipses is defined in the adopted polar coordinates with a radial coordinate defined as the ratio of EORL to the array of blades diameter (D), i.e., the quantity EORL/D. The angle θ is measured relative to the chord line (as defined earlier) and positive in a clockwise direction when the propulsor is above the airfoil section (horizontal stabilizer, FIG. 10) as indicated in the drawings, respectively, by the direction of the arrow from the origin.

An angle θ for the ellipse origin positioning line EOR is measured from a datum that is the chord line to an ellipse positioning line EOR (e.g., in FIG. 9 the vector EOR is located by an angle that is between 180 and 270 degrees measured counterclockwise about origin QC). A positive θ (1) increases in a counter-clockwise direction when the high pressure side of the airfoil section is below the airfoil section, and (2) increases in a clockwise direction when the high pressure side of the airfoil section is above the airfoil section.

In a first embodiment, the point P of the unducted fan propulsor 38 is located in a first ellipse E1 with a first ellipse origin defined by EORL/D of 0.938 and θ of 253.6°. The first ellipse E1 also has a first major axis length (1MajAL) and a first minor axis length (1MinAL), where 1MajAL/D is 2.8 and 1MinAL/D is 1.7. An unducted fan propulsor located within E1 tends to offset scrubbing and interference drag.

In a second embodiment, the point P of the unducted fan propulsor 38 is located in a second ellipse E2 having a second ellipse origin defined by EORL/D of 1.051 and θ of 248.8°. The second ellipse E2 has a second major axis length (2MajAL) and a second minor axis length (2MinAL), where 2MajAL/D is 1.86 and 2MinAL/D is 1.56. An unducted fan propulsor located within E2 tends to offset scrubbing and interference drag.

In a third embodiment, the point P of the unducted fan propulsor 38 is located in a third ellipse E3 having a third ellipse origin defined by EORL/D of 0.870 and θ of 239.6°. The third ellipse E3 has a third major axis length (3MajAL) and a third minor axis length (3MinAL), where 3MajAL/D is 1.4 and 3MinAL/D is 0.9. An unducted fan propulsor located within E3 tends to offset scrubbing and interference drag.

In a fourth embodiment, the point P of the unducted fan propulsor 38 is located in a fourth ellipse E4 having a fourth ellipse origin defined by EORL/D of 0.763 and θ of 235.7°. The fourth ellipse E4 has a fourth major axis length (4MajAL) and a fourth minor axis length (4MinAL), where 4MajAL/D is 0.94 and 4MinAL/D is 0.44. An unducted fan propulsor located within E4 tends to offset scrubbing and interference drag.

The location of the unducted fan propulsor system (i.e., point P) relative to the airfoil section may also be expressed in terms of the following expressions:

$$\frac{RL}{D} + \frac{( \begin{matrix}\sqrt{a * [ b * {sin}^{2} ( θ ) - c * {cos}^{2} ( θ ) + d * sin ( θ ) * cos ( θ ) ]} + \\ e * sin ( θ ) + f * cos ( θ )\end{matrix} )}{g * {sin}^{2} ( θ ) + h * {cos}^{2} ( θ )} > 0$$

$$and$$

$$\frac{RL}{D} + \frac{( \begin{matrix}- \sqrt{a * [ b * {sin}^{2} ( θ ) - c * {cos}^{2} ( θ ) + d * sin ( θ ) * cos ( θ ) ]} + \\ e * sin ( θ ) + f * cos ( θ )\end{matrix} )}{g * {sin}^{2} ( θ ) + h * {cos}^{2} ( θ )} < 0$$

where 0.07<RL/D<1.98 and θ is between 187° and 340°, and where a, b, c, d, e, f, g and h have the values set forth in the following table under the heading “Fifth Emb.”:

| | Fifth | Sixth | Seventh | Eighth |
|---|---|---|---|---|
| Variable | Emb. | Emb. | Emb. | Emb. |
| a | 1.4161 | 0.52621 | 0.09923 | 0.01069156 |
| b | 1.88978 | 0.7205 | 0.2964 | 0.036 |
| c | 0.0875 | 0.352 | 0.36 | 0.3485 |
| d | 0.477 | 0.7448 | 0.66 | 0.5418 |
| e | 1.764 | 0.8476 | 0.3675 | 0.139167 |
| f | 0.19146 | 0.23119 | 0.0891 | 0.020812 |
| g | 1.96 | 0.8649 | 0.49 | 0.2209 |
| h | 0.7225 | 0.6084 | 0.2025 | 0.0484 |

In a sixth embodiment, the point P of the unducted fan propulsor 38 can be defined by the above expression, but where 0.254<RL/D<1.86 and θ is between 199° and 306°, and where a, b, c, d, e, f, g and h have the values set forth in the above table under the heading “Sixth Emb.”

In a seventh embodiment, the point P of the unducted fan propulsor 38 can be defined by the above expression, but where 0.369<RL/D<1.43 and θ is between 204° and 291°, and where a, b, c, d, e, f, g and h have the values set forth in the above table under the heading “Seventh Emb.”.

In an eighth embodiment, the point P of the unducted fan propulsor 38 can be defined by the above expression, but where 0.477<RL/D<0.9455 and θ is between 211° and 274°, And where a, b, c, d, e, f, g and h have the values set forth in the above table under the heading “Eighth Emb.”

The unducted fan propulsor locations illustrated in FIG. 7 are made relative to an airfoil section of an aircraft wing and refer to an undermounted unducted fan propulsor system.

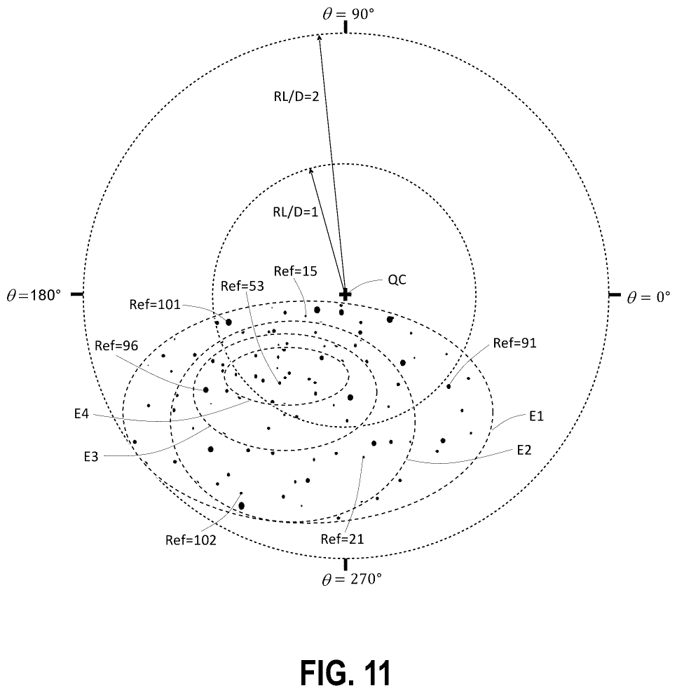

TABLES 1 and 3-6 set forth examples of embodiments of invention. TABLE 1 shows each maximum outer diameter (D) and the location of point P of the unducted fan propulsor relative to the effective quarter chord point, QC, contemplated, where the point P is defined by RL and θ. The term “Ref.” refers to the row in Table 1 for reference. The exemplary types of aircraft indicated with reference letters A through I in TABLE 1 are identified in TABLE 2. The point P of the unducted fan propulsor locations from TABLE 1 are shown in FIG. 11 for an under-wing mounted propulsor (for a propulsor mounted above a horizontal stabilizer the maximum outer diameter (D) and the point P of the unducted fan propulsor locations would be mirrored about the chord line of the airfoil section, which, for purposes of explanation, may be thought of as an axis passing through θ=0 deg and θ=180 deg in FIG. 11) relative to the first ellipse (E1), second ellipse (E2), third ellipse (E3), and the fourth ellipse (E4). The size of the points in FIG. 11 represent the relative size of D for the range provided in TABLE 1 (not to scale). The rotating blades diameter (D) may be between 2-50, 8-16, 10-15, 12-14, or 14-16 feet.

TABLE 1
P-location relative to airfoil section quarter chord point (QC)

| | Type of | RL | D | | |
|---|---|---|---|---|---|
| Ref. | aircraft | (ft) | (ft) | θ (deg) | RL/D |
| 1 | C I | 2.60 | 2.0 | 220.00 | 1.30 |
| 2 | F I | 1.07 | 2.0 | 189.00 | 0.54 |
| 3 | I | 3.13 | 2.0 | 199.73 | 1.57 |
| 4 | C F I | 2.18 | 3.0 | 319.20 | 0.73 |
| 5 | F I | 2.82 | 3.0 | 242.40 | 0.94 |
| 6 | C I | 1.47 | 4.0 | 293.60 | 0.37 |
| 7 | C I | 2.43 | 4.0 | 217.87 | 0.61 |
| 8 | I | 6.64 | 4.0 | 259.47 | 1.66 |
| 9 | C F I | 4.23 | 5.0 | 265.87 | 0.85 |
| 10 | C H I | 6.57 | 5.0 | 194.40 | 1.31 |
| 11 | F I | 2.03 | 5.0 | 250.93 | 0.41 |
| 12 | C F H I | 8.03 | 5.0 | 275.47 | 1.61 |
| 13 | C | 2.52 | 6.0 | 337.33 | 0.42 |
| 14 | H | 4.44 | 6.0 | 228.53 | 0.74 |
| 15 | C I | 1.88 | 6.0 | 208.27 | 0.31 |
| 16 | C F | 7.14 | 7.0 | 244.53 | 1.02 |
| 17 | B F H | 4.15 | 7.0 | 332.00 | 0.59 |
| 18 | B C I | 6.49 | 7.0 | 292.53 | 0.93 |
| 19 | C G | 8.05 | 8.0 | 216.80 | 1.01 |
| 20 | B F I | 11.89 | 8.0 | 256.27 | 1.49 |
| 21 | C G H | 10.08 | 8.0 | 277.60 | 1.26 |
| 22 | B C G I | 7.31 | 8.0 | 330.93 | 0.91 |
| 23 | C H | 9.97 | 8.0 | 294.67 | 1.25 |
| 24 | G I | 11.57 | 8.0 | 312.80 | 1.45 |
| 25 | B F I | 11.58 | 9.0 | 260.53 | 1.29 |
| 26 | C H | 6.06 | 9.0 | 224.27 | 0.67 |
| 27 | F G H | 3.06 | 9.0 | 233.87 | 0.34 |
| 28 | C I | 12.78 | 9.0 | 204.00 | 1.42 |
| 29 | B H | 10.47 | 10.0 | 210.40 | 1.05 |
| 30 | B I | 5.53 | 10.0 | 221.07 | 0.55 |
| 31 | A B C F G H | 7.00 | 10.0 | 253.07 | 0.70 |
| 32 | I | 2.47 | 10.0 | 306.40 | 0.25 |
| 33 | A C | 15.27 | 10.0 | 222.13 | 1.53 |
| 34 | G | 11.67 | 10.0 | 241.33 | 1.17 |
| 35 | A C F H | 17.13 | 10.0 | 243.47 | 1.71 |
| 36 | A B G I | 18.70 | 11.0 | 210.00 | 1.70 |
| 37 | G | 10.93 | 11.0 | 249.87 | 0.99 |
| 38 | A H | 4.33 | 11.0 | 285.07 | 0.39 |
| 39 | F I | 6.82 | 11.0 | 206.13 | 0.62 |
| 40 | A F H | 11.60 | 12.0 | 272.27 | 0.97 |
| 41 | A B F I | 10.64 | 12.0 | 227.47 | 0.89 |
| 42 | A H | 21.84 | 12.0 | 232.80 | 1.82 |
| 43 | A G | 8.56 | 12.0 | 236.00 | 0.71 |
| 44 | B F H | 0.78 | 12.0 | 263.50 | 0.07 |
| 45 | A F | 10.00 | 12.5 | 200.00 | 0.80 |
| 46 | A B G H I | 15.25 | 12.5 | 268.00 | 1.22 |
| 47 | B | 19.92 | 12.5 | 279.73 | 1.59 |
| 48 | A B F | 15.92 | 12.5 | 316.00 | 1.27 |
| 49 | A B | 6.25 | 12.5 | 270.13 | 0.50 |
| 50 | A F H | 18.42 | 12.5 | 211.47 | 1.47 |
| 51 | F G | 24.25 | 12.5 | 215.73 | 1.94 |
| 52 | A B H | 19.50 | 13.0 | 287.20 | 1.50 |
| 53 | H | 10.66 | 13.0 | 234.93 | 0.82 |
| 54 | B | 14.99 | 13.0 | 326.67 | 1.15 |
| 55 | I | 18.11 | 13.0 | 239.20 | 1.39 |
| 56 | A B F H | 23.49 | 13.0 | 225.33 | 1.81 |
| 57 | A F G H | 10.49 | 13.0 | 302.13 | 0.81 |
| 58 | B I | 3.38 | 13.0 | 231.73 | 0.26 |
| 59 | A B G | 13.95 | 13.0 | 212.53 | 1.07 |
| 60 | A B H | 10.14 | 13.0 | 255.20 | 0.78 |
| 61 | F | 10.80 | 13.5 | 215.00 | 0.80 |
| 62 | A H I | 19.35 | 13.5 | 198.67 | 1.43 |
| 63 | B F | 15.39 | 13.5 | 220.00 | 1.14 |
| 64 | A G H I | 7.83 | 13.5 | 207.20 | 0.58 |
| 65 | B H | 10.30 | 13.5 | 235.70 | 0.76 |
| 66 | A B | 23.49 | 13.5 | 237.07 | 1.74 |
| 67 | A H | 22.05 | 13.5 | 238.13 | 1.63 |
| 68 | F G | 13.08 | 13.5 | 192.00 | 0.97 |
| 69 | A B F | 6.03 | 13.5 | 195.47 | 0.45 |
| 70 | A F | 13.23 | 13.5 | 200.80 | 0.98 |
| 71 | B H | 16.89 | 14.0 | 201.87 | 1.21 |
| 72 | B I | 22.68 | 14.0 | 254.13 | 1.62 |
| 73 | A B F H | 24.17 | 14.0 | 269.07 | 1.73 |
| 74 | B E G | 19.69 | 14.0 | 301.07 | 1.41 |
| 75 | A | 12.60 | 14.0 | 223.20 | 0.90 |
| 76 | H I | 23.30 | 15.0 | 214.67 | 1.55 |
| 77 | A B E G H | 10.30 | 15.0 | 248.80 | 0.69 |
| 78 | A B E H | 17.90 | 15.0 | 288.27 | 1.19 |
| 79 | F G | 21.23 | 16.0 | 246.67 | 1.33 |
| 80 | A E | 8.64 | 16.0 | 290.40 | 0.54 |
| 81 | E G | 17.60 | 16.0 | 207.00 | 1.10 |
| 82 | A E | 25.20 | 18.0 | 230.00 | 1.40 |
| 83 | F | 19.80 | 18.0 | 225.00 | 1.10 |
| 84 | A G | 6.84 | 18.0 | 263.73 | 0.38 |
| 85 | A E | 35.64 | 18.0 | 221.00 | 1.98 |
| 86 | A E | 6.17 | 20.0 | 297.03 | 0.31 |
| 87 | F | 30.55 | 21.0 | 259.78 | 1.45 |
| 88 | A D | 10.99 | 22.0 | 252.33 | 0.50 |
| 89 | A E | 21.50 | 22.0 | 237.43 | 0.98 |
| 90 | D | 14.29 | 24.0 | 222.53 | 0.60 |
| 91 | D E | 25.75 | 24.0 | 319.38 | 1.07 |
| 92 | D E | 3.41 | 29.0 | 267.23 | 0.12 |
| 93 | D | 39.42 | 29.0 | 304.48 | 1.36 |
| 94 | E | 38.55 | 33.0 | 282.13 | 1.17 |
| 95 | D | 51.16 | 33.0 | 229.98 | 1.55 |
| 96 | D E | 44.23 | 35.0 | 215.08 | 1.26 |
| 97 | E | 24.18 | 35.0 | 311.93 | 0.69 |
| 98 | D | 8.53 | 40.0 | 207.63 | 0.21 |
| 99 | D | 31.45 | 40.0 | 274.68 | 0.79 |
| 100 | D | 18.19 | 45.0 | 334.28 | 0.40 |
| 101 | D | 42.32 | 48.0 | 192.73 | 0.88 |
| 102 | D | 90.00 | 50.0 | 244.88 | 1.80 |

TABLE 2

| Designator for | |
|---|---|
| TABLE 1 | Aircraft Type |
| A | Narrow Body, twin engine |
| B | Narrow Body, 4 engines |
| C | Narrow Body, distributed propulsors (>4 engines) |
| D | Wide Body, twin engine |
| E | Wide Body, 4 engines |
| F | Wide Body, distributed propulsors (>4 engines) |
| G | Regional Jet |
| H | Business Jet |
| I | UAV |

For Aircraft Type A, B, C and G having a Mach flight speed at cruise conditions of between 0.70 and 0.85 the fan diameter (D) is between 8 and 16 feet, or more preferably between 12 feet and 16 feet.

TABLES 3-6 provide exemplary embodiments for EORL and D for each of the first ellipse E1, second ellipse E2, third ellipse E3 and fourth ellipse E4, respectively, relative to the quarter chord point (QC).

TABLE 3
First Ellipse E1 Embodiments

| | | EORL | 1MajAL | 1MinAL | | | |
|---|---|---|---|---|---|---|---|
| D (ft) | θ (deg) | (ft) | (ft) | (ft) | EORL/D | 1MajAL/D | 1MinAL/D |
| 2 | 253.6 | 1.876 | 5.6 | 3.4 | 0.938 | 2.8 | 1.7 |
| 3 | 253.6 | 2.814 | 8.4 | 5.1 | 0.938 | 2.8 | 1.7 |
| 4 | 253.6 | 3.752 | 11.2 | 6.8 | 0.938 | 2.8 | 1.7 |
| 5 | 253.6 | 4.69 | 14 | 8.5 | 0.938 | 2.8 | 1.7 |
| 6 | 253.6 | 5.628 | 16.8 | 10.2 | 0.938 | 2.8 | 1.7 |
| 7 | 253.6 | 6.566 | 19.6 | 11.9 | 0.938 | 2.8 | 1.7 |
| 8 | 253.6 | 7.504 | 22.4 | 13.6 | 0.938 | 2.8 | 1.7 |
| 9 | 253.6 | 8.442 | 25.2 | 15.3 | 0.938 | 2.8 | 1.7 |
| 10 | 253.6 | 9.38 | 28 | 17 | 0.938 | 2.8 | 1.7 |
| 11 | 253.6 | 10.318 | 30.8 | 18.7 | 0.938 | 2.8 | 1.7 |
| 12 | 253.6 | 11.256 | 33.6 | 20.4 | 0.938 | 2.8 | 1.7 |
| 12.5 | 253.6 | 11.725 | 35 | 21.25 | 0.938 | 2.8 | 1.7 |
| 13 | 253.6 | 12.194 | 36.4 | 22.1 | 0.938 | 2.8 | 1.7 |
| 13.5 | 253.6 | 12.663 | 37.8 | 22.95 | 0.938 | 2.8 | 1.7 |
| 14 | 253.6 | 13.132 | 39.2 | 23.8 | 0.938 | 2.8 | 1.7 |
| 15 | 253.6 | 14.07 | 42 | 25.5 | 0.938 | 2.8 | 1.7 |
| 16 | 253.6 | 15.008 | 44.8 | 27.2 | 0.938 | 2.8 | 1.7 |
| 18 | 253.6 | 16.884 | 50.4 | 30.6 | 0.938 | 2.8 | 1.7 |
| 20 | 253.6 | 18.76 | 56 | 34 | 0.938 | 2.8 | 1.7 |
| 21 | 253.6 | 19.698 | 58.8 | 35.7 | 0.938 | 2.8 | 1.7 |
| 22 | 253.6 | 20.636 | 61.6 | 37.4 | 0.938 | 2.8 | 1.7 |
| 24 | 253.6 | 22.512 | 67.2 | 40.8 | 0.938 | 2.8 | 1.7 |
| 29 | 253.6 | 27.202 | 81.2 | 49.3 | 0.938 | 2.8 | 1.7 |
| 33 | 253.6 | 30.954 | 92.4 | 56.1 | 0.938 | 2.8 | 1.7 |
| 35 | 253.6 | 32.83 | 98 | 59.5 | 0.938 | 2.8 | 1.7 |
| 40 | 253.6 | 37.52 | 112 | 68 | 0.938 | 2.8 | 1.7 |
| 45 | 253.6 | 42.21 | 126 | 76.5 | 0.938 | 2.8 | 1.7 |
| 48 | 253.6 | 45.024 | 134.4 | 81.6 | 0.938 | 2.8 | 1.7 |
| 50 | 253.6 | 46.9 | 140 | 85 | 0.938 | 2.8 | 1.7 |

TABLE 4
Second Ellipse E2 Embodiments

| | | EORL | 2MajAL | 2MinA | | | |
|---|---|---|---|---|---|---|---|
| D (ft) | θ (deg) | (ft) | (ft) | L (ft) | EORL/D | 2MajAL/D | 2MinAL/D |
| 2 | 248.8 | 2.102 | 3.72 | 3.12 | 1.051 | 1.86 | 1.56 |
| 3 | 248.8 | 3.153 | 5.58 | 4.68 | 1.051 | 1.86 | 1.56 |
| 4 | 248.8 | 4.204 | 7.44 | 6.24 | 1.051 | 1.86 | 1.56 |
| 5 | 248.8 | 5.255 | 9.3 | 7.8 | 1.051 | 1.86 | 1.56 |
| 6 | 248.8 | 6.306 | 11.16 | 9.36 | 1.051 | 1.86 | 1.56 |
| 7 | 248.8 | 7.357 | 13.02 | 10.92 | 1.051 | 1.86 | 1.56 |
| 8 | 248.8 | 8.408 | 14.88 | 12.48 | 1.051 | 1.86 | 1.56 |
| 9 | 248.8 | 9.459 | 16.74 | 14.04 | 1.051 | 1.86 | 1.56 |
| 10 | 248.8 | 10.51 | 18.6 | 15.6 | 1.051 | 1.86 | 1.56 |
| 11 | 248.8 | 11.561 | 20.46 | 17.16 | 1.051 | 1.86 | 1.56 |
| 12 | 248.8 | 12.612 | 22.32 | 18.72 | 1.051 | 1.86 | 1.56 |
| 12.5 | 248.8 | 13.1375 | 23.25 | 19.5 | 1.051 | 1.86 | 1.56 |
| 13 | 248.8 | 13.663 | 24.18 | 20.28 | 1.051 | 1.86 | 1.56 |
| 13.5 | 248.8 | 14.1885 | 25.11 | 21.06 | 1.051 | 1.86 | 1.56 |
| 14 | 248.8 | 14.714 | 26.04 | 21.84 | 1.051 | 1.86 | 1.56 |
| 15 | 248.8 | 15.765 | 27.9 | 23.4 | 1.051 | 1.86 | 1.56 |
| 16 | 248.8 | 16.816 | 29.76 | 24.96 | 1.051 | 1.86 | 1.56 |
| 18 | 248.8 | 18.918 | 33.48 | 28.08 | 1.051 | 1.86 | 1.56 |
| 20 | 248.8 | 21.02 | 37.2 | 31.2 | 1.051 | 1.86 | 1.56 |
| 21 | 248.8 | 22.071 | 39.06 | 32.76 | 1.051 | 1.86 | 1.56 |
| 22 | 248.8 | 23.122 | 40.92 | 34.32 | 1.051 | 1.86 | 1.56 |
| 24 | 248.8 | 25.224 | 44.64 | 37.44 | 1.051 | 1.86 | 1.56 |
| 29 | 248.8 | 30.479 | 53.94 | 45.24 | 1.051 | 1.86 | 1.56 |
| 33 | 248.8 | 34.683 | 61.38 | 51.48 | 1.051 | 1.86 | 1.56 |
| 35 | 248.8 | 36.785 | 65.1 | 54.6 | 1.051 | 1.86 | 1.56 |
| 40 | 248.8 | 42.04 | 74.4 | 62.4 | 1.051 | 1.86 | 1.56 |
| 45 | 248.8 | 47.295 | 83.7 | 70.2 | 1.051 | 1.86 | 1.56 |
| 48 | 248.8 | 50.448 | 89.28 | 74.88 | 1.051 | 1.86 | 1.56 |
| 50 | 248.8 | 52.55 | 93 | 78 | 1.051 | 1.86 | 1.56 |

TABLE 5
Third Ellipse E3 Embodiments

| | | | 3MajAL | 3MinAL | | | |
|---|---|---|---|---|---|---|---|
| D (ft) | θ (deg) | EORL (ft) | (ft) | (ft) | EORL/D | 3MajAL/D | 3MinAL/D |
| 2 | 239.6 | 1.74 | 2.8 | 1.8 | 0.87 | 1.4 | 0.9 |
| 3 | 239.6 | 2.61 | 4.2 | 2.7 | 0.87 | 1.4 | 0.9 |
| 4 | 239.6 | 3.48 | 5.6 | 3.6 | 0.87 | 1.4 | 0.9 |
| 5 | 239.6 | 4.35 | 7 | 4.5 | 0.87 | 1.4 | 0.9 |
| 6 | 239.6 | 5.22 | 8.4 | 5.4 | 0.87 | 1.4 | 0.9 |
| 7 | 239.6 | 6.09 | 9.8 | 6.3 | 0.87 | 1.4 | 0.9 |
| 8 | 239.6 | 6.96 | 11.2 | 7.2 | 0.87 | 1.4 | 0.9 |
| 9 | 239.6 | 7.83 | 12.6 | 8.1 | 0.87 | 1.4 | 0.9 |
| 10 | 239.6 | 8.7 | 14 | 9 | 0.87 | 1.4 | 0.9 |
| 11 | 239.6 | 9.57 | 15.4 | 9.9 | 0.87 | 1.4 | 0.9 |
| 12 | 239.6 | 10.44 | 16.8 | 10.8 | 0.87 | 1.4 | 0.9 |
| 12.5 | 239.6 | 10.875 | 17.5 | 11.25 | 0.87 | 1.4 | 0.9 |
| 13 | 239.6 | 11.31 | 18.2 | 11.7 | 0.87 | 1.4 | 0.9 |
| 13.5 | 239.6 | 11.745 | 18.9 | 12.15 | 0.87 | 1.4 | 0.9 |
| 14 | 239.6 | 12.18 | 19.6 | 12.6 | 0.87 | 1.4 | 0.9 |
| 15 | 239.6 | 13.05 | 21 | 13.5 | 0.87 | 1.4 | 0.9 |
| 16 | 239.6 | 13.92 | 22.4 | 14.4 | 0.87 | 1.4 | 0.9 |
| 18 | 239.6 | 15.66 | 25.2 | 16.2 | 0.87 | 1.4 | 0.9 |
| 20 | 239.6 | 17.4 | 28 | 18 | 0.87 | 1.4 | 0.9 |
| 21 | 239.6 | 18.27 | 29.4 | 18.9 | 0.87 | 1.4 | 0.9 |
| 22 | 239.6 | 19.14 | 30.8 | 19.8 | 0.87 | 1.4 | 0.9 |
| 24 | 239.6 | 20.88 | 33.6 | 21.6 | 0.87 | 1.4 | 0.9 |
| 29 | 239.6 | 25.23 | 40.6 | 26.1 | 0.87 | 1.4 | 0.9 |
| 33 | 239.6 | 28.71 | 46.2 | 29.7 | 0.87 | 1.4 | 0.9 |
| 35 | 239.6 | 30.45 | 49 | 31.5 | 0.87 | 1.4 | 0.9 |
| 40 | 239.6 | 34.8 | 56 | 36 | 0.87 | 1.4 | 0.9 |
| 45 | 239.6 | 39.15 | 63 | 40.5 | 0.87 | 1.4 | 0.9 |
| 48 | 239.6 | 41.76 | 67.2 | 43.2 | 0.87 | 1.4 | 0.9 |
| 50 | 239.6 | 43.5 | 70 | 45 | 0.87 | 1.4 | 0.9 |

TABLE 6
Fourth Ellipse E4 Embodiments

| | | EORL | 4MajAL | 4MinAL | | | |
|---|---|---|---|---|---|---|---|
| D (ft) | θ (deg) | (ft) | (ft) | (ft) | EORL/D | 4MajAL/D | 4MinAL/D |
| 2 | 235.7 | 1.526 | 1.88 | 0.88 | 0.763 | 0.94 | 0.44 |
| 3 | 235.7 | 2.289 | 2.82 | 1.32 | 0.763 | 0.94 | 0.44 |
| 4 | 235.7 | 3.052 | 3.76 | 1.76 | 0.763 | 0.94 | 0.44 |
| 5 | 235.7 | 3.815 | 4.7 | 2.2 | 0.763 | 0.94 | 0.44 |
| 6 | 235.7 | 4.578 | 5.64 | 2.64 | 0.763 | 0.94 | 0.44 |
| 7 | 235.7 | 5.341 | 6.58 | 3.08 | 0.763 | 0.94 | 0.44 |
| 8 | 235.7 | 6.104 | 7.52 | 3.52 | 0.763 | 0.94 | 0.44 |
| 9 | 235.7 | 6.867 | 8.46 | 3.96 | 0.763 | 0.94 | 0.44 |
| 10 | 235.7 | 7.63 | 9.4 | 4.4 | 0.763 | 0.94 | 0.44 |
| 11 | 235.7 | 8.393 | 10.34 | 4.84 | 0.763 | 0.94 | 0.44 |
| 12 | 235.7 | 9.156 | 11.28 | 5.28 | 0.763 | 0.94 | 0.44 |
| 12.5 | 235.7 | 9.5375 | 11.75 | 5.5 | 0.763 | 0.94 | 0.44 |
| 13 | 235.7 | 9.919 | 12.22 | 5.72 | 0.763 | 0.94 | 0.44 |
| 13.5 | 235.7 | 10.3005 | 12.69 | 5.94 | 0.763 | 0.94 | 0.44 |
| 14 | 235.7 | 10.682 | 13.16 | 6.16 | 0.763 | 0.94 | 0.44 |
| 15 | 235.7 | 11.445 | 14.1 | 6.6 | 0.763 | 0.94 | 0.44 |
| 16 | 235.7 | 12.208 | 15.04 | 7.04 | 0.763 | 0.94 | 0.44 |
| 18 | 235.7 | 13.734 | 16.92 | 7.92 | 0.763 | 0.94 | 0.44 |
| 20 | 235.7 | 15.26 | 18.8 | 8.8 | 0.763 | 0.94 | 0.44 |
| 21 | 235.7 | 16.023 | 19.74 | 9.24 | 0.763 | 0.94 | 0.44 |
| 22 | 235.7 | 16.786 | 20.68 | 9.68 | 0.763 | 0.94 | 0.44 |
| 24 | 235.7 | 18.312 | 22.56 | 10.56 | 0.763 | 0.94 | 0.44 |
| 29 | 235.7 | 22.127 | 27.26 | 12.76 | 0.763 | 0.94 | 0.44 |
| 33 | 235.7 | 25.179 | 31.02 | 14.52 | 0.763 | 0.94 | 0.44 |
| 35 | 235.7 | 26.705 | 32.9 | 15.4 | 0.763 | 0.94 | 0.44 |
| 40 | 235.7 | 30.52 | 37.6 | 17.6 | 0.763 | 0.94 | 0.44 |
| 45 | 235.7 | 34.335 | 42.3 | 19.8 | 0.763 | 0.94 | 0.44 |
| 48 | 235.7 | 36.624 | 45.12 | 21.12 | 0.763 | 0.94 | 0.44 |
| 50 | 235.7 | 38.15 | 47 | 22 | 0.763 | 0.94 | 0.44 |

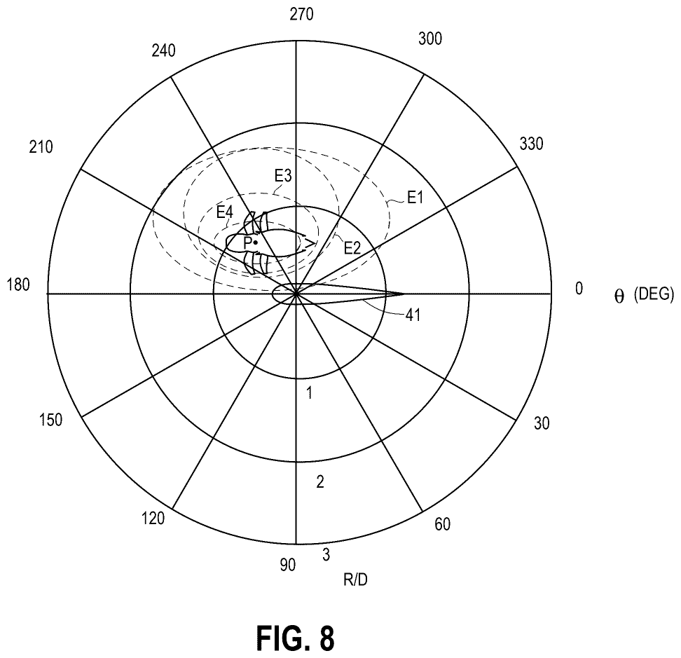

Referring to FIG. 8, the locations for P relative to the airfoil section and advantages therefrom described above can also be realized for an unducted fan propulsor system mounted above a horizontal stabilizer. For an unducted fan propulsor mounted to horizontal stabilizers, the foregoing examples and embodiments would be mirrored about the chord line of the airfoil section (again, for purposes of explanation, this chord line may be thought of as an axis passing through θ=0 deg and θ=180 deg in FIG. 11) for the case where the airfoil section 41 produces a lift in the downward direction, such as a horizontal stabilizer, as compared to a wing which produces a lift in the upward direction. The above descriptions for an undermount propulsor can apply, with the location being shifted as shown in FIG. 8 as compared to FIG. 7.

According to the foregoing examples or embodiments, the unducted fan propulsor 38, incorporating the vane assembly described herein, can be incorporated into an airplane or other aircraft having a cruise flight Mach M₀ of between 0.70 and 0.85, between 0.75 and 0.85, between 0.75 and 0.79, between 0.5 and 0.9, between 0.7 and 0.9, or between 0.75 and 0.9. A propulsor that is part of an airplane that operates at a high cruise flight Mach number (e.g., greater than 0.7) encounters velocities near the surfaces of the rotor, vanes, and nacelle that approach or exceed the speed of sound, or Mach 1.0. In general, friction drag increases roughly in proportion to the square of the air velocity. However, as the Mach number increases, a significant contributor to the increase in drag can come from wave drag. Wave drag is a drag resulting from shock waves that form as the flow of air near a surface becomes supersonic (e.g., Mach>1.0).

In addition to the cruise flight Mach number, another factor contributing to increased drag on propulsor surfaces is high non-dimensional cruise fan net thrust based on fan annular area and flight speed. The same acceleration of the air stream by the fan that produces thrust also tends to increase the drag force on the rotor, vanes, and nacelle.

Expressing thrust non-dimensionally in a way that accounts for flight speed, ambient conditions, and fan annular area yields a thrust parameter as follows:

$$\frac{{F}_{net}}{{ρ}_{0} {A}_{a n} {V}_{0}^{2}}$$

In the above thrust parameter, Fₙₑₜ is cruise fan net thrust, ρ₀ is ambient air density, Vₒ is cruise flight velocity, and Aₐₙ is fan stream tube cross-sectional area at the fan inlet. Fan annular area, Aₐₙ, is computed using a maximum radius as the tip radius of the forward-most rotor blades and a minimum radius as the minimum radius of the fan stream tube entering the fan.

A propulsor that operates at a high cruise fan net thrust parameter (e.g., greater than 0.06) tends to have higher propulsor velocities with risk of higher drag on propulsor surfaces.

According to any of the foregoing examples or embodiments, there may be a particularly beneficial range of a dimensionless cruise fan net thrust parameter normalized by ambient density, cruise flight speed squared, and fan stream tube annular area at fan inlet defined by the following expression:

$$0.15 > \frac{{F}_{net}}{{ρ}_{0} {A}_{a n} {V}_{0}^{2}} > 0.06$$

Both a high cruise flight Mach and high dimensionless cruise fan net thrust parameter contribute to higher drag levels on the propulsor surfaces. Advantageously, the specific unducted fan propulsor positions relative to the wing airfoil section, as described herein, can increase unducted fan propulsor net thrust for a given power input when there is a high cruise flight Mach and a high dimensionless cruise fan net thrust parameter.

Using the conditions described herein, the specific regions for placing the unducted fan propulsor system can be located where there is a relatively higher pressure on the high pressure side of the airfoil, beneath the wings or above the horizontal stabilizers. The higher pressure provides increased thrust from the unducted fan propulsor to thereby offset drag penalties resulting from the installation of unducted fan propulsors.

The foregoing conditions for the placement of the propulsors relative to the wing airfoils can be present for any mounting configuration of the propulsors wing. While the mounting configuration can be fixed, it is contemplated that the mounting configuration could be variable. For example, the mounting configuration of an unducted fan propulsor relative to a wing could be different for takeoff as compared to cruise operating conditions. In such a scenario, the foregoing conditions for placement of the propulsors relative to the wing airfoils can be present in either or both operating conditions, or any other operating condition.

In various exemplary aspects of the present disclosure, the unducted fan propulsor includes an assembly of outlet guide vanes (OGVs) positioned downstream of the rotating blades, wherein the OGVs exhibit non-uniform structural characteristics along the circumferential direction. Specifically, the plurality of OGVs may be arranged with non-uniform circumferential spacing, such as including specific gap spacings or clustered arrangements relative to a pylon or support structure. Additionally, or alternatively, the plurality of OGVs may define non-uniform spans, wherein a span of a first outlet guide vane is different (e.g., shorter) than a span of a second outlet guide vane to accommodate specific flow field distortions.

Notably, the inventors have discovered that a preferred configuration of these non-uniform OGV characteristics is linked to the specific aerodynamic environment influenced by the mounting locations described hereinabove. As described previously, positioning the propulsor within the specific regions relative to the effective quarter chord point (QC) (e.g., the desired RL/D ranges) utilizes the high-pressure field of the wing to offset drag. A specific consequence of this installation is a local deceleration of the airflow entering the fan relative to the freestream velocity. In this installation, an effective velocity seen by the fan (Ve) is strictly less than a free stream flight velocity (Vinf) (e.g., Ve may be 98% or less of Vinf) due to the flow deceleration caused by the proximity to the wing's pressure field.

This reduction in inflow velocity fundamentally alters an effective advance ratio (Je) of the fan. While a standard advance ratio is defined as J=Vinf/nD, with n being a rotation speed of the fan and D being a diameter of the fan, the installation effects of the present disclosure require defining an effective advance ratio as Je=Ve/nD. In some embodiments, the positioning is selected such that a ratio of the effective velocity to the free stream velocity (Ve/Vinf) is less than 1.0. For example, the ratio (Ve/Vinf) may be greater than or equal to 0.95 and less than or equal to 0.995.

The inventors have identified that the trajectory of the wakes shed by the fan blades, and specifically a swirl offset angle determining where those wakes impinge upon the OGVs, is a function of this effective advance ratio (Je). If the OGVs were designed based solely on the isolated freestream advance ratio (J), the non-uniform features (e.g., the gap spacing or the short “clipped” vanes) may be clocked to a less desirable circumferential position.

Accordingly, to fully realize the acoustic and aerodynamic benefits of the claimed mounting locations, the non-uniform OGV features may be “clocked” or positioned based on the effective Advance Ratio (Je) resulting from the specific RL/D installation, rather than the freestream advance ratio. For example, regarding the non-uniform spans (clipping), a circumferential location of the shortest vane can be determined by applying a swirl offset calculated using Je to ensure the vane avoids vortices having undesirably high intensities, which may have a different trajectory due to the installation-induced deceleration. Similarly, regarding non-uniform spacing, the desirable location of the gap spacing relative to the pylon or distortion source can be adjusted to account for a steeper swirl angle caused by the reduced effective velocity (Ve) relative to the freestream velocity (Vinf).

Therefore, the combination of the specific mounting locations and the non-uniform OGV architectures provides specific benefits that build upon one another. The mounting location creates a unique velocity field (Ve<Vinf) that necessitates a specific update of the OGV non-uniformities (via Je) to achieve the intended noise reduction. This combination can allow for the acoustic mitigation to target the actual location of the wake interaction as shifted by the installation aerodynamics, thereby improving propulsive efficiency while simultaneously reducing installation noise penalties.

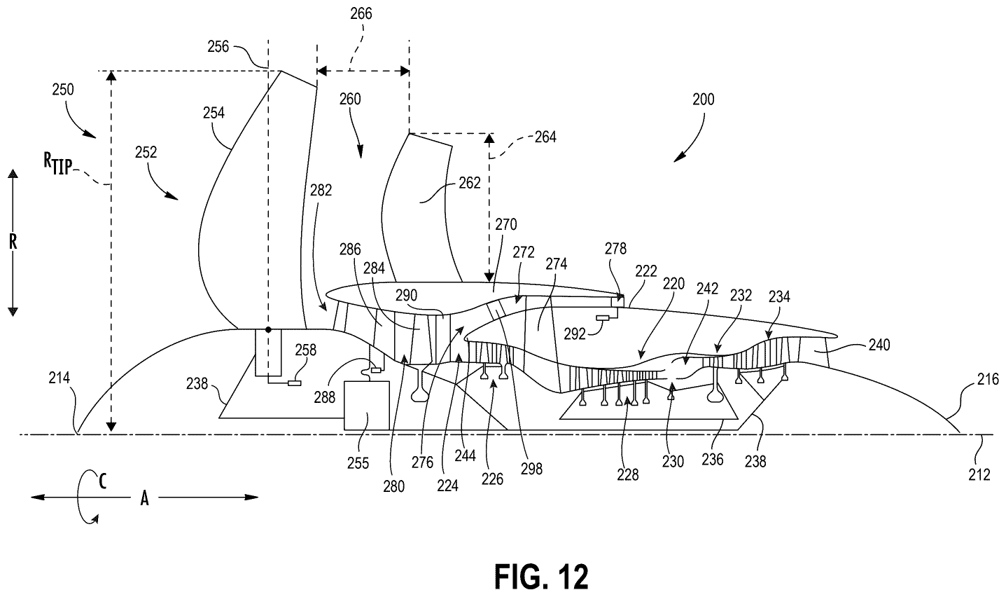

Referring now to FIG. 12, a schematic cross-sectional view of an unducted fan propulsor 200 is provided according to an example embodiment of the present disclosure. Particularly, FIG. 12 provides a gas turbine engine having a rotor assembly with a single stage of unducted rotor blades. In such a manner, the rotor assembly may be referred to herein as an “unducted fan,” or the entire unducted fan propulsor 200 may be referred to as an “unducted gas turbine engine” or “unducted fan propulsor”. In addition, the unducted fan propulsor 200 of FIG. 12 includes a third stream extending from the compressor section to a rotor assembly flowpath over the turbomachine, as will be explained in more detail below.

For reference, the unducted fan propulsor 200 defines an axial direction A, a radial direction R, and a circumferential direction C. Moreover, the unducted fan propulsor 200 defines an axial centerline or longitudinal axis 212 that extends along the axial direction A. In general, the axial direction A extends parallel to the longitudinal axis 212, the radial direction R extends outward from and inward to the longitudinal axis 212 in a direction orthogonal to the axial direction A, and the circumferential direction extends three hundred sixty degrees (360°) around the longitudinal axis 212. The unducted fan propulsor 200 extends between a forward end 214 and an aft end 216, e.g., along the axial direction A.

The unducted fan propulsor 200 includes a turbomachine 220 and a rotor assembly, also referred to a fan section 250, positioned upstream thereof. Generally, the turbomachine 220 includes, in serial flow order, a compressor section, a combustion section, a turbine section, and an exhaust section. Particularly, as shown in FIG. 12, the turbomachine 220 includes a core cowl 222 that defines an annular core inlet 224. The core cowl 222 further encloses at least in part a low pressure system and a high pressure system. For example, the core cowl 222 depicted encloses and supports at least in part a booster or low pressure (“LP”) compressor 226 for pressurizing the air that enters the turbomachine 220 through core inlet 224. A high pressure (“HP”), multi-stage, axial-flow compressor 228 receives pressurized air from the LP compressor 226 and further increases the pressure of the air. The pressurized air stream flows downstream to a combustor 230 of the combustion section where fuel is injected into the pressurized air stream and ignited to raise the temperature and energy level of the pressurized air.

It will be appreciated that as used herein, the terms “high/low speed” and “high/low pressure” are used with respect to the high pressure/high speed system and low pressure/low speed system interchangeably. Further, it will be appreciated that the terms “high” and “low” are used in this same context to distinguish the two systems, and are not meant to imply any absolute speed and/or pressure values.

The high energy combustion products flow from the combustor 230 downstream to a high pressure turbine 232. The high pressure turbine 228 drives the high pressure compressor 228 through a high pressure shaft 236. In this regard, the high pressure turbine 228 is drivingly coupled with the high pressure compressor 228. The high energy combustion products then flow to a low pressure turbine 234. The low pressure turbine 234 drives the low pressure compressor 226 and components of the fan section 250 through a low pressure shaft 238. In this regard, the low pressure turbine 234 is drivingly coupled with the low pressure compressor 226 and components of the fan section 250. The LP shaft 238 is coaxial with the HP shaft 236 in this example embodiment. After driving each of the turbines 232, 234, the combustion products exit the turbomachine 220 through a turbomachine exhaust nozzle 240.

Accordingly, the turbomachine 220 defines a working gas flowpath or core duct 242 that extends between the core inlet 224 and the turbomachine exhaust nozzle 240. The core duct 242 is an annular duct positioned generally inward of the core cowl 222 along the radial direction R. The core duct 242 (e.g., the working gas flowpath through the turbomachine 220) may be referred to as a second stream.

The fan section 250 includes a fan 252, which is the primary fan in this example embodiment. For the depicted embodiment of FIG. 12, the fan 252 is an open rotor or unducted fan 252. In such a manner, the unducted fan propulsor 200 may be referred to as an open rotor or open fan engine.

As depicted, the fan 252 includes an array of fan blades 254 (only one shown in FIG. 12). The fan blades 254 are rotatable, e.g., about the longitudinal axis 212. As noted above, the fan 252 is drivingly coupled with the low pressure turbine 234 via the LP shaft 238. For the embodiments shown in FIG. 12, the fan 252 is coupled with the LP shaft 238 via a speed reduction gearbox 255, e.g., in an indirect-drive or geared-drive configuration.

Moreover, the array of fan blades 254 can be arranged in equal spacing around the longitudinal axis 212. Each fan blade 254 has a root and a tip and a span defined therebetween, and more specifically defines a tip radius R_{TIP} from the longitudinal axis 212 to the tips of the fan blades 254 along the radial direction R. Each fan blade 254 defines a central blade axis 256. For this embodiment, each fan blade 254 of the fan 252 is rotatable about its central blade axis 256, e.g., in unison with one another. One or more actuators, also referred to herein as one or more pitch change mechanisms, 258 are provided to facilitate such rotation and therefore may be used to change a pitch of the fan blades 254 about their respective central blades' axes 256.

The fan section 250 further includes an outlet guide vane array 260 that includes outlet guide vanes 262 (only one shown in FIG. 12; sometimes also referred to as fan guide vanes) disposed around the longitudinal axis 212. For this embodiment, the outlet guide vanes 262 are not rotatable about the longitudinal axis 212. Each outlet guide vane 262 has a root and a tip and a span defined therebetween. The outlet guide vanes 262 may be unshrouded as shown in FIG. 12 or, alternatively, may be shrouded, e.g., by an annular shroud spaced outward from the tips of the outlet guide vanes 262 along the radial direction R or attached to the outlet guide vanes 262.

As will be appreciated, the outlet guide vanes 262 each define an outlet guide vane (OGV) span 264 along the radial direction R from a root to a tip. Additionally, the outlet guide vanes 262 are spaced from the fan blade 254 along the axial direction A by a distance or spacing 266. The spacing 266 is measured from an aft-most edge of the fan blade 254 to a forward-most edge of the outlet guide vanes 262 along the axial direction A.

In the embodiment depicted, as noted above, each outlet guide vane 262 is configured as a fixed guide vane, unable to be pitched about a central blade axis. The outlet guide vanes 262 are thus mounted to a fan cowl 270 in a fixed manner.

It will be appreciated, however, that in other embodiments, the outlet guide vanes 262 may alternatively be variable pitch outlet guide vanes 262.

As shown in FIG. 12, in addition to the fan 252, which is unducted, a ducted fan 284 is included aft of the fan 252, such that the unducted fan propulsor 200 includes both a ducted and an unducted fan which both serve to generate thrust through the movement of air without passage through at least a portion of the turbomachine 220 (e.g., without passage through the HP compressor 228 and combustion section for the embodiment depicted). The ducted fan 284 is rotatable about the same axis (e.g., the longitudinal axis 212) as the fan blade 254. The ducted fan 284 is, for the embodiment depicted, driven by the low pressure turbine 234 (e.g. coupled to the LP shaft 238). In the embodiment depicted, as noted above, the fan 252 may be referred to as the primary fan, and the ducted fan 284 may be referred to as a secondary fan. It will be appreciated that these terms “primary” and “secondary” are terms of convenience, and do not imply any particular importance, power, or the like.

The ducted fan 284 includes a plurality of fan blades (not separately labeled in FIG. 12) arranged in a single stage, such that the ducted fan 284 may be referred to as a single stage fan. The fan blades of the ducted fan 284 can be arranged in equal spacing around the longitudinal axis 212. Each blade of the ducted fan 284 has a root and a tip and a span defined therebetween.

The fan cowl 270 annularly encases at least a portion of the core cowl 222 and is generally positioned outward of at least a portion of the core cowl 222 along the radial direction R. Particularly, a downstream section of the fan cowl 270 extends over a forward portion of the core cowl 222 to define a fan duct flowpath, or simply a fan duct 272. According to this embodiment, the fan flowpath or fan duct 272 may be understood as forming at least a portion of the third stream of the unducted fan propulsor 200.

Incoming air may enter through the fan duct 272 through a fan duct inlet 276 and may exit through a fan exhaust nozzle 278 to produce propulsive thrust. The fan duct 272 is an annular duct positioned generally outward of the core duct 242 along the radial direction R. The fan cowl 270 and the core cowl 222 are connected together and supported by a plurality of substantially radially-extending, circumferentially-spaced stationary struts 274 (only one shown in FIG. 12). The stationary struts 274 may each be aerodynamically contoured to direct air flowing thereby. Other struts in addition to the stationary struts 274 may be used to connect and support the fan cowl 270 and/or core cowl 222. In many embodiments, the fan duct 272 and the core duct 242 may at least partially co-extend (generally axially) on opposite sides (e.g., opposite radial sides) of the core cowl 222. For example, the fan duct 272 and the core duct 242 may each extend directly from a leading edge 244 of the core cowl 222 and may partially co-extend generally axially on opposite radial sides of the core cowl 222.

The unducted fan propulsor 200 also defines or includes an inlet duct 280. The inlet duct 280 extends between an engine inlet 282 and the core inlet 224/fan duct inlet 276. The engine inlet 282 is defined generally at the forward end of the fan cowl 270 and is positioned between the fan 252 and the outlet guide vane array 260 along the axial direction A. The inlet duct 280 is an annular duct that is positioned inward of the fan cowl 270 along the radial direction R. Air flowing downstream along the inlet duct 280 is split, not necessarily evenly, into the core duct 242 and the fan duct 272 by a fan duct splitter or leading edge 244 of the core cowl 222. In the embodiment depicted, the inlet duct 280 is wider than the core duct 242 along the radial direction R. The inlet duct 280 is also wider than the fan duct 272 along the radial direction R.

Notably, for the embodiment depicted, the unducted fan propulsor 200 includes one or more features to increase an efficiency of a third stream thrust, Fn3S (e.g., a thrust generated by an airflow through the fan duct 272 exiting through the fan exhaust nozzle 278, generated at least in part by the ducted fan 284). In particular, the unducted fan propulsor 200 further includes an array of inlet guide vanes 286 positioned in the inlet duct 280 upstream of the ducted fan 284 and downstream of the engine inlet 282. The array of inlet guide vanes 286 are arranged around the longitudinal axis 212. For this embodiment, the inlet guide vanes 286 are not rotatable about the longitudinal axis 212. Each inlet guide vanes 286 defines a central blade axis (not labeled for clarity), and is rotatable about its respective central blade axis, e.g., in unison with one another. In such a manner, the inlet guide vanes 286 may be considered a variable geometry component. One or more actuators 288 are provided to facilitate such rotation and therefore may be used to change a pitch of the inlet guide vanes 286 about their respective central blade axes. However, in other embodiments, each inlet guide vane 286 may be fixed or unable to be pitched about its central blade axis.

Further, located downstream of the ducted fan 284 and upstream of the fan duct inlet 276, the unducted fan propulsor 200 includes an array of outlet guide vanes 290. As with the array of inlet guide vanes 286, the array of outlet guide vanes 290 are not rotatable about the longitudinal axis 212. However, for the embodiment depicted, unlike the array of inlet guide vanes 286, the array of outlet guide vanes 290 are configured as fixed-pitch outlet guide vanes.

Further, it will be appreciated that for the embodiment depicted, the fan exhaust nozzle 278 of the fan duct 272 is further configured as a variable geometry exhaust nozzle. In such a manner, the unducted fan propulsor 200 includes one or more actuators 292 for modulating the variable geometry exhaust nozzle. For example, the variable geometry exhaust nozzle may be configured to vary a total cross-sectional area (e.g., an area of the nozzle in a plane perpendicular to the longitudinal axis 212) to modulate an amount of thrust generated based on one or more engine operating conditions (e.g., temperature, pressure, mass flowrate, etc. of an airflow through the fan duct 272). A fixed geometry exhaust nozzle may also be adopted.

The combination of the array of inlet guide vanes 286 located upstream of the ducted fan 284, the array of outlet guide vanes 290 located downstream of the ducted fan 284, and the fan exhaust nozzle 278 may result in a more efficient generation of third stream thrust, Fn_{3S}, during one or more engine operating conditions. Further, by introducing a variability in the geometry of the inlet guide vanes 286 and the fan exhaust nozzle 278, the unducted fan propulsor 200 may be capable of generating more efficient third stream thrust, Fn_{3S}, across a relatively wide array of engine operating conditions, including takeoff and climb (where a maximum total engine thrust Fn_{Total}, is generally needed) as well as cruise (where a lesser amount of total engine thrust, Fn_{Total}, is generally needed).

Moreover, referring still to FIG. 12, in exemplary embodiments, air passing through the fan duct 272 may be relatively cooler (e.g., lower temperature) than one or more fluids utilized in the turbomachine 220. In this way, one or more heat exchangers 298 may be positioned in thermal communication with the fan duct 272. For example, one or more heat exchangers 298 may be disposed within the fan duct 272 and utilized to cool one or more fluids from the core engine with the air passing through the fan duct 272, as a resource for removing heat from a fluid, e.g., compressor bleed air, oil or fuel.

Although not depicted, the heat exchanger 298 may be an annular heat exchanger extending substantially 360 degrees in the fan duct 272 (e.g., at least 300 degrees, such as at least 330 degrees). In such a manner, the heat exchanger 298 may effectively utilize the air passing through the fan duct 272 to cool one or more systems of the unducted fan propulsor 200 (e.g., lubrication oil systems, compressor bleed air, electrical components, etc.). The heat exchanger 298 uses the air passing through duct 272 as a heat sink and correspondingly increases the temperature of the air downstream of the heat exchanger 298 and exiting the fan exhaust nozzle 278.

It will be appreciated, that for the purposes of discussion in the present disclosure, the ducted fan 284, the fan cowl 270, the inlet duct 280, and the fan duct 272 may all be considered part of the turbomachine 220.

It will be appreciated that the exemplary unducted fan propulsor 200 depicted in FIG. 12 is provided by way of example only, and that in other embodiments, the unducted fan propulsor 200 may have any other suitable configuration. For example, in other embodiments, the unducted fan propulsor 200 may not include the fan duct 272/third stream, and as such may be configured as a “two stream” engine. Additionally, or alternatively, in other embodiments, the unducted fan propulsor 200 may be configured as a direct drive engine (i.e., without the gearbox 255), as a fixed-pitch engine (i.e., without the pitch change mechanism 258), etc.

The gas turbine engines of the present disclosure are generally designed to reduce noise propagation during operation of the gas turbine engine. With an open rotor gas turbine engine, such as the exemplary unducted fan propulsor 200 described above with reference to FIG. 12, noise may propagate from a plurality of outlet guide vanes (see outlet guide vanes 262 of FIG. 12), as fan wakes having a nonuniform velocity from a rotor assembly impinge upon the plurality of outlet guide vanes. Such noise, sometimes referred to as fan-OGV interaction noise, is generally in the form of tonal noise at discrete frequencies related to the number of fan blades and rotational speed of the fan, and broadband noise due to fan wake turbulence. The inventors of the present disclosure have found that by modifying a circumferential spacing of outlet guide vanes relative to a notionally uniform spacing, an amount of noise generated and/or propagated from the outlet guide vanes may be reduced during operation of the unducted fan propulsor. For example, by reducing the spacing of the outlet guide vanes, the tonal component of fan-OGV interaction noise maybe reduced.

The inventors of the present disclosure have found that there exists an optimum number of outlet guide vanes (N_{OGV}) for a given fan blade count that results in the lowest level of tonal fan-OGV interaction noise. However, broadband fan-OGV interaction noise increases with outlet guide vane count. Since both tonal and broadband noise contribute to the overall fan-OGV interaction noise, an OGV count that results in the lowest level of tonal noise may not necessarily result in the quietest overall noise level. A means of reducing tonal noise independent of vane count is therefore desirable. The inventors of the present disclosure have found that the spacing of the outlet guide vanes rather than the total number of outlet guide vanes (N_{OGV}) themselves may govern the amount of tonal noise radiated to the far-field. Changing the spacing of the vanes towards a spacing equivalent to that obtained if the number of the outlet guide vanes were the same as the rotor blades may produce a reduction in tonal noise, without actually changing the number of outlet guide vanes.

Accordingly, the inventors of the present disclosure have further found that locally changing the circumferential spacing of the outlet guide vanes around certain azimuthal positions reduces tonal noise radiation to one or more target azimuthal locations far away from the outlet guide vanes. For example, the target areas may be, e.g., one or more noise sensitive ground locations, a cabin of an aircraft, etc.

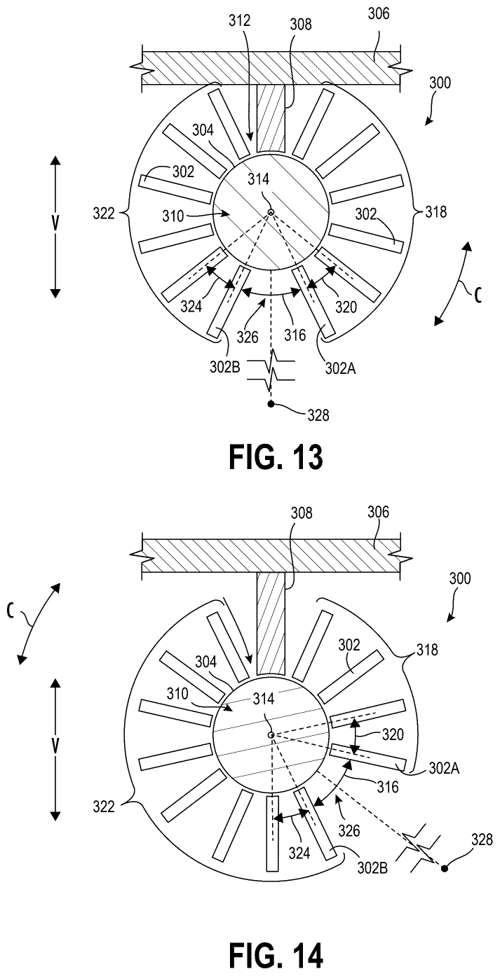

In particular, reference will now be made to FIG. 13. FIG. 13 depicts schematically an unducted fan propulsor 300 in accordance with an exemplary aspect of the present disclosure having a plurality of outlet guide vanes 302 coupled to a cowl 304, with the unducted fan propulsor 300 mounted to a wing 306 of an aircraft (other than the wing 306, not labeled or shown in FIG. 13) through a pylon 308. The unducted fan propulsor 300 may be configured in substantially the same manner as exemplary unducted fan propulsor 200 of FIG. 12. In such a manner, will be appreciated that the cowl 304 may be, e.g., a fan cowl (see fan cowl 270 of FIG. 12). Further, will be appreciated that the unducted fan propulsor 300 includes a turbomachine 310. The turbomachine 310 may be configured in substantially the same manner as the turbomachine 220 of FIG. 12 and defines a pylon attachment location 312 along a circumferential direction C of the unducted fan propulsor 300. The pylon 308 is coupled to the turbomachine 310 at the pylon attachment location 312. In the embodiment shown, the pylon attachment location 312 is positioned at a 12 o'clock position of the unducted fan propulsor 300, also referred to as top dead center.

In other embodiments, it will be appreciated that the pylon 308 may be mounted on a side of the engine to enable an aft-fuselage mounting of the engine, in which case the pylon may be positioned at or near either 3 o'clock or 9 o'clock depending on which side of an aircraft the engine will be installed.

Briefly, it will be appreciated that the circumferential location nomenclature “o'clock” refers to locations along the circumferential direction C of the unducted fan propulsor 300, as viewed from a forward-looking aft location. As mentioned, the 12 o'clock position refers to a top dead center position, or rather, a position aligned with a reference line extending from a longitudinal centerline 314 of the unducted fan propulsor 300 and upward along a vertical direction V during a normal operational attitude of the unducted fan propulsor 300 and aircraft incorporating the unducted fan propulsor 300 (e.g., when the aircraft is parked on a level runway).

It will be appreciated that for the embodiment shown, the plurality of outlet guide vanes 302 includes N_{OGV} number of outlet guide vanes 302. In particular, the plurality of outlet guide vanes 302 includes a first outlet guide vane 302A and a second outlet guide vane 302B adjacent the first outlet guide vane 302A (i.e., positioned with no outlet guide vanes 302 therebetween). The first outlet guide vane 302A and second outlet guide vane 302B together define a gap spacing 316 in the circumferential direction C. Briefly, it will further be appreciated that the pylon attachment location 312 is outside of between the first outlet guide vane 302A and the second outlet guide vane 302B along the circumferential direction C.

As used herein, the term “spacing” as used to describe an amount of space between adjacent outlet guide vanes 302, such as the gap spacing 316 between the first outlet guide vane 302A and the second outlet guide vane 302B, refers to an angle between a first reference line and a second reference line. The first reference line is a pitch change axis of the first outlet guide vane 302A and the second reference line is a pitch change axis of the second outlet guide vane 302B. In an embodiment with fixed-pitch outlet guide vanes 302, the first reference line may be a reference line extending from a leading edge of the first outlet guide vane 302A at a root of the first outlet guide vane 302A to the longitudinal centerline 314 of the unducted fan propulsor 300, and the second reference line may be a reference line extending from a leading edge of the second outlet guide vane 302B at a root of the second outlet guide vane 302B to the longitudinal centerline 314 of the unducted fan propulsor 300.

In the embodiment shown, the gap spacing 316 is greater than 360 degrees divided by N_{OGV} (i.e., the number of outlet guide vanes 302). In such a manner, it will be appreciated that the plurality of outlet guide vanes 302 defines a nonuniform spacing along the circumferential direction C.

Referring still to FIG. 13, it will be appreciated that the plurality of outlet guide vanes 302 further includes a first cluster 318 of outlet guide vanes 302. It will be appreciated that the unducted fan propulsor 300 further includes a rotor assembly having a plurality of unducted rotor blades (not shown in FIG. 13), the plurality of unducted rotor blades including a number N_{B} of unducted rotor blades (not shown in FIG. 13; see, e.g., rotor blades 254 of FIG. 12, rotor blades 352 of FIG. 9). In the embodiment shown, N_{B} is greater than N_{OGV}, such as between one and three greater, such as two greater. As discussed above, such may assist with a reduction of fan-OGV interaction noise during operation of the unducted fan propulsor 300. The first cluster 318 of outlet guide vanes 302 defines a first cluster spacing 320 less than 360 divided by N_{OGV} and greater than or equal to 360 divided by (N_{B}+2). As used herein, the term first cluster spacing 320 refers to the average spacing of each of the adjacent outlet guide vanes 302 in the first cluster 318 of outlet guide vanes 302.

The first cluster 318 of outlet guide vanes 302 includes the first outlet guide vane 302A. In certain embodiments, the first cluster 318 of outlet guide vanes 302 may include at least two outlet guide vanes 302, at least three outlet guide vanes 302, at least four outlet guide vanes 302, N_{OGV} divided by two outlet guide vanes 302, and up to all of the plurality outlet guide vanes 302.

Referring still to FIG. 13, the plurality of outlet guide vanes 302 further includes a second cluster 322 of outlet guide vanes 302 defining a second cluster spacing 324. The second cluster spacing 324 is less than 360 divided by N_{OGV} and greater than or equal to 360 divided by (N_{B}+2).

In certain exemplary aspects, the gap spacing 316 may be at least 25% greater than the first cluster spacing 320 and up to 200% of the first cluster spacing 320. For example, in certain exemplary aspects, the gap spacing 316 may be at least 50% greater than the first cluster spacing 320 such as at least 100% greater than the first cluster spacing 320, such as up to 150% of the first cluster spacing 320.

Referring still to FIG. 13, as briefly mentioned above, the exemplary unducted fan propulsor 300 may be designed to reduce a noise propagation towards a noise sensitive target area. In particular, it will be appreciated that the exemplary unducted fan propulsor 300 depicted defines an acoustically sensitive location 326 along the circumferential direction C, corresponding to an external targeted noise reduction location 328. In the embodiment shown, the acoustically sensitive location 326 is positioned between the first outlet guide vane 302A and the second outlet guide vane 302B. More specifically, the acoustically sensitive location 326 is positioned at a six o'clock position. In such a manner, the exemplary unducted fan propulsor 300 depicted is configured to reduce an amount of noise propagation from the outlet guide vanes 302 downwardly during operation of the unducted fan propulsor 300, reducing an amount of noise experienced during, e.g., a flyover event of an aircraft including the unducted fan propulsor 300 of FIG. 13.

It will be appreciated, however, that in other embodiments, the unducted fan propulsor 300 may define an acoustically sensitive location 326 at other positions along the circumferential direction C. For example, referring now to FIG. 14, an unducted fan propulsor 300 in accordance with another exemplary embodiment of the present disclosure is provided. The exemplary unducted fan propulsor 300 of FIG. 14 may be configured in substantially the same manner as exemplary unducted fan propulsor 300 of FIG. 13.

For example, the exempt unducted fan propulsor 300 of FIG. 14 includes a plurality of outlet guide vanes 302, the plurality of outlet guide vanes 302 including a first outlet guide vane 302A and a second outlet guide vane 302B defining a gap spacing 316. Additionally, the exemplary unducted fan propulsor 300 of FIG. 14 also defines an acoustically sensitive location 326 along the circumferential direction C between the first outlet guide vane 302A and the second outlet guide vane 302B, corresponding to an external targeted noise reduction location 328.

However, for the embodiment of FIG. 14, the acoustically sensitive location 326 is positioned between a three o'clock position and a five o'clock position. In such a manner, it will be appreciated that the exemplary unducted fan propulsor 300 of FIG. 14 may be configured to reduce an amount of noise propagation from the outlet guide vanes 302 laterally outward during operation of the unducted fan propulsor 300, reducing an amount of noise experienced from, e.g., a sideline acoustically sensitive location during operation of an aircraft incorporating the exemplary unducted fan propulsor 300 of FIG. 14.

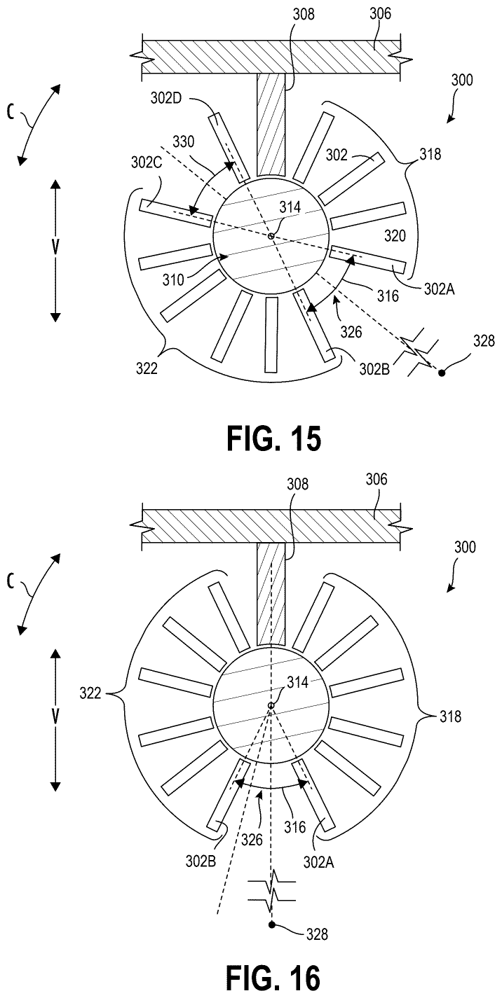

Further, it will be appreciated that in certain exemplary embodiments, the plurality of outlet guide vanes 302 may include an outlet guide vane 302 removed at a location opposite the first outlet guide vane 302A and the second outlet guide vane 302B to provide, e.g., symmetry for the unducted fan propulsor 300. For example, referring now briefly to FIG. 15, an unducted fan propulsor 300 in accordance with yet another exemplary embodiment of the present disclosure is provided. The exemplary unducted fan propulsor 300 of FIG. 15 may be configured in substantially the same manner as exemplary unducted fan propulsor 300 of FIG. 14. However, for the embodiment of FIG. 15, the plurality of outlet guide vanes 302 further includes a third outlet guide vane 302C and a fourth outlet guide vane 302D positioned opposite the first outlet guide vane 302A and second outlet guide vane 302B, respectively (i.e., being the closest outlet guide vane to a 180 degree spacing from the respective outlet guide vane 302). The third outlet guide vane 302C and the fourth outlet guide vane 302D define a spacing 330 within 20% of the gap spacing 316 defined by the first outlet guide vane 302A and the second outlet guide vane 302B, such as within 10% of the gap spacing 316, such as within 5% of the gap spacing 316. In such a manner, the plurality of outlet guide vanes 302 may produce a more uniform back pressure on the fan blades (e.g., fan blades 254 in the embodiment of FIG. 12) of the unducted fan propulsor 300.

Further, still, it will be appreciated that in still other exemplary embodiments, an unducted fan propulsor 300 may be provided having a plurality of outlet guide vanes 302 including a first outlet guide vane 302A and a second outlet guide vane 302B at circumferential locations to allow an acoustically sensitive location 326 therebetween at other desired positions. For example, referring briefly to FIG. 16, an exemplary unducted fan propulsor 300 is depicted having an acoustically sensitive location 326 between a first outlet guide vane 302A and a second outlet guide vane 302B at a five o'clock position.

It will be appreciated, that as used herein, the term “at” with reference to a location of the acoustically sensitive location 326 and/or an external targeted noise reduction location 328 refers to the location 326, 328 being within 15 degrees of the specified circumferential position. Further, it will be appreciated that the “acoustically sensitive location 326” refers to a position halfway between the first outlet guide vane 302A and the second outlet guide vane 302B.

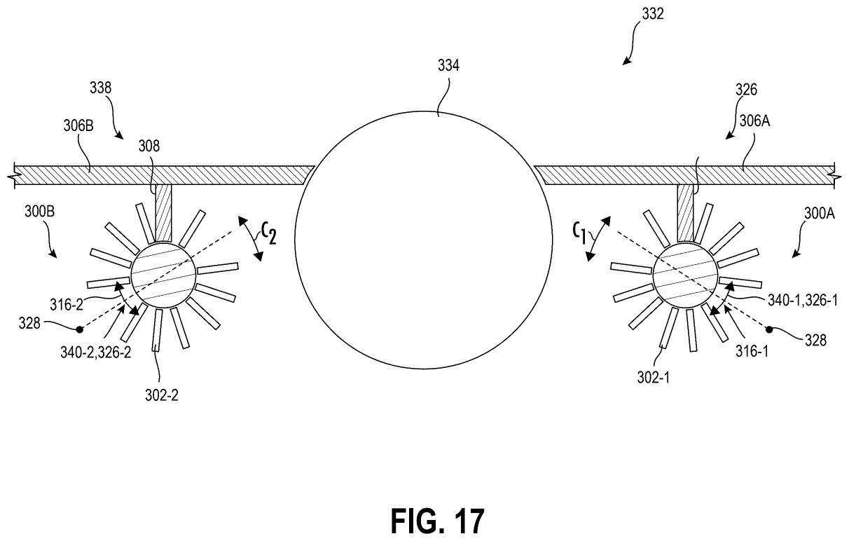

Referring now to FIG. 17, an aircraft 332 is provided in accordance with an exemplary embodiment of the present disclosure. The exemplary aircraft 332 generally includes a fuselage 334 defining a first side 336 and a second side 338. The first side 336 of the fuselage 334 may be a port side of the fuselage 334 and the second side 338 of the fuselage 334 may be a starboard side of the fuselage 334. In such a manner, it will be appreciated that the view of FIG. 17 is a forward-looking-aft view of the aircraft 332. The aircraft 332 further includes a first wing 306A extending from the first side 336 of the fuselage 334 and a second wing 306B extending from a second side 338 of the fuselage 334.

The aircraft 332 further includes a propulsion system. The propulsion system includes a first unducted fan propulsor 300A mounted to the first wing 306A or to the fuselage 334 on the first side 336 of the fuselage 334 and a second unducted fan propulsor 300B mounted to the second wing 306B or the fuselage 334 on the second side 338 of the fuselage 334. For the embodiment shown, the first unducted fan propulsor 300A and the second unducted fan propulsor 300B are mounted to the first wing 306A and the second wing 306B, respectively, in and under-wing configuration using respective pylons 308.

The first unducted fan propulsor 300A defines a first circumferential direction C1 and includes a first unducted rotor assembly (not shown) and a first plurality of outlet guide vanes 302-1 positioned downstream of the first unducted rotor assembly (see, e.g., FIG. 12). Similarly, the second unducted fan propulsor 300B defines a second circumferential direction C2 and includes a second unducted at rotor assembly (not shown) and a second plurality of outlet guide vanes 302-2 positioned downstream of the second unducted rotor assembly (see, e.g., FIG. 12).

The first plurality of outlet guide vanes 302-1 includes N_{OGV1} number of outlet guide vanes 302-1 and defines a first gap spacing 316-1 at a first gap location 340-1 along the first circumferential direction C1, and the second plurality of outlet guide vanes 302-2 includes N_{OGV2} number of outlet guide vanes 302-2 and defines a second gap spacing 316-2 at a second gap location 340-2 along the second circumferential direction C2. The first gap spacing 316-1 is greater than 360 degrees divided by a number of the first plurality of outlet guide vanes 302-1, and the second gap spacing 316-2 is similarly greater than 360 degrees divided by number of the second plurality of outlet guide vanes 302-2.

The first gap location 340-1 is between a two o'clock position and a seven o'clock position, and the second gap location 340-2 is between a five o'clock position and a 10 o'clock position. In particular, for the embodiment shown, the first gap location 340-1 is between a three o'clock position and a six o'clock position and the second gap location 340-2 is between a six o'clock position and a nine o'clock position.

As will be appreciated, the first gap location 340-1 may correspond to a first acoustically sensitive location 326-1 of the first unducted fan propulsor 300A, and the second gap location 340-2 may correspond to a second acoustically sensitive location 326-2 of the second unducted fan propulsor 300B. The first unducted fan propulsor 300A therefore defines the first acoustically sensitive location 326-1 along the circumferential direction C positioned at the first gap location 340-1 and the second unducted fan propulsor 300B defines the second acoustically sensitive location 326-2 along the circumferential direction C positioned at the second gap location 340-2.

In such a manner, it will be appreciated that the propulsion system of the aircraft 332 depicted in FIG. 17 may be configured to reduce an amount of noise propagation at laterally outward locations of the aircraft 332, reducing an amount of noise experienced from opposing sideline positions (labeled 328) during operation of the aircraft 332.

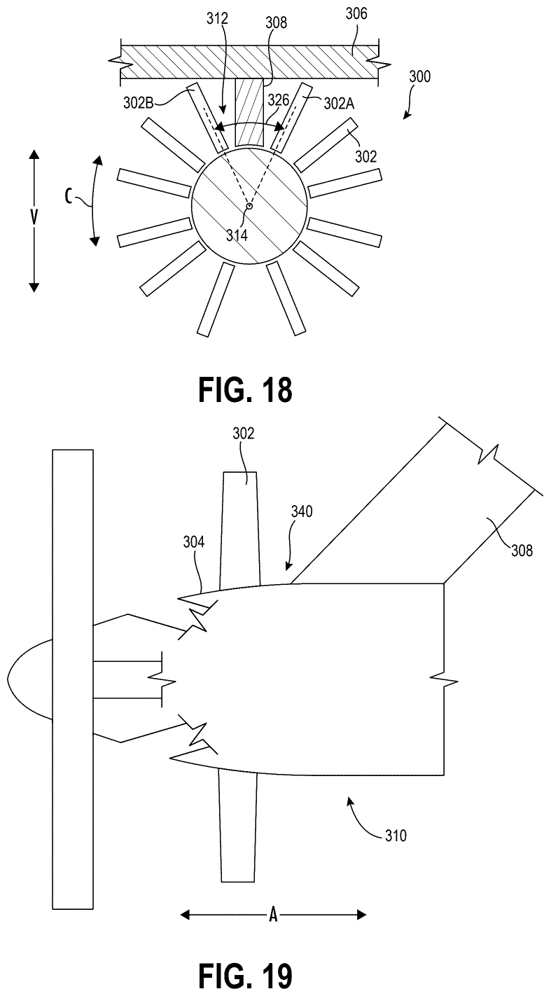

Referring now to FIG. 18, an unducted fan propulsor 300 in accordance with yet another exemplary embodiment of the present disclosure is provided. It will be appreciated that for the embodiment of FIG. 18, the unducted fan propulsor 300 may be configured in a similar manner as the exemplary unducted fan propulsor 300 of FIG. 13, and the same or similar numbers may refer to the same or similar parts.

For example, the exemplary unducted fan propulsor 300 of FIG. 18 generally includes a plurality of outlet guide vanes 302. Further, the unducted fan propulsor 300 is coupled to a wing 306 of an aircraft (not shown other than wing 306) through a pylon 308. In such a manner, it will be appreciated that the unducted fan propulsor 300 generally includes a turbomachine 310 defining a pylon attachment location 312 along a circumferential direction C of the unducted fan propulsor 300. Further, referring briefly to FIG. 19, providing a schematic view of a portion of the unducted fan propulsor 300 and pylon 308 of FIG. 18 from a side, it will be appreciated that the unducted fan propulsor 300 further defines a pylon attachment location 340 along an axial direction A of the unducted fan propulsor 300. The pylon attachment location 340 in the embodiment of FIGS. 18 and 19 is located aft of the plurality of outlet guide vanes 302. In particular, the pylon attachment location 340 refers to a forward-most location where the pylon 308 meets the turbomachine 310, and is aft of an aft-most portion of the plurality of outlet guide vanes 302 depicted.

It will be appreciated, however, that in other exemplary embodiments of the present disclosure, the pylon attachment location 340 may not be positioned aft of the plurality of outlet guide vanes 302, and instead may be positioned at least partially between two outlet guide vanes 302 of the plurality of outlet guide vanes 302.

Referring back to FIG. 18, it will be appreciated that the plurality of outlet guide vanes 302 includes N_{OGV} number of outlet guide vanes 302 which, as with the embodiments above, is less than a number N_{B} of the plurality of unducted rotor blades of an unducted rotor assembly of the unducted fan propulsor 300 (see, e.g., FIG. 12, FIG. 20).

The plurality of outlet guide vanes 302 in FIG. 18 includes a first outlet guide vane 302A and a second outlet guide vane 302B (e.g., a first pair of outlet guide vanes 302) defining a gap spacing 316 less than 360/N_{OGV} and greater than or equal to 360/(N_{B}+2). For example, the spacing may be greater than or equal to 360/(N_{B}+1), such as greater than or equal to 360/N_{B}. For the embodiment depicted in FIG. 18, the pylon attachment location 312 along the circumferential direction C is positioned between the first and second outlet guide vanes 302A, 302B, at a 12 o'clock position.

As discussed above, the exemplary embodiment of FIG. 18 may allow for a lower count of outlet guide vanes 302 relative to the number of rotor blades, which may generally reduce a broadband noise generated by the unducted fan propulsor 300 during operation of the unducted fan propulsor 300.

As will be appreciated, such a configuration may equally apply to other engine mounting locations. For example, referring briefly to FIG. 20, an unducted fan propulsor 300 is depicted coupled to an aircraft structure 343 through a pylon 308. For the embodiment FIG. 20, the pylon 308 couples to the unducted fan propulsor 300 at a side location, such as a three o'clock position (or alternatively at a nine o'clock position) of the unducted fan propulsor 300. With such a configuration, the pylon 308 may be coupling the unducted fan propulsor 300 directly to a fuselage of an aircraft (such as to the fuselage 334 of the aircraft 332 in FIG. 17), e.g., at an aft end of the aircraft.

As mentioned above, the gas turbine engines of the present disclosure are generally designed to reduce noise propagation during operation of the gas turbine engine. With an open rotor gas turbine engine, such as the exemplary gas turbine engine 400 described above with reference to FIG. 12, noise from operation of the rotor assembly may propagate from a plurality of outlet guide vanes, as flow having a nonuniform velocity from the rotor assembly impinges upon the plurality of outlet guide vanes. In particular, with an open rotor configuration, tip vortices from the plurality of rotor blades of the rotor assembly may travel downstream and contact the outlet guide vanes. When these tip vortices contact the outlet guide vanes, undesirable noise may propagate from the outlet guide vanes.

The inventors of the present disclosure have found that during at least certain operating conditions of the gas turbine engine, the tip vortices from the rotor blades may not travel in an uniform way from the rotor blades to the outlet guide vanes along a circumferential direction of the gas turbine engine.

Moreover, the inventors of the present disclosure have found that a useful way to reduce an amount of noise propagation from the gas turbine engine may be to reduce a span of the outlet guide vanes to reduce an amount of contact between the tip vortices of the rotor blades and the outlet guide vanes, to therefore reduce the amount of noise propagation. However, reducing the span of the outlet guide vanes such that the tip vortices from the rotor blades do not contact the outlet guide vanes during the above-noted operating conditions may result in an undesirable reduction in a propulsive efficiency of the gas turbine engine. Therefore, a means of reducing the noise radiated from the outlet guide vanes without excess reduction in efficiency is desirable.

Accordingly, the inventors of the present disclosure have found that incorporating outlet guide vanes having a nonuniform span along the circumferential direction may allow for a reduction in noise propagation during the above-noted operating conditions at desired circumferential targets, without excessively reducing a propulsive efficiency of the gas turbine engine. In particular, the inventors of the present disclosure have found a relationship between various gas turbine engine parameters and gas turbine engine operating conditions to determine a desired location of an outlet guide vane having the shortest span to most efficiently reduce noise propagation during the above-noted operating conditions at desired circumferential target locations, without excessively reducing a propulsive efficiency of the gas turbine engine during other operating conditions.

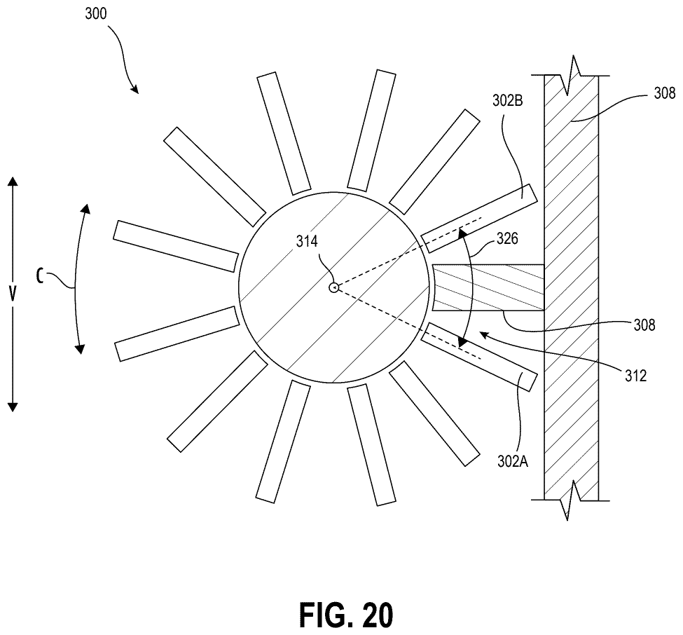

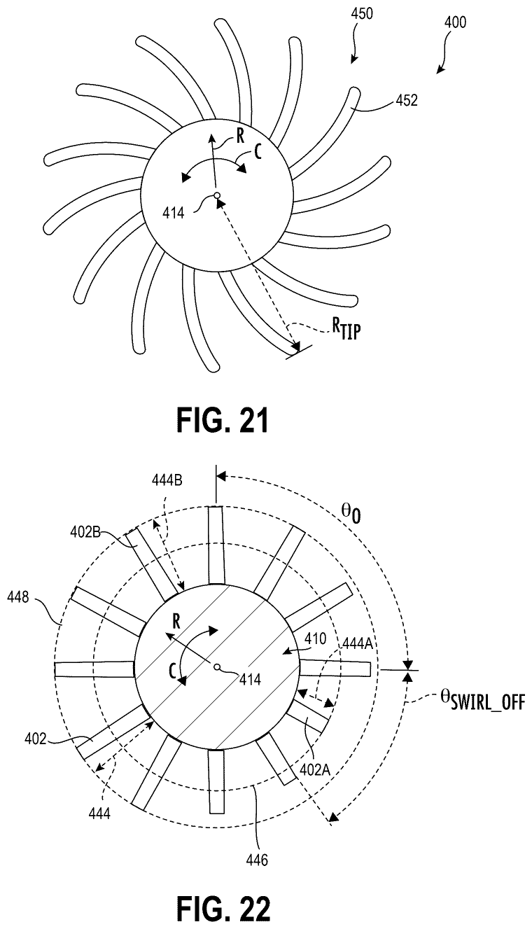

Referring now in particular to FIGS. 21 and 22, aspects of a gas turbine engine 400 in accordance with an exemplary embodiment of the present disclosure is provided. In particular, FIG. 21 depicts a rotor assembly 450 of the gas turbine engine 400 having a plurality of rotor blades 452, and FIG. 22 depicts a plurality of outlet guide vanes 402 of the gas turbine engine 400. The gas turbine engine 400, including the rotor assembly 450 and outlet guide vanes 402, of FIGS. 21 and 22 may be configured in a similar manner as the exemplary gas turbine engines 200, 300 described above.

For example, the gas turbine engine 400 generally additionally includes a turbomachine 410 (see FIG. 22) and defines a longitudinal centerline 414, a circumferential direction C, a radial direction R, and an axial direction A (not depicted in FIGS. 21 and 22). Further, referring particular to FIG. 22, the plurality of outlet guide vanes 402 each define a span 444. The spans 444 of the plurality of outlet guide vanes 402 are nonuniform along a circumferential direction C.

In particular, for the embodiment shown, the plurality of outlet guide vanes 402 includes a first outlet guide vane 402A with a first span 444A that is not greater than the spans 444 of the other outlet guide vanes 402 of the plurality of outlet guide vanes 402. In other words, the first span 444A of the first outlet guide vane 402A is the shortest outlet guide vane 402 (or one of the shortest outlet guide vanes 402). A reference line 446 is provided for illustrative purposes in FIG. 22 to show a height of the first span 444A relative to the spans 444 of the other outlet guide vanes 402.

In the embodiment of FIGS. 21 and 22, a circumferential position of the first outlet guide vane 402A (FIG. 22) is determined based on a location of a most overloaded rotor blade 452 of the plurality of rotor blades 452 of the rotor assembly 450 (FIG. 21) when the rotor assembly 450 is subject to a distorted inflow. In such a manner, the first outlet guide vane 402A may be designed to miss a relatively highly loaded tip vortex from the most overloaded rotor blade 452 during an operating condition of the gas turbine engine 400.

More specifically, the inventors of the present disclosure have determined the location for the first outlet guide vane 402A based on an initial circumferential location of a most overloaded rotor blade 452 of the plurality of rotor blades 452, θ₀, along with a circumferential swirl offset, θ_{SWIRL_OFF}, based on anticipated swirl of the tip vortex from the most overloaded rotor blade 452 at initial circumferential location, θ₀. Notably, a 0 degrees circumferential position corresponds to a 12 o'clock position in the views depicted. Also, all θ parameters are in units of degrees relative to the 12 o'clock position, increasing in the direction of rotation of the rotor assembly/fan.

The most overloaded rotor blade 452 during an operating condition of the gas turbine engine 400 may depend on the operating condition of the gas turbine engine 400. In particular, for the embodiment of FIGS. 21 and 22, the operating condition to which the present disclosure is designed is a high angle of attack operating condition, such as take-off or climb.

In particular, for the embodiment of FIG. 21, the rotor assembly 450 is configured to rotate in a clockwise direction with the angle of attack such that there is a vertically upward component of velocity at the inflow to the rotor assembly 450. In such a manner, the plurality of rotor blade 452 passing through a three o'clock position may be the most highly loaded rotor blade 452 of the plurality of rotor blades 452. For example, the rotor blade 452 passing through the three o'clock position may experience the highest relative angle of attack due to the rotational direction of the plurality of rotor blades 452. By contrast, the rotor blade 452 passing through a nine o'clock position may experience the lowest relative angle of attack due to the rotational direction of the plurality of rotor blades 452, and thus may be the least loaded rotor blade 452 of the plurality of rotor blades 452.

Referring still FIGS. 21 and 22, it will be appreciated that the unducted rotor assembly 450 defines a tip radius, R_{TIP}, and the gas turbine engine 400 defines an axial spacing, S, between the plurality of unducted rotor blades 452 and the plurality of outlet guide vanes 402 (see spacing 266 in FIG. 12). In addition, the rotor assembly 450 defines an advance ratio, J. The advance ratio, J, is defined as

$$\frac{{V}_{INF}}{nD} ,$$

where V_{INF} is the flight velocity of the gas turbine engine 400, n is a rotational speed of the rotor assembly 450 in units of rotations per second, and D is the diameter of the rotor assembly 450 (i.e., two times the tip radius, R_{TIP}).

The circumferential swirl offset, θ_{SWIRL_OFF}, is calculated based on the following relationship:

$$2 \times {tan}^{- 1} ( \frac{π \times S}{J \times {R}_{TIP}} ) .$$

Notably, the inventors of the present disclosure have discovered that the specific mounting locations described hereinabove, and particularly those where the unducted fan propulsor is positioned relative to the effective quarter chord point (QC) with an RL/D<2.0, can create a unique aerodynamic environment that alters the inflow conditions seen by the rotor assembly 450. Specifically, mounting the unducted fan propulsor in these positions relative to the wing utilizes the wing's high-pressure field to offset drag, but a direct consequence of this installation is a local deceleration of the airflow entering the fan. Consequently, the fan operates at an effective installed velocity (Ve) that is strictly less than the freestream flight velocity (Vinf) (e.g., Ve may be 95% to 99% of Vinf).

This reduction in inflow velocity may require an adjustment of the advance ratio used for designing the non-uniform OGV features. While a standard advance ratio is defined above, the installation effects of the present disclosure may support defining an effective advance ratio (Je) as

$$\frac{{V}_{e}}{nD}$$

Because Ve is less than Vint, the effective advance ratio Je is lower than the freestream advance ratio J. The inventors have identified that the trajectory of the wakes shed by the fan blades, and specifically the Swirl Offset angle determining where those wakes impinge upon the OGVs, may be a function of this lower effective advance ratio (Je) when the unducted fan propulsor is mounted according to the RL/D relationship.

Accordingly, to fully realize the acoustic and aerodynamic benefits of the claimed mounting locations, the circumferential positioning (or “clocking”) of the non-uniform OGV features, such as the location of the gap spacing 316 or the shortest vane 302A, is determined based on the effective advance ratio (Je). For instance, the calculation of the circumferential swirl offset (θ_{SWIRL_OFF}) described hereinbelow may utilize Je in the denominator rather than the freestream J. This adjustment may allow for the acoustic mitigation features to be physically located to intercept the wake trajectory as shifted by the installation-induced flow deceleration, thereby improving propulsive efficiency while reducing installation noise penalties.

For the embodiment shown, the first outlet guide vane 402A is located at a circumferential position between θ₀ and θ_{SWIRL_OFF}, where θ_{SWIRL_OFF} is defined in the direction of rotation of the fan. More specifically, for the embodiment shown, the first outlet guide vane 402A is located at a circumferential position equal to θ₀ plus θ_{SWIRL_OFF} divided by 2. As will be appreciated, the position θ₀ is indicative of where a wake from the highest loaded rotor blade 452 starts. It was found that a range from θ₀ to θ_{SWIRL_OFF} identifies the region where a wake can pass through a plane defined by the plurality of outlet guide vanes 402. This angular range can encompass one, two or three outlet guide vanes succeeding the highest loaded blade in some embodiments.

By positioning the first outlet guide vane 402A at such a circumferential location, the first outlet guide vane 402A may be configured to be radially inboard of the tip vortices from the plurality of rotor blades 452 passing through the most highly loaded position of the rotor assembly 450 for the gas turbine engine operating condition, therefore reducing an amount of tonal noise generated.

Notably, for the embodiment of FIGS. 21 and 22, the plurality of outlet guide vanes 402 further includes a second outlet guide vane 402B with a second span 444B not shorter than the spans 444 of the other outlet guide vanes 402. Accordingly, the second outlet guide vane 402B is the longest outlet guide vane 402 (or, e.g., one of the longest outlet guide vanes 402). The second outlet guide vane 402B is located at a circumferential position between 150 degrees and 210 degrees offset from the first outlet guide vane 402A in the embodiment of FIGS. 21 and 22. A reference line 448 is provided for illustrative purposes in FIG. 22 to show a height of the second span 444B relative to the spans 444 of the other outlet guide vanes 402.

In such manner, the second outlet guide vane 402B may extend outwardly along the radial direction R to a span extent required for optimum efficiency and mitigating the performance reduction associated with the shorter first outlet guide vane 402A.

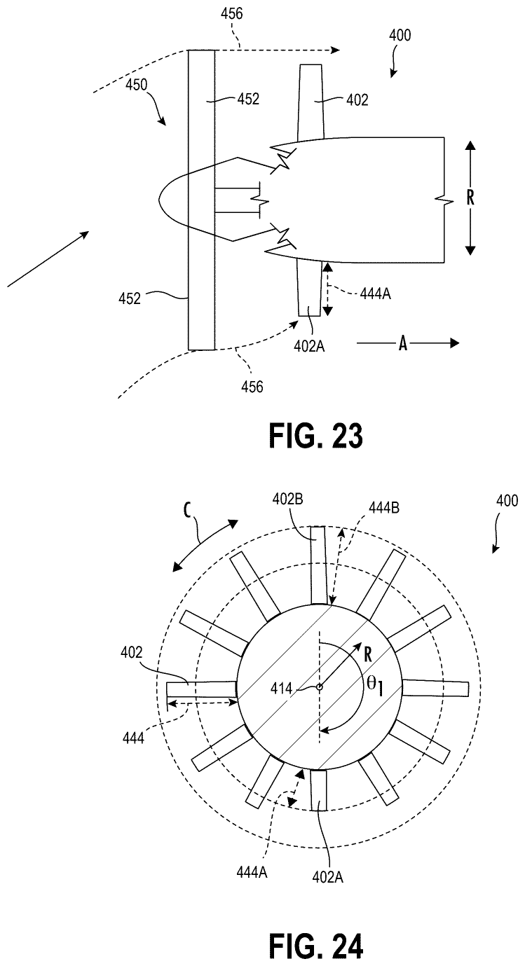

Referring now particularly to FIGS. 23 and 24, a gas turbine engine 400 in accordance with another exemplary embodiment of the present disclosure is provided. In particular, FIG. 23 provides a side, schematic view of the gas turbine engine 400 during an operating condition, and FIG. 24 depicts a plurality of outlet guide vanes 402 of the gas turbine engine 400 of FIG. 23. The gas turbine engine 400 and a rotor assembly 450 of the gas turbine engine 400 depicted in FIGS. 23 and 24 may be configured in a similar manner as exemplary gas turbine engines 200, 300, 400 described above.

As with the embodiment of FIGS. 21 and 22, the plurality of outlet guide vanes 402 depicted in FIGS. 23 and 24 each define a span 444. The spans 444 of the plurality of outlet guide vanes 402 are nonuniform along the circumferential direction C (see FIG. 24). In particular, for the embodiment shown, the plurality of outlet guide vanes 402 includes a first outlet guide vane 402A with a first span 444A that is not greater than the spans 444 of the other outlet guide vanes 402 of the plurality of outlet guide vanes 402. In other words, the first span 444A of the first outlet guide vane 402A is the shortest outlet guide vane 402 (or one of the shortest outlet guide vanes 402) (see FIG. 24).

In the embodiment of FIGS. 23 and 24, a circumferential position of the first outlet guide vane 402A is determined based on a location at which a streamtube 456 from the rotor assembly 450 contracts inwardly along the radial direction R a maximum amount. Referring particularly to FIG. 23, the streamtube 456 from the rotor assembly 450 is depicted in phantom. During a gas turbine engine operating condition, the unducted rotor assembly 450 defines a location of highest inward deflection of the streamtube, θ₁. The first outlet guide vane 402A having the first span 444A not greater than the spans 444 of the other outlet guide vanes 402 is located within 30 degrees of θ₁ (see FIG. 24).

In particular, for the embodiment depicted, the gas turbine engine operating condition is a high angle-of-attack operating condition, such as take-off or climb. With such an operating condition, θ₁ equals 180 degrees from top dead center, i.e., a six o'clock position (see FIG. 24). In such a manner, the first outlet guide vane 402A is configured to extend beneath an inward radial deflection of the streamtube 456 during the gas turbine engine operating condition, to reduce an acoustic impact of such streamtube 456 on the outlet guide vanes 402 (see FIG. 23).

It will be appreciated, however, that in other exemplary embodiments, the plurality of outlet guide vanes 402 may include the first outlet guide vane 402A with the first span 444A not greater than the spans 444 of the other outlet guide vanes 402 at other suitable locations. For example, there may be one more features of the gas turbine engine 400, and/or a mounting of the gas turbine engine 400, that affect aerodynamic flow field of the gas turbine engine 400, and thus acoustic radiation of the gas turbine engine 400.

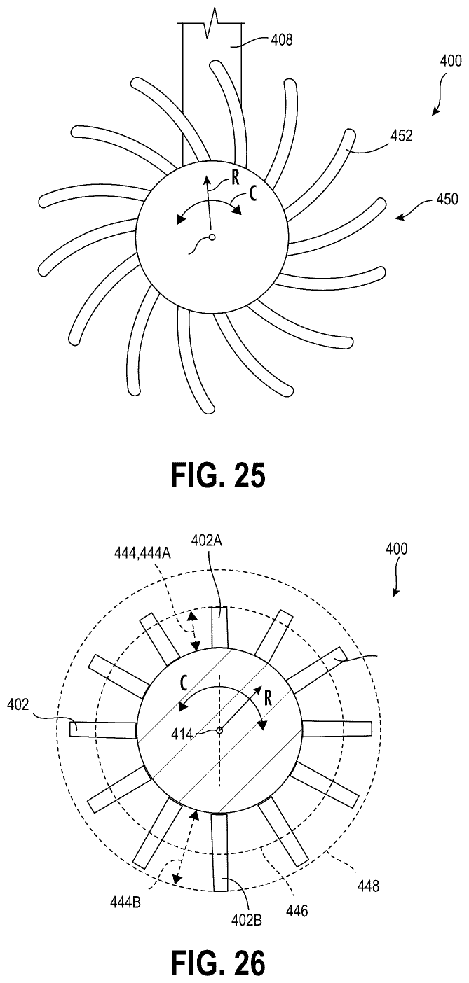

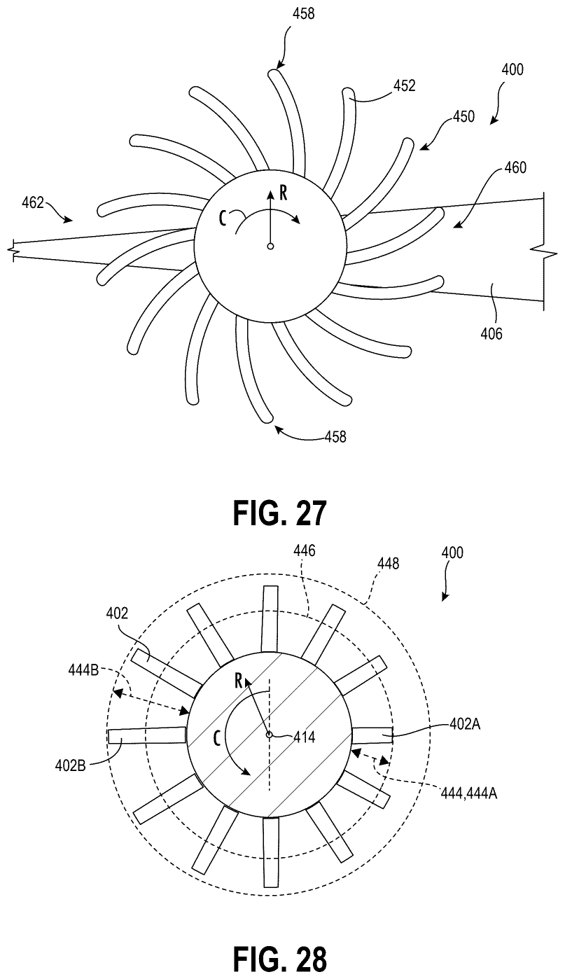

For example, referring now to FIGS. 25 and 26, as well as FIGS. 27 and 28, two additional gas turbine engines 400 are depicted designed to address different aerodynamic flow fields of the gas turbine engine 400. The exemplary gas turbine engines 400 of FIGS. 25 and 26, as well as of FIGS. 27 and 28, may be configured in a similar manner as exemplary gas turbine engines 200, 300, 400 described above.

Referring particular to FIGS. 25 and 26, the exemplary gas turbine engine 400 is configured to be mounted through a pylon 408. Referring particular to FIG. 25, the pylon 408 extends to a turbomachine 410 (see FIG. 26) of the gas turbine engine 400 at a 12 o'clock position. With such a configuration, the pylon 408 may create an aerodynamic blockage, creating a higher pressure upstream of the pylon 408 relative to other locations along a circumferential direction C. Such a blockage may create a higher level of loading on the rotor blades 452 as they pass by upstream in the circumferential vicinity of the pylon 408, shedding a stronger tip vortex upstream of the pylon 408. Accordingly, for the embodiment of FIGS. 25 and 26, a span 444 of the outlet guide vanes 402 at a circumferential position aligned with (e.g., within 30 degrees) of a leading edge of the pylon 408 may be reduced to avoid interaction with the higher strength vortex from the rotor assembly 450 at such location. In particular, for embodiment of FIGS. 25 and 26, a first outlet guide vane 402A having a first span 444A not greater than the spans 444 of the other outlet guide vanes 402 is positioned at the circumferential position aligned with the leading edge of the pylon 408 (see FIG. 25).

Similarly, referring now to FIGS. 27 and 28, the exemplary gas turbine engine 400 is configured to be mounted to a wing 406, such that the wing 406 is positioned inwardly along a radial direction R of the gas turbine engine 400 from radially outer tips 458 of the unducted rotor blades 452 of the unducted rotor assembly 450 (e.g., the wing 406 may be located vertically proximate the axis of the gas turbine engine 400). In such a manner, the wing 406 may similarly create a blockage that creates a higher pressure upstream of the wing 406, potentially leading to higher vortex strengths coming from the rotor blades 452 at such a circumferential position(s). Notably, for the embodiment shown, a thickness of the wing 406 decreases along its length, such that on a first side 460 of the gas turbine engine 400, a thickness of the wing 406 is greater than a thickness of the wing 406 on a second side 462 of the gas turbine engine 400. Further for a swept wing, a distance along an axial direction of the gas turbine engine 400 between a first side 460 of the wing 406 and the gas turbine engine 400 is shorter than at the second side 462, compounding or amplifying the effect of different wing thicknesses on the fan loading distortion.

With such a configuration, the span 444 of the outlet guide vanes 402 at the circumferential position aligned (e.g., within 30 degrees) with a leading edge of the wing 406 may be reduced to avoid interaction with the higher strength vortex from the rotor assembly 450 at such location. In particular, for the embodiment depicted, the plurality of outlet guide vanes 402 includes a first outlet guide vane 402A having a first span 444A not greater than the spans 444 of the other outlet guide vanes 402 positioned at a circumferential position aligned with the leading edge of a thicker portion of the wing 406, or rather positioned at a circumferential position aligned with the leading edge of a the wing 406 on the first side 460 of the gas turbine engine 400 (see FIG. 28).

Referring to FIGS. 25 through 28, it will be appreciated that the position of the first outlet guide vane 402A with the first span 444A not greater than the spans 444 of the other outlet guide vanes 402 (i.e., the shortest outlet guide vane 402) and the second outlet guide vane 402B with the second span 444B not shorter than the spans 444 of the other outlet guide vanes 402 (e.g., a longest outlet guide vane 402) may be based on a location of the most overloaded fan blade, similar to the discussion above with reference to the determination of the position of the gap spacing. In such a manner, although the first outlet guide vanes 402A with the first spans 444A not greater than the spans 444 of the other outlet guide vanes 402 in FIGS. 26 and 28 are depicted immediately downstream of the pylon 408 and the wing 406, in other embodiments the first outlet guide vanes 402A may be offset in the circumferential direction C by up to θ_{SWIRL_OFF}.

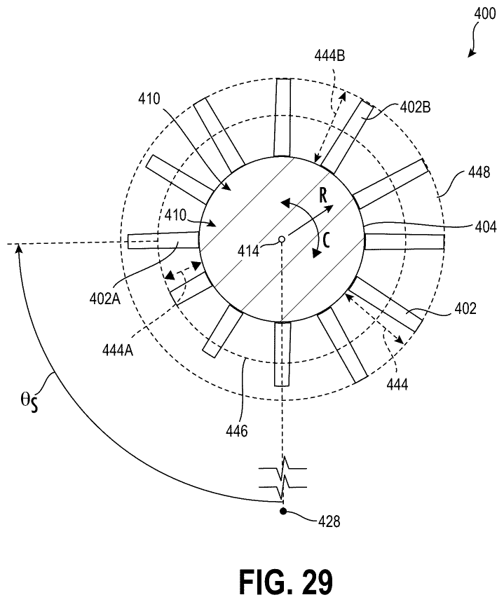

It will be appreciated that in still other exemplary embodiments, a location of a first outlet guide vane 402A with a first span 444A not greater than the spans 444 of the other outlet guide vanes 402 (i.e., a shortest outlet guide vane 402) and a second outlet guide vane 402B with a second span 444B not shorter than the spans 444 of the other outlet guide vanes 402 (e.g., a longest outlet guide vane 402) may be determined in any other suitable manner. For example, referring now to FIG. 29, a schematic, forward-looking-aft view of a plurality of outlet guide vanes 402 coupled to a cowl 404 of a turbomachine 410 of a gas turbine engine 400 in accordance with another exemplary embodiment of the present disclosure is provided.

For the embodiment of FIG. 29, the gas turbine engine 400 defines an acoustically sensitive location 428 along the circumferential direction C, corresponding to an external targeted noise reduction location. In the embodiment shown, the acoustically sensitive location 428 is positioned at a six o'clock position. The first outlet guide vane 402A is offset by an angle θ_{S}. θ_{S} is, for the embodiment depicted, between 60 degrees and 120 degrees in the direction of rotation of the fan of the gas turbine engine 400, or counter the direction of rotation of the fan of the gas turbine engine 400. In such a manner, the exemplary gas turbine engine 400 depicted is configured to reduce an amount of noise propagation from the outlet guide vanes 402 downwardly during operation of the unducted fan propulsor 200, reducing an amount of noise experienced during, e.g., a flyover event of an aircraft including the gas turbine engine 400 of FIG. 29.

It will be appreciated, however, that in other exemplary embodiments, the gas turbine engine 400 may define one or more acoustically sensitive locations 428 at other positions, such as at one or more of the positions discussed above with reference to FIGS. 13 through 17.

Referring to FIGS. 21 through 29, generally, it will be appreciated that the plurality of outlet guide vanes 402 in the various embodiments depicted each generally includes a first outlet guide vane 402A with a first span 444A not greater than the spans 444 of the other outlet guide vanes 402 (i.e., a shortest outlet guide vane 402) and a second outlet guide vane 402B with a second span 444B not shorter than the spans 444 of the other outlet guide vanes 402 (e.g., a longest outlet guide vane 402). The plurality of outlet guide vanes 402 further includes a plurality of intermediate outlet guide vanes 402 positioned between the first outlet guide vane 402A and the second outlet guide vane 402B. The spans 444 of the plurality of intermediate outlet guide vanes 402 are greater than the first span 444A and less than the second span 444B.

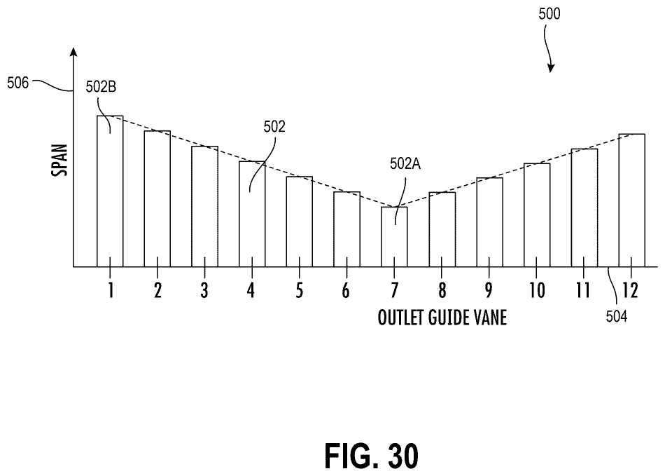

In particular, referring now to FIG. 30, a graph 500 is provided showing a plurality of outlet guide vanes 502 arranged along an X axis 504 and a span of each of the respective outlet guide vanes 502 along a Y axis 506. The plurality of outlet guide vanes 502 includes a first outlet guide vane 502A, a second outlet guide vane 502B, and a plurality of intermediate outlet guide vanes 502 positioned therebetween as noted above. In the embodiment shown, the first outlet guide vane 502A, the second outlet guide vane 502B, and the plurality of intermediate outlet guide vanes 502 includes at least half of a total number of outlet guide vanes 502 of the plurality of outlet guide vanes 502.

In the embodiment shown the spans of the outlet guide vanes 502 increases from the first outlet guide vane 502A to the second outlet guide vane 502B according to a function. The function may be one of a linear function or a cosine function, or any other suitable function. In particular, for the embodiment of FIG. 30, the function is a linear function such that the spans of the outlet guide vanes 502 increase linearly from the first outlet guide vane 502A to the second outlet guide vane 502B. The linear function is depicted in phantom in the graph 500 of FIG. 30.

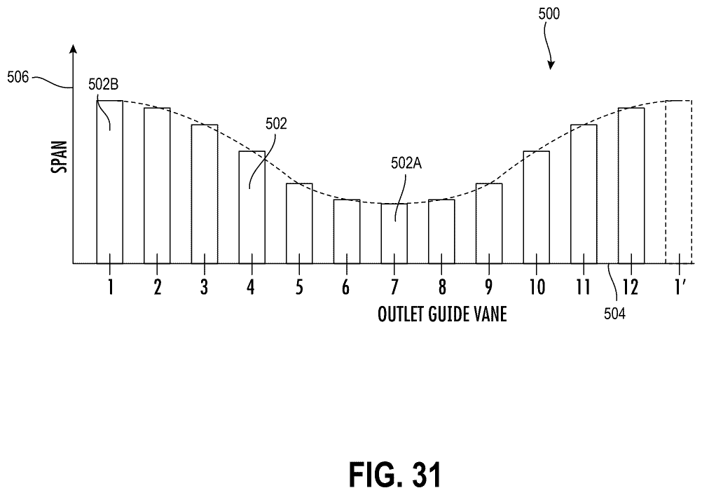

However, in other embodiments, the spans may increase according to any other suitable function. For example, referring now briefly to FIG. 31, the spans of the outlet guide vanes 502 depicted increases from the first outlet guide vane 502A to the second outlet guide vane 502B according to a sinusoidally-varied function (or rather negative cosine function for the embodiment depicted in FIG. 30). The sinusoidally-varied function is depicted in phantom in the graph 500 of FIG. 31.

In such a manner, the plurality of outlet guide vanes 502 may be configured to most efficiently reduce a noise generated through interaction of airflow from the rotor blades with the outlet guide vanes 502, while still providing for efficient operation of the gas turbine engine.

It will be appreciated that at least certain of the exemplary configurations described above relate to determining a position of a first outlet guide vane 402A with a first span 444A that is not greater than the spans 444 of the other outlet guide vanes 402 of the plurality of outlet guide vanes 402, i.e., the shortest outlet guide vane 402. In other exemplary aspects, the same or similar methodologies described above may be utilized to determine a position of a plurality of consecutive outlet guide vanes 402 forming a “short vane subset”, where an average span 444 of the outlet guide vanes 402 forming the short vane subset is less than a median span 444 of all of the plurality of outlet guide vanes 402.

In at least one exemplary embodiment, the plurality of consecutive outlet guide vanes 402 forming the short vane subset may be at least two outlet guide vanes 402 and less than 50% of the plurality of outlet guide vanes 402, such as less than 25% of the plurality of outlet guide vanes 402.

In particular, in one exemplary aspect the unducted rotor assembly defines a circumferential position, θ₀, of the highest loaded rotor blade at a first gas turbine engine operating condition and a tip radius, R_{TIP}, wherein the unducted fan propulsor 200 defines an axial spacing, S, between the plurality of unducted rotor blades and the plurality of outlet guide vanes 402 and an advance ratio, J. With such a configuration, the unducted fan propulsor 200 may define a circumferential swirl offset, θ_{SWIRL_OFF}, equal to

$$2 \times {tan}^{- 1} ( \frac{π \times S}{J \times {R}_{TIP}} ) .$$

Or, if the unducted fan propulsor is mounted according to the RL/D relationship, θ_{SWIRL_OFF}, may be defined using the an effective advance ratio, Je, and more specifically may be equal to

$$2 \times {tan}^{- 1} ( \frac{π \times S}{{Je \times {R}_{TIP}}^{}} ) .$$

With such a configuration, the plurality of consecutive outlet guide vanes 402 forming the short vane subset may include at least one outlet guide vane 402 located at a circumferential position between θ₀ and θ_{SWIRL_OFF} (see FIG. 22).

In another exemplary aspect, the unducted rotor assembly may define a circumferential position, θ₁, of highest inward deflection of a streamtube 456 at a gas turbine engine operating condition (see FIGS. 23 and 24). With such a configuration, the plurality of consecutive outlet guide vanes 402 forming the short vane subset includes at least one outlet guide vane may be located within 30 degrees of θ₁.

Further, in still other exemplary aspects, the unducted fan propulsor 200 may define an acoustically sensitive location, θ_{A}, along the circumferential direction. With such an exemplary aspect, the plurality of consecutive outlet guide vanes 402 forming the short vane subset includes at least one outlet guide vane 402 located at a circumferential position of θ_{A} plus θ_{S} or θ_{A} minus θ_{S}, where θ_{S} is between 60 degrees and 120 degrees (see FIG. 29).

Further aspects of the disclosure are provided by the subject matter of the following clauses:

Clause 1: An aircraft is provided that includes a fuselage; an airfoil extending from the fuselage, the airfoil having an airfoil section with a leading edge (LE) and a trailing edge (TE), a chord extending between the LE and TE, and an effective quarter chord point (QC) along the chord measured from the LE; an unducted fan propulsor mounted relative to the airfoil section on a high pressure side thereof, the unducted fan propulsor having a centerline (CL) and a plurality of blades arranged in one or more arrays, each of the blades having a root and the plurality of blades defining a maximum outer diameter (D), the unducted fan propulsor having a point (P) defined as one of: (a) wherein the plurality of blades is arranged in a single array, the point P is located at an intersection of the CL and a line perpendicular to the CL that passes through a midpoint between edges at the root of one of the plurality of blades, and (b) wherein the plurality of blades is arranged in a forward array and a rearward array, the point P is located at an intersection of the CL and midpoint between a rearward trailing edge (TE) of the rearward array and leading edge (LE) of the forward array when a blade of the forward and rearward arrays are aligned with each other; and an ellipse origin positioning line (EOR) having a length (EORL) extending from the QC to an ellipse origin (OR) and at an angle θ as measured from a vector from the QC to the TE of the airfoil section to the line EOR, where, when viewed with the LE to the left of TE, a positive θ (1) increases in a counter-clockwise direction when the high pressure side of the airfoil section is below the airfoil section, and (2) increases in a clockwise direction when the high pressure side of the airfoil section is above the airfoil section, and wherein the P of the unducted fan propulsor is located within a first ellipse having a first major axis length (1MajAL) and a first minor axis length (1MinAL) with a first ellipse origin defined by EORL/D of 0.938 and θ of 253.6°, and where 1MajAL/D is 2.8 and 1MinAL/D is 1.7.

In the preceding clause, the P of the unducted fan propulsor is located in a second ellipse having a second major axis length (2MajAL) and a second minor axis length (2MinAL) with a second ellipse origin defined by EORL/D of 1.051 and θ of 248.8°, and where 2MajAL/D is 1.86 and 2MinAL/D is 1.56.

In any of the preceding clauses, the P of the unducted fan propulsor is located in a third ellipse having a third major axis length (3MajAL) and a third minor axis length (3MinAL) with a third ellipse origin defined by EORL/D of 0.870 and θ of 239.6°, where 3MajAL/D is 1.4 and 3MinAL/D is 0.9.

In any of the preceding clauses, the P of the unducted fan propulsor is located in a fourth ellipse having a fourth major axis length (4MajAL) and a fourth minor axis length (4MinAL) with a fourth ellipse origin defined by EORL/D of 0.763 and θ of 235.7°, and where 4MajAL/D is 0.94 and 4MinAL/D is 0.44.

In any of the preceding clauses, the unducted fan propulsor is undermounted to the airfoil, such as a wing, with one or more intermediate structures.

In any of the preceding clauses, the unducted fan propulsor has a cruise flight Mach M₀ of between 0.70 and 0.85, between 0.5 and 0.9, between 0.7 and 0.9, or between 0.75 and 0.9.

In any of the preceding clauses, the rotating blades diameter is between 8 to 16 feet or between 12 to 16 feet. In any of the preceding clauses, the aircraft having a wing defining the airfoil and one or two unducted fan propulsors are mounted to the wing.

In any of the preceding clauses, wherein the aircraft are aircraft types A, B, C or G as defined in Tables 1 and 2.

Clause 2: An aircraft is provided including a fuselage; an airfoil extending from the fuselage, the airfoil having an airfoil section with a leading edge (LE) and a trailing edge (TE), a chord extending between the LE and TE, and an effective quarter chord point (QC) along the chord measured from the LE; an unducted fan propulsor mounted relative to the airfoil section on a high pressure side thereof, the unducted fan propulsor having a centerline (CL) and a plurality of blades arranged in one or more arrays, each of the blades having a root and the plurality of blades defining a maximum outer diameter (D), the unducted fan propulsor having a point (P) defined as one of: (a) wherein the plurality of blades is arranged in a single array, the point P is located at an intersection of the CL and a line perpendicular to the CL that passes through a midpoint between edges at the root of one of the plurality of blades, and (b) wherein the plurality of blades is arranged in a forward array and a rearward array, the point P is located at an intersection of the CL and midpoint between a rearward trailing edge (TE) of the rearward array and leading edge (LE) of the forward array when a blade of the forward and rearward arrays are aligned with each other; and a positioning line (R) having a length (RL) and extending from the QC to the point P of the unducted fan propulsor and at an angle θ as measured from a vector from the QC to the TE of the airfoil section to the line R, where, when viewed with the LE to the left of TE, a positive θ (1) increases in a counter-clockwise direction when the high pressure side of the airfoil section is below the airfoil section, and (2) increases in a clockwise direction when the high pressure side of the airfoil section is above the airfoil section, and wherein 0.065<RL/D<1.98 and θ is between 187° and 340°, and wherein RL/D and θ of the P of the unducted fan propulsor adhere to the following expressions:

$$\frac{RL}{D} + \frac{( \begin{matrix}\sqrt{\begin{matrix}1.4161 * [ 1.88978 * {sin}^{2} ( θ ) - 0.0875 * {cos}^{2} ( θ ) + \\ 0.477 * sin ( θ ) * cos ( θ ) ]\end{matrix}} + \\ 1.764 * sin ( θ ) + 0.19146 * cos ( θ ) )\end{matrix} )}{1.96 * {sin}^{2} ( θ ) + 0.7225 * {cos}^{2} ( θ )} > 0$$

$$and$$

$$\frac{RL}{D} + \frac{( \begin{matrix}- \sqrt{\begin{matrix}1.4161 * [ 1.88978 * {sin}^{2} ( θ ) - 0.0875 * {cos}^{2} ( θ ) + \\ 0.477 * sin ( θ ) * cos ( θ ) ]\end{matrix}} + \\ 1.764 * sin ( θ ) + 0.19146 * cos ( θ )\end{matrix} )}{1.96 * {sin}^{2} ( θ ) + 0.7225 * {cos}^{2} ( θ )} < 0$$

In the preceding clause, 0.254<RL/D<1.86 and θ is between 199° and 306°, and the P of the unducted fan propulsor is defined by the following expressions:

$$\frac{RL}{D} + \frac{( \begin{matrix}\sqrt{\begin{matrix}0.52621 * [ 0.7205 * {sin}^{2} ( θ ) - 0.352 * {cos}^{2} ( θ ) + \\ 0.7448 * sin ( θ ) * cos ( θ ) ]\end{matrix}} + \\ 0.8476 * sin ( θ ) + 0.23119 * cos ( θ )\end{matrix} )}{0.8649 * {sin}^{2} ( θ ) + 0.6084 * {cos}^{2} ( θ )} > 0$$

$$and$$

$$\frac{RL}{D} + \frac{( \begin{matrix}- \sqrt{\begin{matrix}0.52621 * [ 0.7205 * {sin}^{2} ( θ ) - 0.352 * {cos}^{2} ( θ ) + \\ 0.7448 * sin ( θ ) * cos ( θ ) ]\end{matrix}} + \\ 0.8476 * sin ( θ ) + 0.23119 * cos ( θ )\end{matrix} )}{0.8649 * {sin}^{2} ( θ ) + 0.6084 * {cos}^{2} ( θ )} < 0$$

In any of the two preceding clauses, 0.369<RL/D<1.43 and θ is between 204° and 291°, and the P of the unducted fan propulsor is defined by the following expressions:

$$\frac{RL}{D} + \frac{( \begin{matrix}\sqrt{\begin{matrix}0.52621 * [ 0.7205 * {sin}^{2} ( θ ) - 0.352 * {cos}^{2} ( θ ) + \\ 0.7448 * sin ( θ ) * cos ( θ ) ]\end{matrix}} + \\ 0.8476 * sin ( θ ) + 0.23119 * cos ( θ )\end{matrix} )}{0.8649 * {sin}^{2} ( θ ) + 0.6084 * {cos}^{2} ( θ )} > 0$$

$$and$$

$$\frac{RL}{D} + \frac{( \begin{matrix}- \sqrt{\begin{matrix}0.52621 * [ 0.7205 * {sin}^{2} ( θ ) - 0.352 * {cos}^{2} ( θ ) + \\ 0.7448 * sin ( θ ) * cos ( θ ) ]\end{matrix}} + \\ 0.8476 * sin ( θ ) + 0.23119 * cos ( θ )\end{matrix} )}{0.8649 * {sin}^{2} ( θ ) + 0.6084 * {cos}^{2} ( θ )} < 0$$

In any of the three preceding clauses: 0.477<RL/D<0.9455 and θ is between 211° and 274°, and the P of the unducted fan propulsor is defined by the following expressions:

$$\frac{RL}{D} + \frac{( \begin{matrix}\sqrt{\begin{matrix}0.01069156 * [ 0.036 * {sin}^{2} ( θ ) - 0.3485 * {cos}^{2} ( θ ) + \\ 0.5418 * sin ( θ ) * cos ( θ ) ]\end{matrix}} + \\ 0.139167 * sin ( θ ) + 0.020812 * cos ( θ )\end{matrix} )}{0.2209 * {sin}^{2} ( θ ) + 0.0484 * {cos}^{2} ( θ )} > 0$$

$$and$$

$$\frac{RL}{D} + \frac{( \begin{matrix}- \sqrt{\begin{matrix}0.01069156 * [ 0.036 * {sin}^{2} ( θ ) - 0.3485 * {cos}^{2} ( θ ) + \\ 0.5418 * sin ( θ ) * cos ( θ ) ]\end{matrix}} + \\ 0.139167 * sin ( θ ) + 0.020812 * cos ( θ )\end{matrix} )}{0.2209 * {sin}^{2} ( θ ) + 0.0484 * {cos}^{2} ( θ )} > 0$$

In any of the four preceding clauses, the unducted fan propulsor is undermounted to the airfoil, such as a wing, with one or more intermediate structures.

In any of the preceding clauses, the unducted fan propulsor has a cruise flight Mach M₀ of between 0.70 and 0.85, between 0.5 and 0.9, between 0.7 and 0.9, or between 0.75 and 0.9.

Clause 3: An aircraft is provided that includes a fuselage; an airfoil extending from the fuselage, the airfoil having an airfoil section with a leading edge (LE) and a trailing edge (TE), a chord extending between the LE and TE, and an effective quarter chord point (QC) along the chord measured from the LE; an unducted fan propulsor mounted relative to the airfoil section on a high pressure side thereof, the unducted fan propulsor having a centerline (CL) and a plurality of blades arranged in one or more arrays, each of the blades having a root and the plurality of blades defining a maximum outer diameter (D), the unducted fan propulsor having a point (P) defined as one of: (a) wherein the plurality of blades is arranged in a single array, the point P is located at an intersection of the CL and a line perpendicular to the CL that passes through a midpoint between edges at the root of one of the plurality of blades, and (b) wherein the plurality of blades is arranged in a forward array and a rearward array, the point P is located at an intersection of the CL and midpoint between a rearward trailing edge (TE) of the rearward array and leading edge (LE) of the forward array when a blade of the forward and rearward arrays are aligned with each other; and a positioning line (R) having a length (RL) and extending from the QC to the point P of the unducted fan propulsor and at an angle θ as measured from a vector from the QC to the TE of the airfoil section to the line R, where, when viewed with the LE to the left of TE, a positive θ (1) increases in a counter-clockwise direction when the high pressure side of the airfoil section is below the airfoil section, and (2) increases in a clockwise direction when the high pressure side of the airfoil section is above the airfoil section, and wherein RL/D≤2 and θ is between 187° and 342°.

In any of the preceding clauses, 0.15≤RL/D.

In any of the preceding clauses, 0.35≤RL/D, and preferably RL/D is about 0.72.

In any of the preceding clauses, wherein 0 is between 198° and 310°, and preferably between 205° and 285°.

In any of the preceding clauses, the unducted fan propulsor operates at a cruise flight Mach M₀ of between 0.5 and 0.9, preferably between 0.7 and 0.9, and more preferably between 0.75 and 0.9.

In any of the preceding clauses, the unducted fan propulsor has a dimensionless cruise fan net thrust parameter expressed as follows:

$$0.15 > \frac{{F}_{net}}{{ρ}_{0} {A}_{a n} {V}_{0}^{2}} > 0.06 ,$$

wherein Fₙₑₜ is cruise fan net thrust, ρ₀ is ambient air density, Vₒ is cruise flight velocity, and Aₐₙ is annular cross-sectional area perpendicular to an axis of rotation of a rotor axis of rotation.

In any of the preceding clauses, the unducted fan propulsor is undermounted to the airfoil with one or more intermediate structures.

In any of the foregoing clauses, the P of the unducted fan propulsor is variable to accommodate different operating conditions.

In any of the preceding clauses, the aircraft includes a plurality of the unducted fan propulsors.

In the preceding clause, the plurality of the unducted fan propulsors may be each mounted to the same airfoil, such as a wing or horizontal stabilizer; or the plurality of the unducted fan propulsors may be each mounted to different airfoils, such as a wing or horizontal stabilizer; or combinations thereof.

In any of the preceding clauses, wherein the unducted propulsor has two arrays of blades and only one of the array of blades is rotating.

Clause 4: An aircraft is provided that includes a fuselage; an airfoil extending from the fuselage, the airfoil having an airfoil section defining an effective quarter chord point (QC); an unducted fan propulsor mounted relative to the airfoil section on a high pressure side thereof, the unducted fan propulsor having a centerline (CL), a plurality of counterclockwise rotating blades arranged in a forward array and a plurality clockwise rotating blades arranged in a rearward array, wherein one of the forward and rearward array of blades define a maximum outer diameter (D); a point (P) located at the intersection of the CL and a midpoint (TRL) between a rearward trailing edge nearest a root of a blade of the rearward array and a leading edge nearest a root of a blade of the forward array when the forward leading edge and rearward trailing edge of the respective blades are aligned with each other; and an ellipse origin positioning line (EOR) having a length (EORL) extending from the QC to an ellipse origin (OR) at an angle θ measured positive in a counter-clockwise direction when the high pressure side of the airfoil section is below the airfoil section, and measured positive in a clockwise direction when the high pressure side of the airfoil section is above the airfoil section; wherein the P of the unducted fan propulsor is located within a first ellipse having a first major axis length (1MajAL) and a first minor axis length (1MinAL) with a first ellipse origin defined by EORL/D of 0.938 and θ of 253.6°, and where 1MajAL/D is 2.8 and 1MinAL/D is 1.7.

Clause 5: An aircraft is provided that includes a fuselage; an airfoil extending from the fuselage, the airfoil having an airfoil section and the airfoil section having an effective quarter chord point (QC), and a plurality of rotating blades defining a maximum outer diameter (D); a point (P) located at an intersection of the CL and a line perpendicular to the CL that passes through a midpoint between leading and trailing edges nearest the root of one of the plurality of blades, and an ellipse origin positioning line (EOR) having a length (EORL) extending from the QC to an ellipse origin (OR) and at an angle θ measured positive in a counter-clockwise direction when the high pressure side of the airfoil section is below the airfoil section, and measured positive in a clockwise direction when the high pressure side of the airfoil section is above the airfoil section, and wherein the P of the unducted fan propulsor is located within a first ellipse having a first major axis length (1MajAL) and a first minor axis length (1MinAL) with a first ellipse origin defined by EORL/D of 0.938 and θ of 253.6°, and where 1MajAL/D is 2.8 and 1 MinAL/D is 1.7.

Clause 6: An aircraft is provided that includes a fuselage; an airfoil extending from the fuselage, the airfoil having an airfoil section defining an effective quarter chord point (QC); an unducted fan propulsor mounted relative to the airfoil section on a high pressure side thereof, the unducted fan propulsor having a centerline (CL), a plurality of blades arranged in a forward array and a plurality of blades arranged in a rearward array, wherein only one of the forward and rearward array of blades are rotating blades and the rotating blades define a maximum outer diameter (D); a point (P) located at the intersection of the CL and a midpoint (TRL) between a rearward trailing edge nearest a root of a blade of the rearward array and a leading edge nearest a root of a blade of the forward array when the forward leading edge and rearward trailing edge of the respective blades are aligned with each other; and a positioning line (R) having a length (RL) and extending from the QC to the point P of the unducted fan propulsor at an angle θ measured positive in a counter-clockwise direction when the high pressure side of the airfoil section is below the airfoil section, and measured positive in a clockwise direction when the high pressure side of the airfoil section is above the airfoil section; wherein 0.065<RL/D<1.98 and θ is between 187° and 340°; and wherein RL/D and θ of the P of the unducted fan propulsor adhere to the following expressions:

$$\frac{RL}{D} \frac{( \begin{matrix}\sqrt{\begin{matrix}1.4161 * [ 1.88978 * {sin}^{2} ( θ ) - 0.0875 * {cos}^{2} ( θ ) + \\ 0.477 * sin ( θ ) * cos ( θ ) ]\end{matrix}} + \\ 1.764 * sin ( θ ) + 0.19146 * cos ( θ )\end{matrix} )}{1.96 * {sin}^{2} ( θ ) + 0.7225 * {cos}^{2} ( θ )} > 0 ,$$

$$and$$

$$\frac{RL}{D} \frac{( \begin{matrix}- \sqrt{\begin{matrix}1.4161 * [ 1.88978 * {sin}^{2} ( θ ) - 0.0875 * {cos}^{2} ( θ ) + \\ 0.477 * sin ( θ ) * cos ( θ ) ]\end{matrix}} + \\ 1.764 * sin ( θ ) + 0.19146 * cos ( θ )\end{matrix} )}{1.96 * {sin}^{2} ( θ ) + 0.7225 * {cos}^{2} ( θ )} < 0$$

The aircraft of Clause 6, wherein:
0.254<RL/D<1.86 and θ is between 199° and 306°, and
the P of the unducted fan propulsor is defined by the following expressions:

$$\frac{R L}{D} + \frac{( \begin{matrix}\sqrt{0.52 621 * [ 0.7205 * {sin}^{2} ( θ ) - 0.352 * {cos}^{2} ( θ ) + 0.7448 * sin ( θ ) * cos ( θ ) ]} + \\ 0.8476 * sin ( θ ) + 0.23119 * cos ( θ )\end{matrix} )}{0.8649 * {sin}^{2} ( θ ) + 0.6084 * {cos}^{2} ( θ )} > 0$$

$$and$$

$$\frac{R L}{D} + \frac{( \begin{matrix}- \sqrt{0.52 621 * [ 0.7205 * {sin}^{2} ( θ ) - 0.352 * {cos}^{2} ( θ ) + 0.7448 * sin ( θ ) * cos ( θ ) ]} + \\ 0.8476 * sin ( θ ) + 0.23119 * cos ( θ )\end{matrix} )}{0.8649 * {sin}^{2} ( θ ) + 0.6084 * {cos}^{2} ( θ )} < 0$$

The aircraft of Clause 6, wherein:
0.369<RL/D<1.43 and θ is between 204° and 291°, and
the P of the unducted fan propulsor is defined by the following expressions:

$$\frac{R L}{D} + \frac{( \begin{matrix}\sqrt{0.09923 * [ 0.2964 * {sin}^{2} ( θ ) - 0.36 * {cos}^{2} ( θ ) + 0.66 * sin ( θ ) * cos ( θ ) ]} + \\ 0.3675 * sin ( θ ) + 0.0891 * cos ( θ )\end{matrix} )}{0.49 * {sin}^{2} ( θ ) + 0.2025 * {cos}^{2} ( θ )} > 0$$

$$and$$

$$\frac{R L}{D} + \frac{( \begin{matrix}- \sqrt{0.09923 * [ 0.2964 * {sin}^{2} ( θ ) - 0.36 * {cos}^{2} ( θ ) + 0.66 * sin ( θ ) * cos ( θ ) ]} + \\ 0.3675 * sin ( θ ) + 0.0891 * cos ( θ )\end{matrix} )}{0.49 * {sin}^{2} ( θ ) + 0.2025 * {cos}^{2} ( θ )} < 0$$

The aircraft of Clause 6, wherein:
0.477<RL/D<0.9455 and θ is between 211° and 274°, and
the P of the unducted fan propulsor is defined by the following expressions:

$$\frac{R L}{D} + \frac{( \begin{matrix}\sqrt{0.01069156 * [ 0.036 * {sin}^{2} ( θ ) - 0.3485 * {cos}^{2} ( θ ) + 0.5418 * sin ( θ ) * cos ( θ ) ]} + \\ 0.139167 * sin ( θ ) + 0.020812 * cos ( θ )\end{matrix} )}{0.2209 * {sin}^{2} ( θ ) + 0.0484 * {cos}^{2} ( θ )} > 0$$

$$and$$

$$\frac{R L}{D} + \frac{( \begin{matrix}- \sqrt{0.01069156 * [ 0.036 * {sin}^{2} ( θ ) - 0.3485 * {cos}^{2} ( θ ) + 0.5418 * sin ( θ ) * cos ( θ ) ]} + \\ 0.139167 * sin ( θ ) + 0.020812 * cos ( θ )\end{matrix} )}{0.2209 * {sin}^{2} ( θ ) + 0.0484 * {cos}^{2} ( θ )} < 0$$

The aircraft of Clause 6, wherein the unducted fan propulsor is undermounted to the airfoil with one or more intermediate structures.

The aircraft of Clause 6, wherein the P of the unducted fan propulsor is variable to accommodate different operating conditions.

Clause 7: An aircraft is provided that includes a fuselage; an airfoil extending from the fuselage, the airfoil having an airfoil section defining an effective quarter chord point (QC); an unducted fan propulsor mounted relative to the airfoil section on a high pressure side thereof, the unducted fan propulsor having a centerline (CL), a plurality of blades arranged in a forward array and a plurality of blades arranged in a rearward array, wherein only one of the forward and rearward array of blades are rotating blades and the rotating blades define a maximum outer diameter (D); a point (P) located at the intersection of the CL and a midpoint (TRL) between a rearward trailing edge nearest a root of a blade of the rearward array and a leading edge nearest a root of a blade of the forward array when the forward leading edge and rearward trailing edge of the respective blades are aligned with each other; and a positioning line (R) having a length (RL) and extending from the QC to the point P of the unducted fan propulsor at an angle θ measured positive in a counter-clockwise direction when the high pressure side of the airfoil section is below the airfoil section, and measured positive in a clockwise direction when the high pressure side of the airfoil section is above the airfoil section; wherein RL/D≤2 and θ is between 187° and 342°.

The aircraft of Clause 7, wherein 0.15≤RL/D.

The aircraft of Clause 7, wherein 0.35≤RL/D, and preferably RL/D is about 0.72.

The aircraft of Clause 7, wherein 0 is between 198° and 310°, and preferably between 205° and 285°.

The aircraft of Clause 7, wherein the unducted fan propulsor operates at a cruise flight Mach M₀ of between 0.5 and 0.9, preferably between 0.7 and 0.9, and more preferably between 0.75 and 0.9.

The aircraft of Clause 7, wherein the unducted fan propulsor has a dimensionless cruise fan net thrust parameter expressed as follows:

$$0.15 > \frac{{F}_{net}}{{ρ}_{0} {A}_{a n} {V}_{0}^{2}} > 0.06 ,$$

wherein Fₙₑₜ is cruise fan net thrust, ρ₀ is ambient air density, Vₒ is cruise flight velocity, and Aₐₙ is annular cross-sectional area perpendicular to an axis of rotation of a rotor axis of rotation.

The aircraft of Clause 7, wherein the unducted fan propulsor is undermounted to the airfoil with one or more intermediate structures.

The aircraft of Clause 7, wherein the P of the unducted fan propulsor is variable to accommodate different operating conditions.

Clause 8: A method of assembly, comprising: using an aircraft body comprising a fuselage and an airfoil extending from the fuselage, wherein the airfoil has an airfoil section defining an effective quarter chord point (QC); and attaching an unducted fan propulsor to the aircraft body relative to the airfoil section on a high pressure side thereof; the unducted fan propulsor having a centerline (CL), a plurality of blades arranged in a forward array and a plurality of blades arranged in a rearward array, wherein only one of the forward and rearward array of blades are rotating blades and the rotating blades define a maximum outer diameter (D); a point (P) located at the intersection of the CL and a line HP perpendicular to the axial centerline CL that passes through the axial midpoint between a rearward trailing edge at a root of a blade of the rearward array and a forward leading edge at a root of a blade of the forward array when the forward leading edge and rearward trailing edge of the respective blades are aligned with each other; and a positioning line (R) having a length (RL) and extending from the QC to the point P of the unducted fan propulsor at an angle θ measured positive in a counter-clockwise direction when the high pressure side of the airfoil section is below the airfoil section, and measured positive in a clockwise direction when the high pressure side of the airfoil section is above the airfoil section, when viewed looking from an outboard position towards an inboard position; wherein 0.07≤RL/D≤2.0 and θ is between 187° and 342.°

The method of Clause 8, wherein 0.15≤RL/D.

The method of Clause 8, wherein 0.35≤RL/D, and preferably RL/D is about 0.72.

The method of Clause 8, wherein 0 is between 198° and 310°, and preferably between 205° and 285°.

The method of Clause 8, wherein the unducted fan propulsor operates at a cruise flight Mach M₀ of between 0.5 and 0.9, preferably between 0.7 and 0.9, and more preferably between 0.75 and 0.9.

The method of Clause 8, wherein the unducted fan propulsor has a dimensionless cruise fan net thrust parameter expressed as follows:

$$0.15 > \frac{{F}_{net}}{{ρ}_{0} {A}_{a n} {V}_{0}^{2}} > 0.06 ,$$

wherein Fₙₑₜ is cruise fan net thrust, ρ₀ is ambient air density, Vₒ is cruise flight velocity, and Aₐₙ is annular cross-sectional area perpendicular to an axis of rotation of a rotor axis of rotation.

The method of Clause 8, wherein the unducted fan propulsor is undermounted to the airfoil with one or more intermediate structures.

The method of Clause 8, wherein the P of the unducted fan propulsor is variable to accommodate different operating conditions.

Clause 9: A method of assembly, comprising: using an aircraft body comprising a fuselage and an airfoil extending from the fuselage, the airfoil having an airfoil section with a leading edge (LE) and a trailing edge (TE), a chord extending between the LE and TE, and an effective quarter chord point (QC) along the chord measured from the LE, wherein the airfoil has an airfoil section defining an effective quarter chord point (QC); and attaching an unducted fan propulsor to the aircraft body relative to the airfoil section on a high pressure side thereof; the unducted fan propulsor having a centerline (CL) and a plurality of blades arranged in one or more arrays, each of the blades having a root and the plurality of blades defining a maximum outer diameter (D), the unducted fan propulsor having a point (P) defined as one of: (a) wherein the plurality of blades is arranged in a single array, the point P is located at an intersection of the CL and a line perpendicular to the CL that passes through a midpoint between edges at the root of one of the plurality of blades, and (b) wherein the plurality of blades is arranged in a forward array and a rearward array, the point P is located at an intersection of the CL and midpoint between a rearward trailing edge (TE) of the rearward array and leading edge (LE) of the forward array when a blade of the forward and rearward arrays are aligned with each other; and an ellipse origin positioning line (EOR) having a length (EORL) extending from the QC to an ellipse origin (OR) and at an angle θ as measured from a vector from the QC to the TE of the airfoil section to the line EOR, where, when viewed with the LE to the left of TE, a positive θ (1) increases in a counter-clockwise direction when the high pressure side of the airfoil section is below the airfoil section, and (2) increases in a clockwise direction when the high pressure side of the airfoil section is above the airfoil section, and wherein the P of the unducted fan propulsor is located within a first ellipse having a first major axis length (1MajAL) and a first minor axis length (1MinAL) with a first ellipse origin defined by EORL/D of 0.938 and θ of 253.6°, and where 1MajAL/D is 2.8 and 1 MinAL/D is 1.7.

The method of Clause 9, wherein the P of the unducted fan propulsor is located in a second ellipse having a second major axis length (2MajAL) and a second minor axis length (2MinAL) with a second ellipse origin defined by EORL/D of 1.051 and θ of 248.8°, and where 2MajAL/D is 1.86 and 2MinAL/D is 1.56.

The method of Clause 9, wherein the P of the unducted fan propulsor is located in a third ellipse having a third major axis length (3MajAL) and a third minor axis length (3MinAL) with a third ellipse origin defined by EORL/D of 0.870 and θ of 239.6°, where 3MajAL/D is 1.4 and 3MinAL/D is 0.9.

The method of Clause 9, wherein the P of the unducted fan propulsor is located in a fourth ellipse having a fourth major axis length (4MajAL) and a fourth minor axis length (4MinAL) with a fourth ellipse origin defined by EORL/D of 0.763 and θ of 235.7°, and where 4MajAL/D is 0.94 and 4MinAL/D is 0.44.

Clause 10: An aircraft comprising:
a fuselage;
a pair of wings extending from the fuselage,
two or more unducted fan propulsors, each of the unducted fan propulsors is mounted relative to one of the wings on a high pressure side thereof, the unducted fan propulsor having a centerline (CL), a plurality of blades arranged in a forward array and a plurality of blades arranged in a rearward array, wherein only one of the forward and rearward array of blades are rotating blades and the rotating blades define a maximum outer diameter (D);
a point (P) located at an intersection of the CL and a line HP perpendicular to the CL that passes through an axial midpoint between a rearward trailing edge at a root of a blade of the rearward array and a forward leading edge at a root of a blade of the forward array when the forward leading edge and rearward trailing edge of the respective blades are aligned with each other; and
an airfoil section having an effective quarter chord point QC;
a positioning line (R) having a length (RL) and extending from the QC to the point P of the unducted fan propulsor at an angle θ measured positive in a counter-clockwise direction when the high pressure side of the airfoil section is below the airfoil section when viewed looking from an outboard position towards an inboard position of the wing; wherein 0.07≤RL/D≤2.0 and θ is between 187° and 342°.

Clause 11: An aircraft comprising:
a fuselage;
a pair of horizontal stabilizers extending relative to the fuselage, two or more unducted fan propulsors, each of the unducted fan propulsors is mounted relative to one of the horizontal stabilizers on a high pressure side thereof, the unducted fan propulsor having a centerline (CL), a plurality of blades arranged in a forward array and a plurality of blades arranged in a rearward array, wherein only one of the forward and rearward array of blades are rotating blades and the rotating blades define a maximum outer diameter (D);
a point (P) located at an intersection of the CL and a line HP perpendicular to the CL that passes through an axial midpoint between a rearward trailing edge at a root of a blade of the rearward array and a forward leading edge at a root of a blade of the forward array when the forward leading edge and rearward trailing edge of the respective blades are aligned with each other; and
an airfoil section having an effective quarter chord point QC;
a positioning line (R) having a length (RL) and extending from the QC to the point P of the unducted fan propulsor at an angle θ measured positive in a clockwise direction when the high pressure side of the airfoil section is above the airfoil section when viewed looking from an outboard position towards an inboard position of the wing; wherein 0.07≤RL/D≤2.0 and 0 is between 187° and 342°.

In any of the preceding clauses, the unducted fan propulsor is undermounted to the airfoil, such as a wing, with one or more intermediate structures.

In any of the preceding clauses, the P of the unducted fan propulsor is variable to accommodate different operating conditions.

In any of the preceding clauses the drive mechanism may be a gas turbine engine and associated transmission to delivers torque from the drive mechanism to the propeller assembly.

In any of the preceding clauses, the unducted fan propulsor is incorporated into an airplane or other aircraft having a cruise flight Mach M₀ of between 0.70 and 0.85, between 0.75 and 0.85, between 0.75 and 0.79, between 0.5 and 0.9, between 0.7 and 0.9, or between 0.75 and 0.9.

In any of the preceding clauses, the unducted fan propulsors is connected to the wing (or horizontal stabilizer) through a pylon.

In any of the preceding clauses, the rotating blades diameter (D) may be between 8 to 16 feet or 12 to 16 feet.

In any of the preceding clauses, each of the propulsors including a drive mechanism comprising a gas turbine engine assembly comprising in serial order a compressor, combustor, high pressure turbine and power turbine.

In any of the preceding clauses, the propulsor having a pitch angle between −5 and +5 degrees, or −3 and 0 degrees.

In any of the preceding clauses, the propulsor having an inward toe angle of between 0 and 5 degrees, or 1 and 3 degrees.

In any of the preceding clauses, the rotating blades diameter is between 8 to 16 feet or between 12 to 16 feet.

In any of the preceding clauses, the aircraft having a wing defining the airfoil and one or two unducted fan propulsors are mounted to the wing.

In any of the preceding clauses, wherein the aircraft are aircraft types A, B, C or G as defined in Tables 1 and 2.

A gas turbine engine defining a circumferential direction, the gas turbine engine comprising: a turbomachine; an unducted rotor assembly drivingly coupled to the turbomachine, the unducted rotor assembly including a plurality of unducted rotor blades; and a plurality of outlet guide vanes positioned downstream of the plurality of unducted rotor blades, the plurality of outlet guide vanes each defining a span, wherein the spans of the plurality of outlet guide vanes are nonuniform.

The gas turbine engine of any preceding clause, wherein the unducted rotor assembly defines a circumferential position, θ₀, of the highest loaded rotor blade at a first gas turbine engine operating condition, wherein a rotor blade of the unducted rotor assembly further defines a tip radius, R_{TIP}, wherein the gas turbine engine defines an axial spacing, S, between the plurality of unducted rotor blades and the plurality of outlet guide vanes and an advance ratio, J, and wherein the gas turbine engine defines a circumferential swirl offset, θ_{SWIRL_OFF}, equal to

$$2 \times {tan}^{- 1} ( \frac{π \times S}{J \times {R}_{TIP}} ) ;$$

and wherein the plurality of outlet guide vanes includes a first outlet guide vane with a first span not greater than the spans of the other outlet guide vanes, the first outlet guide vane located at a circumferential position between θ₀ and θ_{SWIRL_OFF}.

The gas turbine engine of any preceding clause, wherein θ_{SWIRL_OFF} is defined in a direction of rotation of the unducted rotor assembly.

The gas turbine engine of any preceding clause, wherein the plurality of outlet guide vanes includes a second outlet guide vane with a second span not shorter than the spans of the other outlet guide vanes, wherein the second outlet guide vane is located at a circumferential position between 150 degrees and 210 degrees offset from the first outlet guide vane.

The gas turbine engine of any preceding clause, wherein the gas turbine engine is configured to be mounted to an aircraft through a pylon at a pylon attachment location, wherein the circumferential position, θ₀, of the highest loaded rotor blade is aligned circumferentially with the pylon attachment location, wherein the plurality of outlet guide vanes includes a first outlet guide vane with a first span not greater than the spans of the other outlet guide vanes, the first outlet guide vane aligned with the pylon attachment location or positioned within θ_{SWIRL_OFF} of the pylon attachment location in a direction of rotor rotation.

The gas turbine engine of any preceding clause, wherein the gas turbine engine is configured to be mounted to a wing of an aircraft at a location where at least a portion the wing is positioned inward along a radial direction from tips of the unducted rotor blades, wherein the plurality of outlet guide vanes includes a first outlet guide vane with a first span not greater than the spans of the other outlet guide vanes, the first outlet guide vane aligned with the wing or positioned within θ_{SWIRL_OFF} of the wing in a direction of rotor rotation.

The gas turbine engine of any preceding clause, wherein the unducted rotor assembly defines a circumferential position, θ₁, of highest inward deflection of a streamtube at a gas turbine engine operating condition, wherein the plurality of outlet guide vanes includes a first outlet guide vane with a first span not greater than the spans of the other outlet guide vanes, the first outlet guide vane located within 30 degrees of θ₁.

The gas turbine engine of any preceding clause, wherein the gas turbine engine operating condition is a high angle of attack operating condition, and wherein θ₁ corresponds to a bottom dead center location.

The gas turbine engine of any preceding clause, wherein the plurality of outlet guide vanes includes a first outlet guide vane with a first span not greater than the spans of the other outlet guide vanes, a second outlet guide vane with a second span not shorter than the spans of the other outlet guide vanes, and a plurality of intermediate outlet guide vanes positioned between the first and second outlet guide vanes, wherein the spans of the intermediate outlet guide vanes are each greater than the first span and less than the second span.

The gas turbine engine of any preceding clause, wherein the spans of the plurality of intermediate outlet guide vanes increases from the first span to the second span according to a function, and wherein the function is one of a sinusoidally-varying function or a linear function.

The gas turbine engine of any preceding clause, wherein the plurality of outlet guide vanes includes N_{OGV} number of outlet guide vanes, the plurality of outlet guide vanes including a pair of outlet guide vanes defining a gap spacing greater than 360 degrees divided by N_{OGV}.

The gas turbine engine of any preceding clause, wherein the turbomachine defines a pylon attachment location along the circumferential direction, and wherein the pylon attachment location positioned outside of between the pair of outlet guide vanes.

The gas turbine engine of any preceding clause, wherein the plurality of unducted rotor blades includes N_{B} number of unducted rotor blades, wherein N_{B} is greater than N_{OGV}.

The gas turbine engine of any preceding clause, wherein the plurality of outlet guide vanes includes a first cluster of outlet guide vanes defining a first cluster spacing less than 360/N_{OGV} and greater than or equal to 360/(N_{B}+2).

The gas turbine engine of any preceding clause, wherein the plurality of outlet guide vanes includes at least one fixed-pitch outlet guide vane.

The gas turbine engine of any preceding clause, wherein the gas turbine engine defines an acoustically sensitive location along the circumferential direction, θ_{A}, wherein the plurality of outlet guide vanes includes a first outlet guide vane with a first span not greater than the spans of the other outlet guide vanes, the first outlet guide vane located at a circumferential position of θ_{A} plus θ_{S} or θ_{A} minus θ_{S}, where θ_{S} is between 60 degrees and 120 degrees.

The gas turbine engine of any preceding clause, wherein the plurality of outlet guide vanes comprises a plurality of consecutive outlet guide vanes forming a short vane subset, wherein an average span of the outlet guide vanes forming the short vane subset is less than a median span of all of the plurality of outlet guide vanes.

An outlet guide vane assembly for a gas turbine engine, the gas turbine engine defining a circumferential direction and including a turbomachine and an unducted rotor assembly drivingly coupled to the turbomachine, the outlet guide vane assembly comprising: a plurality of outlet guide vanes configured to be positioned downstream of a plurality of unducted rotor blades of the unducted rotor assembly when installed in the gas turbine engine, the plurality of outlet guide vanes each defining a span, the spans of the plurality of outlet guide vanes being nonuniform along the circumferential direction.

The outlet guide vane assembly of any preceding clause, wherein the unducted rotor assembly defines a circumferential position, θ₀, of the highest loaded rotor blade at a first gas turbine engine operating condition and a tip radius, R_{TIP}, wherein the gas turbine engine defines an axial spacing, S, between the plurality of unducted rotor blades and the plurality of outlet guide vanes and an advance ratio, J, and wherein the gas turbine engine defines a circumferential swirl offset, θ_{SWIRL_OFF}, equal to

$$2 \times {tan}^{- 1} ( \frac{π \times S}{J \times {R}_{TIP}} ) ;$$

and wherein the plurality of outlet guide vanes includes a first outlet guide vane with a first span not greater than the spans of the other outlet guide vanes, the first outlet guide vane located at a circumferential position between θ₀ and θ_{SWIRL_OFF}, wherein θ_{SWIRL_OFF} is defined in a direction of rotation of the unducted rotor assembly.

The outlet guide vane assembly of any preceding clause, wherein the unducted rotor assembly defines a circumferential position, θ₁, of highest inward deflection of a streamtube at a gas turbine engine operating condition, wherein the plurality of outlet guide vanes includes a first outlet guide vane with a first span not greater than the spans of the other outlet guide vanes, the first outlet guide vane located within 30 degrees of θ₁.

A gas turbine engine defining a circumferential direction, the gas turbine engine comprising: a turbomachine, the turbomachine defining a pylon attachment location along the circumferential direction; an unducted rotor assembly drivingly coupled to the turbomachine, the unducted rotor assembly including a plurality of unducted rotor blades; and an N_{OGV} plurality of outlet guide vanes positioned downstream of the plurality of unducted rotor blades including a first outlet guide vane and a second outlet guide vane adjacent the first outlet guide vane, a circumferential gap extending from the first outlet guide vane to the second outlet guide vane wherein the circumferential gap is greater than 360 degrees divided by N_{OGV}, and the pylon attachment location is located outside of the circumferential gap.

The gas turbine engine of any preceding clause, wherein the gas turbine engine defines an acoustically sensitive location along the circumferential direction, wherein the acoustically sensitive location is positioned between the first and second outlet guide vanes, and wherein the acoustically sensitive location is positioned between a three o'clock position and a nine o'clock position.

The gas turbine engine of any preceding clause, wherein the gas turbine engine defines an acoustically sensitive location along the circumferential direction, wherein the acoustically sensitive location is positioned between the first and second outlet guide vanes, and wherein the acoustically sensitive location is positioned between a five o'clock position and a seven o'clock position.

The gas turbine engine of any preceding clause, wherein the gas turbine engine defines an acoustically sensitive location along the circumferential direction, wherein the acoustically sensitive location is positioned between the first and second outlet guide vanes, and wherein the acoustically sensitive location is positioned between a three o'clock position and a five o'clock position or between a seven o'clock position and a nine o'clock position.

The gas turbine engine of any preceding clause, wherein the plurality of unducted rotor blades includes N_{B} number of unducted rotor blades, wherein N_{B} is greater than N_{OGV}.

The gas turbine engine of any preceding clause, wherein the plurality of outlet guide vanes includes a first cluster of outlet guide vanes defining a first cluster spacing less than 360/N_{OGV} and greater than or equal to 360/(N_{B}+2).

The gas turbine engine of any preceding clause, wherein the first cluster includes the first outlet guide vane.

The gas turbine engine of any preceding clause, wherein the plurality of outlet guide vanes includes a second cluster of outlet guide vanes defining a second cluster spacing less than 360/N_{OGV} and greater than or equal to 360/(N_{B}+2), and wherein the second cluster includes the second outlet guide vane.

The gas turbine engine of any preceding clause, wherein the gap spacing is at least 25% greater than the first cluster spacing and up to 200% of the first cluster spacing.

The gas turbine engine of any preceding clause, wherein the plurality of outlet guide vanes includes a third outlet guide vane and a fourth outlet guide vane positioned opposite the first and second outlet guide vanes, and wherein a spacing between the third and fourth outlet guide vanes is equal to the gap spacing.

The gas turbine engine of any preceding clause, wherein the pylon attachment location is positioned at a 12 o'clock position.

The gas turbine engine of any preceding clause, wherein the plurality of outlet guide vanes are unshrouded outlet guide vanes.

A gas turbine engine defining an axial direction, the gas turbine engine comprising: a turbomachine, the turbomachine defining a pylon attachment location along the axial direction; an unducted rotor assembly drivingly coupled to the turbomachine, the unducted rotor assembly including a plurality of unducted rotor blades, the plurality of unducted rotor blades including N_{B} number of unducted rotor blades; and a plurality of outlet guide vanes positioned downstream of the plurality of unducted rotor blades, the plurality of outlet guide vanes including N_{OGV} number of outlet guide vanes which is less than N_{B}, the plurality of outlet guide vanes including a first pair of outlet guide vanes defining a spacing less than 360/N_{OGV} and greater than or equal to 360/(N_{B}+2), wherein the pylon attachment location is aft of the plurality of outlet guide vanes.

The gas turbine engine of any preceding clause, wherein the spacing is greater than or equal to 360/(N_{B}+1).

The gas turbine engine of any preceding clause, wherein the spacing is greater than or equal to 360/N_{B}.

An aircraft comprising: a fuselage; a first wing extending from a first side of the fuselage and a second wing extending from a second side of the fuselage; and a propulsion system comprising: a first gas turbine engine mounted to the first wing or the fuselage on the first side of the fuselage, the first gas turbine engine defining a first circumferential direction and comprising a first unducted rotor assembly and a first plurality of outlet guide vanes positioned downstream of the first unducted rotor assembly, a first gap spacing defined by the first plurality of outlet guide vanes and extending along the first circumferential direction, wherein the first gap spacing location is between a 2 o'clock position and a 7 o'clock position, the first gap spacing being greater than an average gap spacing of the first plurality of outlet guide vanes; and a second gas turbine engine mounted to the second wing or the fuselage on the second side of the fuselage, the second gas turbine engine defining a second circumferential direction and comprising a second unducted rotor assembly and a second plurality of outlet guide vanes positioned downstream of the second unducted rotor assembly, a second gap spacing defined by the second plurality of outlet guide vanes and extending along the first circumferential direction, wherein the second gap spacing location is between a five o'clock position and a 10 o'clock position, the second gap spacing being greater than an average gap spacing of the second plurality of outlet guide vanes.

The aircraft of any preceding clause, wherein the first gap location is between a three o'clock position and a six o'clock position, and wherein the second gap location is between a six o'clock position and a nine o'clock position.

The aircraft of any preceding clause, wherein the first side of the fuselage is a port side of the fuselage, and wherein the second side of the fuselage is a starboard side of the fuselage.

The aircraft of any preceding clause, wherein the first gas turbine engine defines a first acoustically sensitive location along the first circumferential direction positioned at the first gap location, and wherein the second gas turbine engine defines a second acoustically sensitive location along the first circumferential direction positioned at the second gap location.

The aircraft of any preceding clause, wherein the first plurality of outlet guide vanes includes N_{OGV1} number of outlet guide vanes, wherein the first plurality of outlet guide vanes further includes a first outlet guide vane and a second outlet guide vane adjacent the first outlet guide vane defining the first gap spacing therebetween, wherein the second plurality of outlet guide vanes includes N_{OGV2} number of outlet guide vanes, wherein the second plurality of outlet guide vanes further includes a first outlet guide vane and a second outlet guide vane adjacent the first outlet guide vane defining the second gap spacing therebetween.

An aircraft comprising: a fuselage; a pair of wings extending from the fuselage, two or more unducted fan propulsors, each of the unducted fan propulsors is mounted relative to one of the wings on a high pressure side thereof, the unducted fan propulsor having a centerline (CL), a plurality of blades arranged in a forward array and a plurality of blades arranged in a rearward array, wherein only one of the forward and rearward array of blades are rotating blades and the rotating blades that define a maximum outer diameter (D); a point (P) located at an intersection of the CL and a line HP perpendicular to the CL that passes through an axial midpoint between a rearward trailing edge at a root of a blade of the rearward array and a forward leading edge at a root of a blade of the forward array when the forward leading edge and rearward trailing edge of the respective blades are aligned with each other; and an airfoil section having an effective quarter chord point QC; a positioning line (R) having a length (RL) and extending from the QC to the point P of the unducted fan propulsor at an angle θ measured positive in a counter-clockwise direction when the high pressure side of the airfoil section is below the airfoil section when viewed looking from an outboard position towards an inboard position of the wing; wherein 0.07≤RL/D≤2.0 and θ is between 187° and 342°, wherein the rearward array of blades is a plurality of outlet guide vanes positioned downstream of the rotating blades, the plurality of outlet guide vanes each defining a span, wherein the spans of the plurality of outlet guide vanes are nonuniform.

The aircraft of any of the preceding clauses, wherein the rotating blades defines a circumferential position, θ₀, of a highest loaded rotor blade at a first unducted fan propulsor operating condition, wherein a rotor blade of the rotating blades further defines a tip radius, R_{TIP}, wherein the unducted fan propulsor defines an axial spacing, S, between the rotating blades and the plurality of outlet guide vanes and an advance ratio, J, and wherein the unducted fan propulsor defines a circumferential swirl offset, θ_{SWIRL_OFF}, equal to

$$2 \times {tan}^{- 1} ( \frac{π \times S}{J \times {R}_{TIP}} ) ;$$

and wherein the plurality of outlet guide vanes includes a first outlet guide vane with a first span not greater than the spans of the other outlet guide vanes, the first outlet guide vane located at a circumferential position between θ₀ and θ_{SWIRL_OFF}.

The aircraft of any of the preceding clauses, wherein θ_{SWIRL_OFF} is defined in a direction of rotation of the unducted rotor assembly.

The aircraft of any of the preceding clauses, wherein the plurality of outlet guide vanes includes a second outlet guide vane with a second span not shorter than the spans of the other outlet guide vanes, wherein the second outlet guide vane is located at a circumferential position between 150 degrees and 210 degrees offset from the first outlet guide vane.

The aircraft of any of the preceding clauses, wherein the unducted fan propulsor is mounted to the aircraft through a pylon at a pylon attachment location, wherein the circumferential position, θ0, of the highest loaded rotor blade is aligned circumferentially with the pylon attachment location, wherein the plurality of outlet guide vanes includes a first outlet guide vane with a first span not greater than the spans of the other outlet guide vanes, the first outlet guide vane aligned with the pylon attachment location or positioned within θ_{SWIRL_OFF} of the pylon attachment location in a direction of rotor rotation.

The aircraft of any of the preceding clauses, wherein the plurality of outlet guide vanes includes a second outlet guide vane with a second span not shorter than the spans of the other outlet guide vanes, wherein the second outlet guide vane is located at a circumferential position between 150 degrees and 210 degrees offset from the first outlet guide vane.

The aircraft of any of the preceding clauses, wherein the rotating blades defines a circumferential position, θ₀, of a highest loaded rotor blade at a first unducted fan propulsor operating condition, wherein a rotor blade of the rotating blades further defines a tip radius, R_{TIP}, wherein the unducted fan propulsor defines an axial spacing, S, between the rotating blades and the plurality of outlet guide vanes and an effective advance ratio, Je, and wherein the unducted fan propulsor defines a circumferential swirl offset, θ_{SWIRL_OFF}, equal to

$$2 \times {tan}^{- 1} ( \frac{π \times S}{{J}_{{e}^{\times R} TIP}} ) ;$$

and wherein the plurality of outlet guide vanes includes a first outlet guide vane with a first span not greater than the spans of the other outlet guide vanes, the first outlet guide vane located at a circumferential position between θ₀ and θ_{SWIRL_OFF}.

The aircraft of any of the preceding clauses, wherein the plurality of outlet guide vanes includes a first outlet guide vane with a first span not greater than the spans of the other outlet guide vanes, a second outlet guide vane with a second span not shorter than the spans of the other outlet guide vanes, and a plurality of intermediate outlet guide vanes positioned between the first and second outlet guide vanes, wherein the spans of the intermediate outlet guide vanes are each greater than the first span and less than the second span.

The aircraft of any of the preceding clauses, wherein 0.15≤RL/D.

The aircraft of any of the preceding clauses, wherein 0.35≤RL/D, and preferably RL/D is about 0.72.

The aircraft of any of the preceding clauses, wherein 0 is between 198° and 310°, and preferably between 205° and 285°.

The aircraft of any of the preceding clauses, wherein the two or more unducted fan propulsors are configured to operate at a cruise flight Mach M₀ of between 0.7 and 0.9, and more preferably between 0.75 and 0.9; or the two or more unducted fan propulsors are configured to propel the aircraft at a cruise flight Mach M₀ of between 0.7 and 0.9, and more preferably between 0.75 and 0.85.
The aircraft of any of the preceding clauses, wherein the unducted fan propulsor has a dimensionless cruise fan net thrust parameter expressed as follows:

$$0.15 > \frac{{F}_{net}}{{ρ}_{0} {A}_{a n} {V}_{0}^{2}} > 0.06 ,$$

wherein Fₙₑₜ is cruise fan net thrust, ρ₀ is ambient air density, Vₒ is cruise flight velocity, and Aₐₙ is annular cross-sectional area perpendicular to an axis of rotation of a rotor axis of rotation.

The aircraft of any of the preceding clauses, wherein the unducted fan propulsor is undermounted to the airfoil with one or more intermediate structures.

The aircraft of any of the preceding clauses, wherein the P of the unducted fan propulsor is variable to accommodate different operating conditions.

An aircraft, comprising: a fuselage; an airfoil extending from the fuselage, the airfoil having an airfoil section defining an effective quarter chord point (QC); an unducted fan propulsor mounted relative to the airfoil section on a high pressure side thereof, the unducted fan propulsor having a centerline (CL), a plurality of blades arranged in a forward array and a plurality of blades arranged in a rearward array, wherein only one of the forward and rearward array of blades are rotating blades and the rotating blades define a maximum outer diameter (D); a point (P) located at an intersection of the CL and a line HP perpendicular to the CL that passes through an axial midpoint between a rearward trailing edge at a root of a blade of the rearward array and a forward leading edge at a root of a blade of the forward array when the forward leading edge and rearward trailing edge of the respective blades are aligned with each other; and an ellipse origin positioning line (EOR) having a length (EORL) extending from the QC to an ellipse origin (OR) at an angle θ measured positive in a counter-clockwise direction when the high pressure side of the airfoil section is below the airfoil section, and measured positive in a clockwise direction when the high pressure side of the airfoil section is above the airfoil section, when viewed looking for an outboard position towards an inboard position; wherein the P of the unducted fan propulsor is located within a first ellipse having a first major axis length (1MajAL) and a first minor axis length (1MinAL) with a first ellipse origin defined by EORL/D of 0.938 and θ of 253.6°, and where 1MajAL/D is 2.8 and 1MinAL/D is 1.7, wherein the rearward array of blades is a plurality of outlet guide vanes positioned downstream of the rotating blades, the plurality of outlet guide vanes each defining a span, wherein the spans of the plurality of outlet guide vanes are nonuniform.

The aircraft of any of the preceding clauses, wherein the P of the unducted fan propulsor is located in a second ellipse having a second major axis length (2MajAL) and a second minor axis length (2MinAL) with a second ellipse origin defined by EORL/D of 1.051 and θ of 248.8°, and where 2MajAL/D is 1.86 and 2MinAL/D is 1.56.

The aircraft of any of the preceding clauses, wherein the P of the unducted fan propulsor is located in a third ellipse having a third major axis length (3MajAL) and a third minor axis length (3MinAL) with a third ellipse origin defined by EORL/D of 0.870 and θ of 239.6°, where 3MajAL/D is 1.4 and 3MinAL/D is 0.9.

The aircraft of any of the preceding clauses, wherein the P of the unducted fan propulsor is located in a fourth ellipse having a fourth major axis length (4MajAL) and a fourth minor axis length (4MinAL) with a fourth ellipse origin defined by EORL/D of 0.763 and θ of 235.7°, and where 4MajAL/D is 0.94 and 4MinAL/D is 0.44.

An aircraft, comprising: a fuselage; an airfoil extending from the fuselage, the airfoil having an airfoil section defining an effective quarter-chord point (QC); an unducted fan propulsor mounted relative to the airfoil section on a high pressure side thereof, the unducted fan propulsor having a centerline (CL), a plurality of blades arranged in a forward array and a plurality of blades arranged in a rearward array, wherein one of the forward and rearward array of blades are rotating blades and the rotating blades define a maximum outer diameter (D); a point (P) located at an intersection of the CL and a line HP perpendicular to the CL that passes through an axial midpoint between a rearward trailing edge at a root of a blade of the rearward array and a forward leading edge at a root of a blade of the forward array when the forward leading edge and rearward trailing edge of the respective blades are aligned with each other; and a positioning line (R) having a length (RL) and extending from the QC to the point P of the unducted fan propulsor at an angle θ measured positive in a counter-clockwise direction when the high pressure side of the airfoil section is below the airfoil section, and measured positive in a clockwise direction when the high pressure side of the airfoil section is above the airfoil section, when viewed looking from an outboard position towards an inboard position (e.g. the fuselage) OR when viewed with the LE to the left of the TE; wherein 0.065<RL/D<1.98 and θ is between 187° and 340°; and wherein RL/D and θ of the P of the unducted fan propulsor adhere to the following expressions:

$$\frac{R L}{D} + \frac{( \begin{matrix}\sqrt{1.4161 * [ 1.88978 * {sin}^{2} ( θ ) - 0.0875 * {cos}^{2} ( θ ) + 0.477 * sin ( θ ) * cos ( θ ) ]} + \\ 1.764 * sin ( θ ) + 0.19146 * cos ( θ )\end{matrix} )}{1.96 * {sin}^{2} ( θ ) + 0.7225 * {cos}^{2} ( θ )} > 0$$

$$and$$

$$\frac{R L}{D} + \frac{( \begin{matrix}- \sqrt{1.4161 * [ 1.88978 * {sin}^{2} ( θ ) - 0.0875 * {cos}^{2} ( θ ) + 0.477 * sin ( θ ) * cos ( θ ) ]} + \\ 1.764 * sin ( θ ) + 0.19146 * cos ( θ )\end{matrix} )}{1.96 * {sin}^{2} ( θ ) + 0.7225 * {cos}^{2} ( θ )} < 0$$

wherein the rearward array of blades is a plurality of outlet guide vanes positioned downstream of the rotating blades, the plurality of outlet guide vanes each defining a span, wherein the spans of the plurality of outlet guide vanes are nonuniform.

An aircraft comprising: a fuselage; a pair of wings extending from the fuselage, two or more unducted fan propulsors, each of the unducted fan propulsors is mounted relative to one of the wings on a high pressure side thereof, the unducted fan propulsor having a centerline (CL), a turbomachine defining a pylon attachment location along a circumferential direction, and a plurality of blades arranged in a forward array and a plurality of blades arranged in a rearward array, wherein the forward array of blades are rotating blades that define a maximum outer diameter (D); a point (P) located at an intersection of the CL and a line HP perpendicular to the CL that passes through an axial midpoint between a rearward trailing edge at a root of a blade of the rearward array and a forward leading edge at a root of a blade of the forward array when the forward leading edge and rearward trailing edge of the respective blades are aligned with each other; and an airfoil section having an effective quarter chord point QC; a positioning line (R) having a length (RL) and extending from the QC to the point P of the unducted fan propulsor at an angle θ measured positive in a counter-clockwise direction when the high pressure side of the airfoil section is below the airfoil section when viewed looking from an outboard position towards an inboard position of the wing; wherein 0.07≤RL/D≤2.0 and θ is between 187° and 342°, wherein the rearward array of blades is an N_{OGV} plurality of outlet guide vanes positioned downstream of the rotating blades and including a first outlet guide vane and a second outlet guide vane adjacent the first outlet guide vane, a circumferential gap extending from the first outlet guide vane to the second outlet guide vane, wherein the circumferential gap is greater than 360 degrees divided by N_{OGV}, and the pylon attachment location is located outside of the circumferential gap.

The aircraft of any of the preceding clauses, wherein the plurality of unducted rotor blades includes N_{B} number of unducted rotor blades, wherein N_{B} is greater than N_{OGV}; and wherein the plurality of outlet guide vanes includes a cluster of outlet guide vanes defining a cluster spacing less than 360/N_{OGV} and greater than or equal to 360/(N_{B}+2).

An aircraft comprising: a fuselage; a pair of wings extending from the fuselage, two or more unducted fan propulsors, each of the unducted fan propulsors is mounted relative to one of the wings on a high pressure side thereof, the unducted fan propulsor having a centerline (CL), a turbomachine defining a pylon attachment location along a circumferential direction, and a plurality of blades arranged in a forward array and a plurality of blades arranged in a rearward array, wherein the forward array of blades are rotating blades that define a maximum outer diameter (D); a point (P) located at an intersection of the CL and a line HP perpendicular to the CL that passes through an axial midpoint between a rearward trailing edge at a root of a blade of the rearward array and a forward leading edge at a root of a blade of the forward array when the forward leading edge and rearward trailing edge of the respective blades are aligned with each other; and an airfoil section having an effective quarter chord point QC; a positioning line (R) having a length (RL) and extending from the QC to the point P of the unducted fan propulsor at an angle θ measured positive in a counter-clockwise direction when the high pressure side of the airfoil section is below the airfoil section when viewed looking from an outboard position towards an inboard position of the wing; wherein 0.07≤RL/D≤2.0 and θ is between 187° and 342°, wherein the rearward array of blades is an N_{OGV} plurality of outlet guide vanes positioned downstream of the rotating blades, the plurality of outlet guide vanes including a first pair of outlet guide vanes defining a spacing less than 360/N_{OGV} and greater than or equal to 360/(N_{B}+2), wherein the pylon attachment location is aft of the plurality of outlet guide vanes.

The aircraft of any of the preceding clauses, wherein a ratio of the effective velocity (Ve) to the free stream velocity (Vinf) is between 0.95 and 0.995.

1. An aircraft comprising:
a fuselage;
a pair of wings extending from the fuselage,
two or more unducted fan propulsors, each of the unducted fan propulsors is mounted relative to one of the wings on a high pressure side thereof, the unducted fan propulsor having a centerline (CL), a plurality of blades arranged in a forward array and a plurality of blades arranged in a rearward array, wherein the forward array of blades are rotating blades that define a maximum outer diameter (D);
a point (P) located at an intersection of the CL and a line HP perpendicular to the CL that passes through an axial midpoint between a rearward trailing edge at a root of a blade of the rearward array and a forward leading edge at a root of a blade of the forward array when the forward leading edge and rearward trailing edge of the respective blades are aligned with each other; and
an airfoil section having an effective quarter chord point QC;
a positioning line (R) having a length (RL) and extending from the QC to the point P of the unducted fan propulsor at an angle θ measured positive in a counter-clockwise direction when the high pressure side of the airfoil section is below the airfoil section when viewed looking from an outboard position towards an inboard position of the wing; wherein 0.07≤RL/D≤2.0 and θ is between 187° and 342°,
wherein the rearward array of blades is a plurality of outlet guide vanes positioned downstream of the rotating blades, the plurality of outlet guide vanes each defining a span, wherein the spans of the plurality of outlet guide vanes are nonuniform.

2. The aircraft of claim 1, wherein the rotating blades defines a circumferential position, θ₀, of a highest loaded rotor blade at a first unducted fan propulsor operating condition, wherein a rotor blade of the rotating blades further defines a tip radius, R_{TIP}, wherein the unducted fan propulsor defines an axial spacing, S, between the rotating blades and the plurality of outlet guide vanes and an advance ratio, J, and wherein the unducted fan propulsor defines a circumferential swirl offset, θ_{SWIRL_OFF}, equal to
$$2 \times {tan}^{- 1} ( \frac{π \times S}{J \times {R}_{TIP}} ) ;$$
and wherein the plurality of outlet guide vanes includes a first outlet guide vane with a first span not greater than the spans of the other outlet guide vanes, the first outlet guide vane located at a circumferential position between θ₀ and θ_{SWIRL_OFF}.

3. The aircraft of claim 1, wherein θ_{SWIRL_OFF} is defined in a direction of rotation of the unducted rotor assembly.

4. The aircraft of claim 1, wherein the plurality of outlet guide vanes includes a second outlet guide vane with a second span not shorter than the spans of the other outlet guide vanes, wherein the second outlet guide vane is located at a circumferential position between 150 degrees and 210 degrees offset from the first outlet guide vane.

5. The aircraft of claim 2, wherein the unducted fan propulsor is mounted to the aircraft through a pylon at a pylon attachment location, wherein the circumferential position, θ₀, of the highest loaded rotor blade is aligned circumferentially with the pylon attachment location, wherein the plurality of outlet guide vanes includes a first outlet guide vane with a first span not greater than the spans of the other outlet guide vanes, the first outlet guide vane aligned with the pylon attachment location or positioned within θ_{SWIRL_OFF} of the pylon attachment location in a direction of rotor rotation.

6. The aircraft of claim 2, wherein the plurality of outlet guide vanes includes a second outlet guide vane with a second span not shorter than the spans of the other outlet guide vanes, wherein the second outlet guide vane is located at a circumferential position between 150 degrees and 210 degrees offset from the first outlet guide vane.

7. The aircraft of claim 1, wherein the rotating blades defines a circumferential position, θ₀, of a highest loaded rotor blade at a first unducted fan propulsor operating condition, wherein a rotor blade of the rotating blades further defines a tip radius, R_{TIP}, wherein the unducted fan propulsor defines an axial spacing, S, between the rotating blades and the plurality of outlet guide vanes and an effective advance ratio, Je, and wherein the unducted fan propulsor defines a circumferential swirl offset, θ_{SWIRL_OFF}, equal to
$$2 \times {tan}^{- 1} ( \frac{π \times S}{{J}_{{e}^{\times R} TIP}} ) ;$$
and wherein the plurality of outlet guide vanes includes a first outlet guide vane with a first span not greater than the spans of the other outlet guide vanes, the first outlet guide vane located at a circumferential position between θ₀ and θ_{SWIRL_OFF}.

8. The aircraft of claim 1, wherein the plurality of outlet guide vanes includes a first outlet guide vane with a first span not greater than the spans of the other outlet guide vanes, a second outlet guide vane with a second span not shorter than the spans of the other outlet guide vanes, and a plurality of intermediate outlet guide vanes positioned between the first and second outlet guide vanes, wherein the spans of the intermediate outlet guide vanes are each greater than the first span and less than the second span.

9. The aircraft of claim 1, wherein 0.15≤RL/D.

10. The aircraft of claim 1, wherein 0.35≤RL/D, and preferably RL/D is about 0.72.

11. The aircraft of claim 1, wherein 0 is between 198° and 310°, and preferably between 205° and 285°.

12. The aircraft of claim 1, wherein the unducted fan propulsor has a dimensionless cruise fan net thrust parameter expressed as follows:
$$0.15 > \frac{{F}_{net}}{{ρ}_{0} {A}_{a n} {V}_{0}^{2}} > 0.06 ,$$
wherein Fₙₑₜ is cruise fan net thrust, ρ₀ is ambient air density, Vₒ is cruise flight velocity, and Aₐₙ is annular cross-sectional area perpendicular to an axis of rotation of a rotor axis of rotation.

13. The aircraft of claim 1, wherein the unducted fan propulsor is undermounted to the airfoil with one or more intermediate structures.

14. The aircraft of claim 1, wherein the P of the unducted fan propulsor is variable to accommodate different operating conditions.

15. An aircraft, comprising:
a fuselage;
an airfoil extending from the fuselage, the airfoil having an airfoil section defining an effective quarter chord point (QC);
an unducted fan propulsor mounted relative to the airfoil section on a high pressure side thereof, the unducted fan propulsor having a centerline (CL), a plurality of blades arranged in a forward array and a plurality of blades arranged in a rearward array, wherein only one of the forward and rearward array of blades are rotating blades and the rotating blades define a maximum outer diameter (D);
a point (P) located at an intersection of the CL and a line HP perpendicular to the CL that passes through an axial midpoint between a rearward trailing edge at a root of a blade of the rearward array and a forward leading edge at a root of a blade of the forward array when the forward leading edge and rearward trailing edge of the respective blades are aligned with each other; and
an ellipse origin positioning line (EOR) having a length (EORL) extending from the QC to an ellipse origin (OR) at an angle θ measured positive in a counter-clockwise direction when the high pressure side of the airfoil section is below the airfoil section, and measured positive in a clockwise direction when the high pressure side of the airfoil section is above the airfoil section, when viewed looking for an outboard position towards an inboard position; wherein the P of the unducted fan propulsor is located within a first ellipse having a first major axis length (1MajAL) and a first minor axis length (1MinAL) with a first ellipse origin defined by EORL/D of 0.938 and θ of 253.6°, and where 1MajAL/D is 2.8 and 1MinAL/D is 1.7,
wherein the rearward array of blades is a plurality of outlet guide vanes positioned downstream of the rotating blades, the plurality of outlet guide vanes each defining a span, wherein the spans of the plurality of outlet guide vanes are nonuniform.

16. The aircraft of claim 15, wherein the P of the unducted fan propulsor is located in a second ellipse having a second major axis length (2MajAL) and a second minor axis length (2MinAL) with a second ellipse origin defined by EORL/D of 1.051 and θ of 248.8°, and where 2MajAL/D is 1.86 and 2MinAL/D is 1.56.

17. The aircraft of claim 15, wherein the P of the unducted fan propulsor is located in a third ellipse having a third major axis length (3MajAL) and a third minor axis length (3MinAL) with a third ellipse origin defined by EORL/D of 0.870 and θ of 239.6°, where 3MajAL/D is 1.4 and 3MinAL/D is 0.9.

18. The aircraft of claim 15, wherein the P of the unducted fan propulsor is located in a fourth ellipse having a fourth major axis length (4MajAL) and a fourth minor axis length (4MinAL) with a fourth ellipse origin defined by EORL/D of 0.763 and θ of 235.7°, and where 4MajAL/D is 0.94 and 4MinAL/D is 0.44.

19. An aircraft, comprising:
a fuselage;
an airfoil extending from the fuselage, the airfoil having an airfoil section defining an effective quarter-chord point (QC);
an unducted fan propulsor mounted relative to the airfoil section on a high pressure side thereof, the unducted fan propulsor having a centerline (CL), a plurality of blades arranged in a forward array and a plurality of blades arranged in a rearward array, wherein one of the forward and rearward array of blades are rotating blades and the rotating blades define a maximum outer diameter (D);
a point (P) located at an intersection of the CL and a line HP perpendicular to the CL that passes through an axial midpoint between a rearward trailing edge at a root of a blade of the rearward array and a forward leading edge at a root of a blade of the forward array when the forward leading edge and rearward trailing edge of the respective blades are aligned with each other; and
a positioning line (R) having a length (RL) and extending from the QC to the point P of the unducted fan propulsor at an angle θ measured positive in a counter-clockwise direction when the high pressure side of the airfoil section is below the airfoil section, and measured positive in a clockwise direction when the high pressure side of the airfoil section is above the airfoil section, when viewed looking from an outboard position towards an inboard position (e.g. the fuselage) OR when viewed with the LE to the left of the TE; wherein 0.065<RL/D<1.98 and θ is between 187° and 340°; and wherein RL/D and θ of the P of the unducted fan propulsor adhere to the following expressions:
$$\frac{R L}{D} + \frac{( \begin{matrix}\sqrt{1.4161 * [ 1.88978 * {sin}^{2} ( θ ) - 0.0875 * {cos}^{2} ( θ ) + 0.477 * sin ( θ ) * cos ( θ ) ]} + \\ 1.764 * sin ( θ ) + 0.19146 * cos ( θ )\end{matrix} )}{1.96 * {sin}^{2} ( θ ) + 0.7225 * {cos}^{2} ( θ )} > 0$$
$$and$$
$$\frac{R L}{D} + \frac{( \begin{matrix}- \sqrt{1.4161 * [ 1.88978 * {sin}^{2} ( θ ) - 0.0875 * {cos}^{2} ( θ ) + 0.477 * sin ( θ ) * cos ( θ ) ]} + \\ 1.764 * sin ( θ ) + 0.19146 * cos ( θ )\end{matrix} )}{1.96 * {sin}^{2} ( θ ) + 0.7225 * {cos}^{2} ( θ )} < 0$$
wherein the rearward array of blades is a plurality of outlet guide vanes positioned downstream of the rotating blades, the plurality of outlet guide vanes each defining a span, wherein the spans of the plurality of outlet guide vanes are nonuniform.
